(19) United States
(12) Patent Application Publication
(10) Pub. No.: US 2025/0066559 A1
(43) Pub. Date: Feb. 27, 2025

(54) Ultra-High Molecular Weight Polyethylene Powder and Molded Product

(71) Applicant: ASAHI KASEI KABUSHIKI KAISHA, Tokyo (JP)

(72) Inventor: Koichi Tsujimoto, Tokyo (JP)

(73) Assignee: ASAHI KASEI KABUSHIKI KAISHA, Tokyo (JP)

(21) Appl. No.: 18/766,722

(22) Filed: Jul. 9, 2024

(30) Foreign Application Priority Data
Jul. 11, 2023 (JP) 2023-113663
Jul. 1, 2024 (JP) 2024-106221

(51) Int. Cl. C08J 3/12; C08L 23/06

(52) U.S. Cl. CPC C08J 3/12; C08L 23/06; C08J 2323/06; C08L 2203/12; C08L 2207/068

(57) ABSTRACT

An object of the present invention is to provide an ultrahigh-molecular-weight polyethylene powder excellent in molding processability that can produce a homogenous gel in a short time, and can produce a gel having a high polymer concentration by drastically shortening a kneading time. The ultrahigh-molecular-weight polyethylene powder has intrinsic viscosity IV of 1.0 dL/g or more and 38.0 dL/g or less, and has an average particle size D50 of 50 m or more and 400 m or less, wherein a dissolution time of a powder having a particle size D50 is 5 seconds or more and 80 seconds or less.

### BACKGROUND OF THE INVENTION

### Field of the Invention

The present invention relates to an ultrahigh-molecular-weight polyethylene powder and a molded article.

### Description of the Related Art

Polyethylene is employed in a wide variety of uses such as films, sheets, microporous membranes, fibers, foams, and pipes. Polyethylene is used because melt processing is easy and the obtained molded article has high mechanical strength and is also excellent in chemical resistance, rigidity, etc. Among others, ultrahigh-molecular-weight polyethylene has higher mechanical strength because of its large molecular weight and is excellent in slidability and abrasion resistance and also excellent in chemical stability and long-term reliability.

However, the ultrahigh-molecular-weight polyethylene has low fluidity even if melted at a temperature equal to or higher than a melting point. Therefore, for example, a compression molding method of compression-molding a polyethylene powder under heating, followed by cutting, or a molding method of dissolving a polyethylene powder in a solvent such as liquid paraffin, then performing drawing, and removing the solvent for molding into a sheet or a thread form, is applied thereto.

The ultrahigh-molecular-weight polyethylene is molded in a powder state. The powder has a larger surface area than that of a pellet and has fine pores in the powder.

As for the pore state of the polyethylene powder, for example, Japanese Patent Laid-Open No. 2017-088773 discloses a polyethylene powder that is rapidly dissolved in a solvent and produces a molded article with less occurrence of undissolved matter, by adjusting a specific surface area determined by a BET method and a pore volume determined by a mercury intrusion method to proper ranges.

For example, Japanese Patent Laid-Open No. 2017-145306 discloses a polyethylene powder that produces a molded article with less occurrence of undissolved matter, by adjusting the ratio between the median diameter and the modal diameter of pores measured by a mercury intrusion method to a proper range.

In recent years, a polyethylene powder has been proposed which is excellent in molding processability and produces a high-quality molded article.

For example, Japanese Patent Laid-Open No. 2019-019265 discloses a polyethylene powder that has excellent solubility and is capable of improving productivity and product quality in processing molding (particularly, wet extrusion molding), by imparting a predetermined particle size distribution and a predetermined swelling ratio to the polyethylene powder.

For example, Japanese Patent Laid-Open No. 2019-070117 discloses a polyethylene polymer powder improved in oxidation resistance while effectively improved in membrane uniformity and smoothness of a thin film, by controlling intrinsic viscosity IV and Al, Mg and Si contents in specific ranges.

For example, Japanese Patent Laid-Open No. 2019-123777 discloses an ethylene polymer that is less entangled when processed and drawn, is excellent in low-temperature tensile strength in the form of a high-strength fiber, and is excellent in rate of shrinkage of a membrane and low-temperature puncture strength in the form of a microporous membrane, by allowing the ethylene polymer to contain nonmagnetic matter that satisfies specific conditions.

For example, International Publication No. WO2021/193544 discloses that a molded article excellent in processability and dimensional accuracy can be obtained by adjusting a difference between a swell start temperature and a dissolution start temperature of an ultrahigh-molecular-weight polyethylene powder, and adjusting an impregnation rate of liquid paraffin in the ultrahigh-molecular-weight polyethylene powder.

For example, International Publication No. WO2023/054514 discloses that an ultrahigh-molecular-weight polyethylene powder excellent in molding processability obtained when precedently swollen at a low temperature, and a high-quality molded article obtained by molding the same can be obtained by controlling, to a specific range, a swell start temperature of an ultrahigh-molecular-weight polyethylene powder having a particle size D₁₀, D₅₀, or D₉₀.

As mentioned above, the ultrahigh-molecular-weight polyethylene powder has a larger surface area than that of a pellet and has fine pores in the powder. Hence, the shape, surface state, crystal state, pore state, and the like of the powder are changed during heating.

Therefore, the molding of the ultrahigh-molecular-weight polyethylene powder requires adjustment to a proper temperature and processing such as dissolution or compression. In the case of compression-molding the ultrahigh-molecular-weight polyethylene powder, air bubbles tend to remain in the resulting molded article or strain tends to remain in the resulting molded article and to cause deformation after cooling, unless a preheating temperature before compression is proper.

The polyethylene powder described in Japanese Patent Laid-Open No. 2017-088773 merely undergoes the adjustment of a specific surface area and a pore volume as powder properties. The properties of the powder are largely changed at an actual dissolution or melting temperature, and this powder is still susceptible to improvement in molding processability.

The polyethylene powder described in Japanese Patent Laid-Open No. 2017-145306 also merely undergoes the definition of a powder pore size. Since the pore size is largely changed during the course of heating, the powder is still susceptible to improvement in molding processability and may have the difficulty in producing a homogeneous molded article.

Meanwhile, the polyethylene powders described in Japanese Patent Laid-Open Nos. 2019-019265, 2019-070117, and 2019-123777 are relatively excellent in molding processability and however, have not discussed about the obtainment of a homogeneous gel in a short time. Thus, the powders are still susceptible to improvement in molding processability and molded article quality.

In addition, the polyethylene powders described in International Publication Nos. WO2021/193544 and WO2023/054514 have not been examined for a dissolution time (time from the start to the end of dissolution) in the liquid paraffin, and there is a room of improvement in molding processability and the quality of a molded article.

The present invention has been made in light of the circumstances described above, and an object of the present invention is to provide an ultrahigh-molecular-weight polyethylene powder that can produce a homogenous gel in a short time, and can produce a gel having a high polymer concentration by drastically shortening a kneading time when the ultrahigh-molecular-weight polyethylene powder is used in the preparation of a molded article, and is excellent in molding processability, and provide a high-quality molded article (e.g., a separator for a secondary battery excellent in even film thickness and puncture strength, and fiber excellent in even thread diameter and high-speed windability) prepared by molding the same.

### SUMMARY OF THE INVENTION

The present inventors have pursued diligent studies to attain the object and consequently completed the present invention by finding that the object can be attained by using an ultrahigh-molecular-weight polyethylene powder that dissolves in liquid paraffin in a prescribed period of time.

Specifically, the present invention is as follows:

[1]

An ultrahigh-molecular-weight polyethylene powder,

having intrinsic viscosity IV of 1.0 dL/g or more and 38.0 dL/g or less, and

having an average particle size D50 of 50 μm or more and 400 μm or less, wherein

a dissolution time of a powder having a particle size D50 is 5 seconds or more and 80 seconds or less.

[2]

The ultrahigh-molecular-weight polyethylene powder according to [1], wherein

the intrinsic viscosity IV is 13.5 dL/g or more and 38.0 dL/g or less.

[3]

The ultrahigh-molecular-weight polyethylene powder according to [1] or [2], wherein the dissolution time is 5 seconds or more and 40 seconds or less.

[4]

The ultrahigh-molecular-weight polyethylene powder according to any one of [1] to [3], wherein a proportion of interconnected pores in the powder having the particle size D50 is 3% or more and 70% or less.

[5]

The ultrahigh-molecular-weight polyethylene powder according to any one of [1] to [4], wherein a surface thickness of the powder having the particle size D50 is 3 μm or more and 60 μm or less.

[6]

The ultrahigh-molecular-weight polyethylene powder according to any one of [1] to [5], wherein an interconnected pore diameter of the powder having the particle size D50 is 3 μm or more and 30 μm or less.

[7]

The ultrahigh-molecular-weight polyethylene powder according to any one of [1] to [6], wherein a titanium content is 5 ppm or less.

[8]

The ultrahigh-molecular-weight polyethylene powder according to any one of [1] to [7], wherein

an aluminum content is 5 ppm or less.

[9]

A molded article of the ultrahigh-molecular-weight polyethylene powder according to any one of [1] to [8].

[10]

The molded article according to [9], wherein

the molded article is a separator for secondary battery.

[11]

The molded article according to [9], wherein

the molded article is a fiber.

[12]

A method for producing a high-strength fiber, comprising:
a slurry preparing step of mixing an ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry;
a gelling step of mixing the slurry and second liquid paraffin at 150° C. or more and 300° C. or less to obtain a gel for a fiber at 140° C. or more and 200° C. or less;
an extruding step of extruding the gel for a fiber to obtain a fiber;
an extracting step of extracting the first liquid paraffin and the second liquid paraffin from the fiber to obtain a fiber for drawing; and
a fiber drawing step of thermally drawing the fiber for drawing, wherein the ultrahigh-molecular-weight polyethylene powder has intrinsic viscosity IV of 13.5 dL/g or more and 38.0 dL/g or less,
an average particle size D50 of the ultrahigh-molecular-weight polyethylene powder is 50 μm or more and 400 μm or less, and
a dissolution time of a powder having a particle size D50 of the ultrahigh-molecular weight polyethylene powder is 5 seconds or more and 80 seconds or less.
   [13]

The method for producing a high-strength fiber according to [12], comprising a kneading step of kneading the gel for a fiber before the extruding step.

[14]

A method for producing a microporous membrane, comprising:
a slurry preparing step of mixing an ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry;
a gelling step of mixing the slurry and second liquid paraffin at 150° C. or more and 300° C. or less to obtain a gel for pressing at 140° C. or more and 200° C. or less;
a pressing step of thermally pressing the gel for pressing to obtain a gel sheet;
a membrane drawing step of drawing the gel sheet to obtain a drawn membrane; and
an extracting step of extracting the first liquid paraffin and the second liquid paraffin from the drawn membrane, wherein
the ultrahigh-molecular-weight polyethylene powder has intrinsic viscosity IV of 1.0 dL/g or more and 13.0 dL/g or less,
an average particle size D50 of the ultrahigh-molecular-weight polyethylene powder is 50 μm or more and 400 μm or less, and
a dissolution time of a powder having a particle size D50 of the ultrahigh-molecular weight polyethylene powder is 5 seconds or more and 80 seconds or less.
   [15]

The method for producing a microporous membrane according to [14], comprising a kneading step of kneading the gel for pressing before the pressing step.

[16]

The method for producing a high-strength fiber according to [12] or [13], wherein
a stirring temperature is 25° C. or more and 120° C. or less in the slurry preparing step, and
a polyethylene concentration in the gel for a fiber is 3% by mass or more and 20% by mass or less in the gelling step.
   [17]

The method for producing a high-strength fiber according to [13] or [16], wherein
the kneading step is performed at a temperature of 140° C. or more and 200° C. or less, at a time for 5 minutes or more and 180 minutes or less, and at a rotational speed of 3 rpm or more and 50 rpm or less.
   [18]

The method for producing a high-strength fiber according to any one of [12], [13], [16], and [17], comprising a rapidly cooling step after the extruding step, wherein
a time from the extruding step to the rapidly cooling step is 0 second or more and 10 seconds or less, and
a temperature in the rapidly cooling step is 5° C. or more and 30° C. or less.
   [19]

The method for producing a high-strength fiber according to any one of [121, [131, and [16] to [18], comprising an extrusion preparation step before the extruding step, wherein
a temperature in the extrusion preparation step is 140° C. or more and 200° C. or less, and
a time of the extrusion preparation step is 5 minutes or more and 90 minutes or less.
   [20]

The method for producing a high-strength fiber according to any one of [12], [13], and [16] to [19], wherein
in the extruding step, an extrusion rate is 5 mm/min or more and 20 mm/min or less, a winding rate is 200 mm/min or more and 1600 mm/min or less, a discharge amount is 0.2 g/min or more and 1.5 g/min or less, and a spinning diameter is 0.8 mm or more and 1.5 mm or less.
   [21]

The method for producing a high-strength fiber according to any one of [12], [13], and [16] to [20], wherein
an extraction solvent is used in the extracting step,
the extraction solvent is hexane or dichloromethane, and
a time of the extraction is 3 hours or more and 24 hours or less.
   [22]

The method for producing a high-strength fiber according to any one of [12], [13], and [16] to [21], wherein
multistage drawing is performed in the fiber drawing step.
   [23]

The method for producing a high-strength fiber according to [22], wherein
the multistage drawing is two-stage drawing.
   [24]

The method for producing a high-strength fiber according to [23], wherein
the two-stage drawing includes a primary drawing step and a secondary drawing step,
in the primary drawing step, a feeding rate is 50 mm/min or more and 200 mm/min or less, a winding rate is 1000 mm/min or more and 4000 mm/min or less, and a temperature is 110° C. or more and 155° C. or less, and
in the secondary drawing step, a feeding rate is 50 mm/min or more and 200 mm/min or less, a winding rate is 100 mm/min or more and 500 mm/min or less, and a temperature is 130° C. or more and 155° C. or less.
   [25]

The method for producing a microporous membrane according to [14] or [15], wherein
a stirring temperature is 25° C. or more and 120° C. or less in the slurry preparing step, and
a polyethylene concentration in the gel for pressing is 20% by mass or more and 55% by mass or less in the gelling step.
   [26]

The method for producing a microporous membrane according to [15] or [25], wherein
in the kneading step, a temperature is 140° C. or more and 250° C. or less, a time is 5 minutes or more and 60 minutes or less, and a rotational speed is 30 rpm or more and 100 rpm or less.
   [27]

The method for producing a microporous membrane according to any one of [14], [15], [25], and [26], wherein
in the pressing step, a metal frame having a thickness of 1.0 mm is used for obtaining a thickness of the gel sheet of 1.0 mm,
a temperature and a pressure are adjusted multistage in such a manner that:
heating is conducted in a first stage under conditions of a temperature of 180° C. or more and 220° C. or less, a pressure of 1 MPa, and a time of 3 minutes,
heating is conducted in a second stage under conditions of a temperature of 180° C. or more and 220° C. or less, a pressure of 10 MPa, and a time of 2 minutes, and
cooling is conducted in a third stage under conditions of a temperature of 20° C. or more and 35° C. or less, a pressure of 10 MPa, and a time of 5 minutes.
   [28]

The method for producing a microporous membrane according to any one of [14], [15], and [25] to [27], wherein
in the membrane drawing step, the drawing is simultaneous biaxial drawing, performed at a temperature of 110° C. or more and 130° C. or less, at a ratio of 5 times or more and 20 times or less in a longitudinal direction, and at a ratio of 5 times or more and 20 times or less in a lateral direction.
   [29]

The method for producing a microporous membrane according to any one of [14], [15], and [25] to [28], wherein
an extraction solvent is used in the extracting step,
the extraction solvent is hexane or dichloromethane, and
a time of extraction is 3 hours or more and 24 hours or less.

According to the present invention, an ultrahigh-molecular-weight polyethylene powder excellent in molding processability, and a high-quality molded article obtained by molding the same can be provided.

### BRIEF DESCRIPTION OF THE DRAWINGS

FIG. 1 illustrates an image of a powder (particle) having a particle size D50, in which a region surrounded with a dotted line on an outer circumference of the particle is referred to as the “outer diameter of the particle”, a diameter of the largest circle (illustrated with a dotted line) within an interconnected pore is referred to as the “interconnected pore diameter”, and a diameter of the largest circle (illustrated with a dotted line) within a resin region is referred to as the “thickness”; and

FIG. 2 illustrates a tomographic image of powder having a particle size D50.

### DETAILED DESCRIPTION OF THE INVENTION

Hereinafter, a mode for carrying out the present invention (hereinafter, simply referred to as the “present embodiment”) will be described in detail. However, the present invention is not intended to be limited by the present embodiment. Various changes or modifications can be made in the present invention without departing from the spirit thereof.

### [Ultrahigh-Molecular-Weight Polyethylene Powder]

The ultrahigh-molecular-weight polyethylene powder (hereinafter, also simply referred to as the “powder” or the “polymer”) of the present embodiment has intrinsic viscosity IV of 1.0 dL/g or more and 38.0 dL/g or less, preferably 1.5 dL/g or more and 33.0 dL/g or less, more preferably 2.4 dL/g or more and 31.0 dL/g or less.

The ultrahigh-molecular-weight polyethylene powder of the present embodiment has better strength when having the intrinsic viscosity IV equal to or more than the lower limit, and has better molding processability when having the intrinsic viscosity IV equal to or less than the upper limit.

The intrinsic viscosity IV of the ultrahigh-molecular-weight polyethylene powder of the present embodiment is not particularly limited and is preferably 1.0 dL/g or more and 13.0 dL/g or less, more preferably 1.5 dL/g or more and 11.5 dL/g or less, further preferably 2.4 dL/g or more and 9.5 dL/g or less, for example, for use in a molded article of a separator for secondary battery. A separator for secondary battery obtained by molding the ultrahigh-molecular-weight polyethylene powder having the intrinsic viscosity IV within the range described above tends to be excellent in membrane strength and thermal shrink properties, etc.

The intrinsic viscosity IV of the ultrahigh-molecular-weight polyethylene powder of the present embodiment is not particularly limited and is preferably 13.5 dL/g or more and 38.0 dL/g or less, more preferably 15.0 dL/g or more and 33.0 dL/g or less, further preferably 16.5 dL/g or more and 31.0 dL/g or less, for example, for use in a molded article of a fiber. A fiber obtained by molding (e.g., general molding or molding performed after kneading the powder for a short period of time) of the ultrahigh-molecular-weight polyethylene powder having the intrinsic viscosity IV within the range described above tends to be excellent in thread strength, etc.

The method for controlling the intrinsic viscosity IV to the range mentioned above is not particularly limited and involves, for example, changing the polymerization temperature of a reactor where ethylene is homopolymerized or where ethylene and an olefin, other than ethylene, copolymerizable therewith are copolymerized. The intrinsic viscosity IV tends to be lower as the polymerization temperature is higher, and tends to be higher as the polymerization temperature is lower. Another method for controlling the intrinsic viscosity IV to the range mentioned above is not particularly limited and involves, for example, changing the type of an organic metal compound for use as a promoter in the homopolymerization of ethylene or the copolymerization of ethylene and an olefin, other than ethylene, copolymerizable therewith. A further alternative method for controlling the intrinsic viscosity IV to the range mentioned above is not particularly limited and involves, for example, adding a chain transfer agent in the homopolymerization of ethylene or the copolymerization of ethylene and an olefin, other than ethylene, copolymerizable therewith. The addition of the chain transfer agent tends to decrease the intrinsic viscosity IV of the ultrahigh-molecular-weight polyethylene to be produced even at the same polymerization temperature.

In the present embodiment, the intrinsic viscosity IV can be determined by, for example, but not particularly limited to, a method described in Examples mentioned later.

The ultrahigh-molecular-weight polyethylene powder of the present embodiment is preferably a powder consisting of an ethylene homopolymer and/or a copolymer of ethylene and an olefin (hereinafter, also referred to as a comonomer), other than ethylene, copolymerizable therewith (hereinafter, the homopolymer and the copolymer are also collectively referred to as the “ethylene polymer”).

Specific examples of the comonomer described above copolymerizable with ethylene include, but are not particularly limited to, at least one comonomer selected from the group consisting of α-olefins having 3 or more and 15 or less carbon atoms, cyclic olefins having 3 or more and 15 or less carbon atoms, compounds represented by the formula CH₂=CHR¹ (wherein R¹ is an aryl group having 6 to 12 carbon atoms), and linear, branched, or cyclic dienes having 3 or more and 15 or less carbon atoms. Among them, an α-olefin having 3 or more and 15 or less carbon atoms is preferred.

Examples of the α-olefin include, but are not particularly limited to, propylene, 1-butene, 4-methyl-1-pentene, 1-hexene, 1-octene, 1-nonene, 1-decene, 1-undecene, 1-dodecene, 1-tridecene, and 1-tetradecene.

The ultrahigh-molecular-weight polyethylene powder of the present embodiment may be obtained by using, as a raw material, ethylene produced from, for example, biomass-derived naphtha or biomass-derived ethanol. For example, the biomass-derived ultrahigh-molecular-weight polyethylene powder described above can be produced by cracking biomass-derived naphtha used as a raw material.

An average particle size (D50) of the ultrahigh-molecular-weight polyethylene powder of the present embodiment is 50 μm or more and 400 μm or less, preferably 70 μm or more and 300 μm or less, more preferably 90 μm or more and 250 μm or less, further preferably 100 μm or more and 200 μm or less, and most preferably 120 μm or more and 180 μm or less.

When the average particle size (D50) is 50 m or more, clogging in an extruder hopper caused by low fluidity can be suppressed, and thus, productivity can be improved. Besides, when the average particle size (D50) is 400 μm or less, a sufficient amount of liquid paraffin can be caused to enter the powder, and thus, a disentangled homogeneous gel can be produced. In other words, the gel can be suppressed from being unhomogenous due to an insufficient amount of liquid paraffin entering.

A method for controlling the average particle size (D50) to the aforementioned range is not especially limited, and for example, a method in which conditions in a polymerization system (e.g., a polymerization temperature, and an ethylene pressure) are appropriately adjusted can be employed. Specifically, the polymerization temperature and/or polymerization pressure can be increased.

A method for measuring the average particle size (D50) of the ultrahigh-molecular-weight polyethylene powder is not especially limited, and for example, a method described in Examples below can be employed.

### [Dissolution Time of Ultrahigh-Molecular-Weight Polyethylene Powder]

A dissolution time of the ultrahigh-molecular-weight polyethylene powder of the present embodiment is 5 seconds or more and 80 seconds or less, preferably 5 seconds or more and 70 seconds or less, more preferably 5 seconds or more and 60 seconds or less, further preferably 5 seconds or more and 40 seconds or less, and most preferably 5 seconds or more and 35 seconds or less.

The dissolution time is calculated in accordance with the following methods 1 and 2:

### [Method 1: Method for Measuring D50]

A particle size of a target ultrahigh-molecular-weight polyethylene powder is measured with a laser particle size distribution meter using methanol as a dispersion medium to create, based on the measurement, a cumulative particle size distribution from the small particle size side, and a particle size corresponding to 50% cumulative particle size is determined as D50.

### [Method 2: Method for Measuring Dissolution Time]

The dissolution time of a powder having a particle size D50 is obtained. First, under observation, with an optical microscope, of an ultrahigh-molecular-weight polyethylene powder having a long diameter and a short diameter within the range of D50±10%, one particle is freely collected. Here, the short diameter of the particle is determined, in a plane figure of the particle observed with an optical microscope, as a shortest distance between parallel lines, and the long diameter of the particle is determined as a longest distance between parallel lines crossing, at right angle, the parallel lines of the short diameter. The thus collected one particle of the ultrahigh-molecular-weight polyethylene powder (hereinafter, also referred to as the “measurement particle”) is set on a microscope glass, 0.05 mL of liquid paraffin is dropped onto the measurement particle with a 1 mL syringe, and then a cover glass is placed thereon to sandwich the measurement particle. Thereafter, the microscope glass is set on a heat stage, and the temperature is increased from room temperature to 150° C. under temperature increase conditions described below. The appearance of the measurement particle during the temperature increase is captured with an optical microscope equipped with a camera every 5 seconds. Based on the thus obtained observation images, an equivalent circle diameter of the measurement particle is calculated, and a time from a state in which the equivalent circle diameter is the largest until elimination of the powder is determined as the dissolution time. This operation is continuously performed 10 times, and an average of eight values excluding the maximum and minimum values is calculated to obtain a final dissolution time.

### (Temperature Increase Conditions)

temperature increase rate from room temperature to 35° C.: 5° C./min
temperature increase rate from 35° C. to 80° C.: 8° C./min
temperature increase rate from 80° C. to 150° C.: 5° C./min

The ultrahigh-molecular-weight polyethylene powder of the present embodiment having the dissolution time that falls within the range described above can reduce environmental load by reducing energy required for wet extrusion processing, for example, when processed by wet extrusion into a fiber (e.g., high-strength fiber) or a separator for secondary battery (e.g., microporous membrane), and can also drastically improve the production efficiency of the molded article.

In general, the wet extrusion processing refers to a process of kneading slurry of a powder impregnated with liquid paraffin under heat in an extruder, and processing the resulting gel form into each molded article. In this context, the processability of a molded article is influenced by the amount of a molecular chain entangled in the gel. Since the ultrahigh-molecular-weight polyethylene powder has a large amount of entanglement of molecular chains in an amorphous moiety, it is difficult to obtain a disentangled homogenous gel. In other words, even when wet extrusion conditions (a temperature, a time, and a screw rotational speed) are adjusted, it is difficult to obtain a homogenous gel having disentangled molecular chains, and it is significant to reduce the amount of entanglement in the amorphous moiety of the powder itself.

Here, the dissolution behavior of a polyethylene powder will be described. When a polyethylene powder is impregnated with liquid paraffin, the liquid paraffin enters (dissolves in) the polyethylene powder, resulting in swelling the polyethylene powder. Since the liquid paraffin cannot easily enter a crystalline moiety of the polyethylene powder, the liquid paraffin is presumed to enter an amorphous moiety, and actually, it has been confirmed that the crystal length period of the polyethylene powder is increased in accordance with the swelling. In other words, the swelling is probably a phenomenon that the liquid paraffin enters between lamellar crystals of the polyethylene powder to expand the amorphous moiety.

At this point, when the amount of entanglement of molecular chains in the amorphous moiety is large, the swelling is suppressed, and hence the amount of the liquid paraffin entering the powder is reduced. Therefore, solubility of the powder is degraded (namely, the dissolution time is increased beyond 80 seconds), and thus, a disentangled homogenous gel cannot be obtained even through long-term kneading.

On the other hand, when the amount of entanglement of molecular chains in the amorphous moiety is small, the amount of the liquid paraffin entering the powder is increased, and therefore, the solubility of the powder is improved (namely, the dissolution time is reduced to 5 seconds or more and 80 seconds or less), and thus, a disentangled homogenous gel can be obtained through short-term kneading. As a result, a high-quality molded article, for example, a separator for secondary battery having high breaking strength with thickness variations suppressed, or a fiber that is drawable at a high speed with an uneven thread diameter suppressed, can be obtained in wet extrusion processing. When the amount of entanglement of molecular chains in the amorphous moiety is, however, too small (namely, the dissolution time is too short to be less than 5 seconds), thermal shrinkage of a molded article caused after wet extrusion processing cannot be suppressed, which probably causes strength deterioration. This is probably because appropriate entanglement remaining therein can suppress shrinkage of a fully stretched chain, resulting in reducing the thermal shrinkage.

Accordingly, the amount of entanglement of molecular chains in the amorphous moiety should not be too large and too small, but is significant to be set to an appropriate range. For this purpose, the dissolution time of the powder needs to be controlled to 5 seconds or more and 80 seconds or less.

A method for controlling the dissolution time of the ultrahigh-molecular-weight polyethylene powder to the aforementioned range is not especially limited, and examples include a method in which the powder is impregnated with liquid paraffin to be vacuum deaerated under heating (hereinafter also referred to as the control method 1), and a method in which main polymerization is performed with a polymer obtained through polymerization by using, as a preliminary polymerization catalyst, liquid paraffin added to a polymerization solvent in preliminary polymerization (hereinafter also referred to as the control method 2).

Although the mechanism that the dissolution time of the ultrahigh-molecular-weight polyethylene powder can be controlled to the aforementioned range by these methods is not clear and is not limited to a mechanism given below, the present inventors have made the following presumption.

Regarding the control method 1, although the reason is not clear, and the method is not limited to the following, it is significant to disentangle molecular chains slowly little by little by impregnating the powder with liquid paraffin, and allowing it to stand still at a temperature at which the powder is not melted but molecular chains can move (50° C. or more and 100° C. or less) under vacuum (300 Pa or more and 400 Pa or less) for 1 hour or more and 6 hours or less to cause the liquid paraffin to sufficiently enter pores of the powder. Next, the resultant is dipped in hexane for 5 hours or more and 24 hours or less to extract the liquid paraffin from the powder, and the resultant powder is dried at 25° C. or more and 50° C. or less for 24 hours, and thus, a powder having a short dissolution time (of 5 seconds or more and 80 seconds or less) can be probably obtained.

Regarding the control method 2, although the reason is not clear, and the method is not limited to the following, when main polymerization is performed with a polymer obtained through polymerization with 55 to 70% by mass of liquid paraffin added to a polymerization solvent in preliminary polymerization, and the liquid paraffin is removed from the powder after completing the polymerization, a powder having a short dissolution time (of 5 seconds or more and 80 seconds or less) can be probably obtained. When the liquid paraffin added to the polymerization solvent is adjusted to a temperature equivalent to the polymerization temperature, an effect that the liquid paraffin suppresses entanglement of molecular chains can be probably exhibited during growth reaction of the molecular chains.

### [Proportion of Interconnected Pores in Ultrahigh-Molecular-Weight Polyethylene Powder]

A proportion of interconnected pores in the ultrahigh-molecular-weight polyethylene powder of the present embodiment is, for example, 3% or more and 70% or less, preferably 5% or more and 70% or less, more preferably 7% or more and 70% or less, further preferably 10% or more and 50% or less, and most preferably 15% or more and 40% or less.

When the proportion of interconnected pores is 3% or more, the liquid paraffin sufficiently enters the powder, and thus, a homogenous gel can be produced through short-term kneading. Besides, when the proportion of interconnected pores is 70% or less, reduction of a filling rate in a packaging bag caused due to a high void structure of the powder can be suppressed, and thus production cost increase can be avoided.

The proportion of interconnected pores is calculated in accordance with a method described in Examples below.

### [Surface Thickness of Ultrahigh-Molecular-Weight Polyethylene Powder]

The surface thickness of the ultrahigh-molecular-weight polyethylene powder of the present embodiment is, for example, 3 μm or more and 60 μm or less, preferably 5 m or more and 50 μm or less, more preferably 5 m or more and 40 μm or less, further preferably 5 m and 35 m or less, and most preferably 5 μm or more and 30 m or less.

When the surface thickness is 3 μm or more, fusion among particles of the powder due to melting of the powder surface can be prevented, and thus, a disentangled homogeneous gel can be produced. When the surface thickness is 60 μm or less, the liquid paraffin can enter the powder in a short period of time, and thus, a disentangled homogenous gel can be produced.

The surface thickness is calculated in accordance with a method described in Examples below.

### [Interconnected Pore Diameter of Ultrahigh-Molecular-Weight Polyethylene Powder]

An interconnected pore diameter of the ultrahigh-molecular-weight polyethylene powder of the present embodiment is, for example, 3 μm or more and 30 m or less, preferably 4 μm or more and 30 μm or less, more preferably 6 μm or more and 30 μm or less, further preferably 8 μm or more and 30 μm or less, and most preferably 10 μm or more and 30 μm or less.

When the interconnected pore diameter is 30 m or less, the liquid paraffin can be caused to enter the powder through a capillary phenomenon, and thus, a disentangled homogenous gel can be produced. When the interconnected pore diameter is 3 μm or more, a sufficient amount of the liquid paraffin can be caused to enter the powder, and thus a disentangled homogenous gel can be produced.

The interconnected pore diameter is calculated in accordance with a method described in Examples below.

A method for controlling the proportion of interconnected pores in the ultrahigh-molecular-weight polyethylene powder, the surface thickness, and the interconnected pore diameter to the aforementioned ranges is not especially limited, and an example includes a method in which polymerization is performed under a high pressure condition by using, as a preliminary polymerization catalyst, a polymer obtained by preliminary polymerization (hereinafter, also referred to as the control method 3).

Although the mechanism that the proportion of interconnected pores in the ultrahigh-molecular-weight polyethylene powder, the surface thickness, and the interconnected pore diameter can be controlled to the aforementioned ranges is not clear and is not limited to a mechanism given below, the present inventors have made the following presumption.

Regarding the control method 3, although the reason is not clear, and the method is not limited to the following, when polymerization is performed under a high pressure condition (0.5 MPa or more and 1.0 MPa or less) using a preliminary polymerization catalyst (at a low temperature (5° C. or more and 20° C. or less), for a short period of time (0.5 hours or more and 2 hours or less) with 5 NL or more and 20 NL or less of ethylene charged), the polymerization can be performed in a highly active state of initial polymerization activity. Therefore, a large amount of polymerization heat energy is generated in the polymerization step, and an interconnected pore is probably formed to extend from a powder central part to the surface while the heat energy is escaped from the powder central part to the outside. When the amount of the heat energy is adjusted, the interconnected pore diameter can be probably controlled.

### [Contents of Titanium (Ti) and Aluminum (Al) in Ultrahigh-Molecular-Weight Polyethylene Powder]

The contents of titanium (Ti) and aluminum (Al) in the ultrahigh-molecular-weight polyethylene powder of the present embodiment are, for example, 5 ppm or less, preferably 4 ppm or less, and more preferably 3 ppm or less. In general, large amounts of metals derived from catalyst residues remaining in an ultrahigh-molecular-weight polyethylene powder have a strong tendency to make the thickness of a molded article uneven. However, the ultrahigh-molecular-weight polyethylene powder of the present embodiment tends to be excellent in quality by adjusting the contents of titanium (Ti) and aluminum (Al) to 5 ppm or less. This also tends to enhance safety when the ultrahigh-molecular-weight polyethylene powder of the present embodiment is employed in battery uses.

The contents of titanium (Ti) and aluminum (Al) in the ultrahigh-molecular-weight polyethylene powder can be controlled by the productivity of an ethylene homopolymer or an ethylene polymer per unit catalyst. The productivity of an ethylene homopolymer or an ethylene polymer can be controlled by a polymerization temperature, a polymerization pressure, or a slurry concentration in a reactor for production. Specifically, examples of the approach of enhancing the productivity of the ethylene homopolymer or the ethylene polymer used in the present embodiment include, but are not particularly limited to, elevation of a polymerization temperature, elevation of a polymerization pressure, and/or elevation of a slurry concentration in polymerization. In other methods, it may be controlled by selecting the type of a promoter component, decreasing the concentration of the promoter component, or washing the ethylene homopolymer or the ethylene polymer with an acid or an alkali in polymerization for the ethylene homopolymer or the ethylene polymer.

The contents of titanium (Ti) and aluminum (Al) can be measured by, for example, but not particularly limited to, a method described in Examples mentioned later.

### [Method for Producing Ultrahigh-Molecular-Weight Polyethylene Powder]

Hereinafter, the method for producing the ultrahigh-molecular-weight polyethylene powder of the present embodiment will be described in detail.

### (Catalyst Component)

Examples of the catalytic component for use in the production of the ultrahigh-molecular-weight polyethylene powder according to the present embodiment include, but are not particularly limited to, general Ziegler-Natta catalysts and metallocene catalysts.

### <Ziegler-Natta Catalyst>

The Ziegler-Natta catalyst is preferably a catalyst for olefin polymerization comprising a solid catalytic component [A] and an organic metal compound component [B], wherein the solid catalytic component [A] is produced by reacting an organic magnesium compound (A-1) represented by the following formula 1 which is soluble in an inert hydrocarbon solvent with a titanium compound (A-2) represented by the following formula 2:

(A-1):(M¹)α(Mg)β(R²)ₐ(R³)_{b}(Y¹)_{c} Formula 1

wherein M1 represents a metal atom selected from the group consisting of groups 12, 13, and 14 of the periodic system; R² and R³ each represent a hydrocarbon group having 2 or more and 20 or less carbon atoms; Y1 represents any of alkoxy, siloxy, allyloxy, amino, amide, —N═C—R⁴, R⁵, —SR⁶ (wherein R⁴, R⁵, and R⁶ each represent a hydrocarbon group having 1 or more and 20 or less carbon atoms, and when c is 2, Y1 moieties may be different from each other), and a β-keto acid residue; and α, β, a, b, and c each represent a real number that satisfies the following relationships: 0≤α, 0<β, 0≤a, 0≤b, 0≤c, 0<a+b, 0≤c/((α+β)≤2, and nα+2β=a+b+c (wherein n represents the valence of M1); and

(A-2):Ti(OR⁷)_{d}X¹_{(4-d)} Formula 2

wherein d represents a real number of 0 or larger and 4 or smaller; R⁷ represents a hydrocarbon group having 1 or more and 20 or less carbon atoms; and X¹ represents a halogen atom.

Specific examples of the inert hydrocarbon solvent for use in the reaction between the compounds (A-1) and (A-2) include, but are not particularly limited to: aliphatic hydrocarbons such as pentane, hexane, and heptane; aromatic hydrocarbons such as benzene and toluene; and alicyclic hydrocarbons such as cyclohexane and methylcyclohexane.

First, the compound (A-1) will be described. The compound (A-1) is represented in the form of an organic magnesium complex compound soluble in an inert hydrocarbon solvent, and encompasses all of dihydrocarbyl magnesium compounds and their complexes with other metal compounds. The relational expression nα+2β=a+b+c of the symbols α, β, a, b, and c represents the stoichiometry of metal atom valence and substituents.

In the formula 1, specific examples of the hydrocarbon group having 2 or more and 20 or less carbon atoms, represented by R² or R³ include, but are not particularly limited to, alkyl groups, cycloalkyl groups, and aryl groups, for example, ethyl, propyl, butyl, pentyl, hexyl, octyl, decyl, cyclohexyl, and phenyl groups. Among them, alkyl groups are preferred. When α>0, a metal atom selected from the group consisting of groups 12, 13, and 14 of the periodic system can be used as the metal atom M¹. Examples thereof include, but are not particularly limited to, zinc, boron, and aluminum. Among them, aluminum and zinc are preferred.

The ratio β/α of magnesium to the metal atom M¹ is not particularly limited and is preferably 0.1 or more and 30 or less, more preferably 0.5 or more and 10 or less. In the case of using a predetermined organic magnesium compound wherein α=0, although not particularly limited, for example, a compound wherein R² is 1-methylpropyl is soluble in an inert hydrocarbon solvent. Such a compound also brings about a preferred consequence to the present embodiment. It is recommended that R² and R³ satisfy any one of the following three conditions (1), (2), and (3) in the formula 1 wherein (x=0.
Condition (1): at least one of R² and R³ is a secondary or tertiary alkyl group having 4 or more and 6 or less carbon atoms, preferably both of R² and R³ are alkyl groups having 4 or more and 6 or less carbon atoms and at least one of the groups is a secondary or tertiary alkyl group;
Condition (2): R² and R³ are alkyl groups differing in the number of carbon atoms, preferably R² is an alkyl group having 2 or 3 carbon atoms and R³ is an alkyl group having 4 or more carbon atoms; and
Condition (3): at least one of R² and R³ is a hydrocarbon group having 6 or more carbon atoms, preferably, an alkyl group wherein the total number of carbon atoms contained in R² and R³ is 12 or more.

Hereinafter, these groups will be shown specifically. In Condition (1), specific examples of the secondary or tertiary alkyl group having 4 or more and 6 or less carbon atoms include, but are not particularly limited to, 1-methylpropyl, 2-methylpropyl, 1,1-dimethylethyl, 2-methylbutyl, 2-ethylpropyl, 2,2-dimethylpropyl, 2-methylpentyl, 2-ethylbutyl, 2,2-dimethylbutyl, and 2-methyl-2-ethylpropyl groups. Among them, a 1-methylpropyl group is particularly preferred.

In Condition (2), specific examples of the alkyl group having 2 or 3 carbon atoms include, but are not particularly limited to, ethyl, 1-methylethyl, and propyl groups. Among them, an ethyl group is particularly preferred. Specific examples of the alkyl group having 4 or more carbon atoms include, but are not particularly limited to, butyl, pentyl, hexyl, heptyl, and octyl groups. Among them, butyl and hexyl groups are particularly preferred.

Alternatively, in Condition (3), specific examples of the hydrocarbon group having 6 or more carbon atoms include, but are not particularly limited to, hexyl, heptyl, octyl, nonyl, decyl, phenyl, and 2-naphthyl groups. Among these hydrocarbon groups, alkyl groups are preferred. Among the alkyl groups, hexyl and octyl groups are particularly preferred.

According to general tendencies, an alkyl group containing a larger number of carbon atoms is more soluble in an inert hydrocarbon solvent and forms a solution having a higher viscosity. A moderate long chain alkyl group is therefore preferably used in terms of handling. The organic magnesium compound can be diluted, for use, with an inert hydrocarbon solvent.

This solution can be used without any problem even if trace amounts of Lewis basic compounds such as ethers, esters, and amines are contained or remain therein.

Next, Y¹ will be described. In the formula 1, Y1 is any of alkoxy, siloxy, allyloxy, amino, amide, —N═C—R⁴, R⁵, —SR⁶ (wherein R⁴, R⁵, and R⁶ each independently represent a hydrocarbon group having 2 or more and 20 or less carbon atoms), and a β-keto acid residue.

In the formula 1, the hydrocarbon group represented by R⁴, R⁵, or R⁶ is preferably an alkyl or aryl group having 1 or more and 12 or less carbon atoms, particularly preferably an alkyl or aryl group having 3 or more and 10 or less carbon atoms. Examples include, but are not particularly limited to, methyl, ethyl, propyl, 1-methylethyl, butyl, 1-methylpropyl, 1,1-dimethylethyl, pentyl, hexyl, 2-methylpentyl, 2-ethylbutyl, 2-ethylpentyl, 2-ethylhexyl, 2-ethyl-4-methylpentyl, 2-propylheptyl, 2-ethyl-5-methyloctyl, octyl, nonyl, decyl, phenyl, and naphthyl groups. Among them, butyl, 1-methylpropyl, 2-methylpentyl and 2-ethylhexyl groups are particularly preferred.

In the formula 1, Y¹ is preferably an alkoxy group or a siloxy group. Specific examples of the alkoxy group preferably include, but are not particularly limited to, methoxy, ethoxy, propoxy, 1-methylethoxy, butoxy, 1-methylpropoxy, 1,1-dimethylethoxy, pentoxy, hexoxy, 2-methylpentoxy, 2-ethylbutoxy, 2-ethylpentoxy, 2-ethylhexoxy, 2-ethyl-4-methylpentoxy, 2-propylheptoxy, 2-ethyl-5-methyloctoxy, octoxy, phenoxy, and naphthoxy groups. Among them, butoxy, 1-methylpropoxy, 2-methylpentoxy, and 2-ethylhexoxy groups are more preferred. Specific examples of the siloxy group preferably include, but are not particularly limited to, hydrodimethylsiloxy, ethylhydromethylsiloxy, diethylhydrosiloxy, trimethylsiloxy, ethyldimethylsiloxy, diethylmethylsiloxy, and triethylsiloxy groups. Among them, hydrodimethylsiloxy, ethylhydromethylsiloxy, diethylhydrosiloxy, and trimethylsiloxy groups are more preferred.

In the present embodiment, the compound (A-1) can be synthesized by any method without particular limitations and may be synthesized by reacting, for example, an organic magnesium compound selected from the group consisting of the formulas R²MgX¹ and R²Mg (wherein R² is as defined above, and X¹ represents halogen) with an organic metal compound selected from the group consisting of the formulas M¹R³ₙ and M¹R³₍ₙ₋₁₎H (wherein M¹ and R³ are as defined above, and n represents the valence of M¹) at 25° C. or higher and 150° C. or lower in an inert hydrocarbon solvent and, if necessary, subsequently with a compound represented by the formula Y¹—H (wherein Y1 is as defined above) or with an organic magnesium compound and/or an organic aluminum compound having a functional group represented by Y¹. In the approach of reacting the organic magnesium compound soluble in an inert hydrocarbon solvent with a compound represented by the formula Y¹—H, the order in which the compounds are added to the reaction system is not particularly limited. Any of the following methods can be used: for example, the compound represented by the formula Y¹—H is added into the organic magnesium compound; the organic magnesium compound is added into the compound represented by the formula Y¹−H; and both of the compounds are added at the same time.

In the present embodiment, the molar composition ratio c/((α+β) of Y¹ to all metal atoms in the compound (A-1) is 0≤c/((α+)≤2, preferably 0≤c/((α+β)<1. The compound (A-1) wherein the molar composition ratio of Y¹ to all metal atoms is 2 or less tends to have better reactivity with the compound (A-2).

Next, the compound (A-2) will be described. The compound (A-2) is a titanium compound represented by the formula 2:

(A-2):Ti(OR⁷)_{d}X¹_{(4-d)} Formula 2

wherein d represents a real number of 0 or larger and 4 or smaller; R⁷ represents a hydrocarbon group having 1 or more and 20 or less carbon atoms; and X¹ represents a halogen atom.

In the formula 2, d is preferably 0 or larger and 1 or smaller, further preferably 0. In the formula 2, specific examples of the hydrocarbon group represented by R⁷ include, but are not particularly limited to: aliphatic hydrocarbon groups such as methyl, ethyl, propyl, butyl, pentyl, hexyl, 2-ethylhexyl, heptyl, octyl, decyl, and allyl groups; alicyclic hydrocarbon groups such as cyclohexyl, 2-methylcyclohexyl, and cyclopentyl groups; and aromatic hydrocarbon groups such as phenyl and naphthyl groups. Among them, aliphatic hydrocarbon groups are preferred. Examples of the halogen represented by X¹ include chlorine, bromine, and iodine. Among them, chlorine is preferred. In the present embodiment, the compound (A-2) is particularly preferably titanium tetrachloride. In the present embodiment, two or more compounds selected from these compounds may be used as a mixture.

Next, the reaction between the compounds (A-1) and (A-2) will be described. The reaction is preferably carried out in an inert hydrocarbon solvent and further preferably carried out in an aliphatic hydrocarbon solvent such as hexane or heptane. In the reaction, the molar ratio between (A-1) and (A-2) is not particularly limited, and the molar ratio (Ti/Mg) of Ti atom contained in the compound (A-2) to Mg atom contained in the compound (A-1) is preferably 0.1 or more and 10 or less, more preferably 0.3 or more and 3 or less. The reaction temperature is not particularly limited and is preferably within the range of −80° C. or higher and 150° C. or lower, further preferably within the range of −40° C. or higher and 100° C. or lower. The order in which the compounds (A-1) and (A-2) are added to the reaction system is not particularly limited. Any of the following methods can be used: the compound (A-2) is added subsequently to the compound (A-1); the compound (A-1) is added subsequently to the compound (A-2); and the compounds (A-1) and (A-2) are added at the same time. The method of adding the compounds (A-1) and (A-2) at the same time is preferred. In the present embodiment, the solid catalytic component [A] obtained by the reaction is used as a slurry solution with an inert hydrocarbon solvent.

Another example of the Ziegler-Natta catalytic component used in the present embodiment is preferably a catalyst for olefin polymerization comprising a solid catalytic component [C] and an organic metal compound component [B], wherein the solid catalytic component [C] is produced by reacting an organic magnesium compound (C-1) represented by the formula 3 which is soluble in an inert hydrocarbon solvent with a chlorinating agent (C-2) represented by the formula 4, and allowing an organic magnesium compound (C-4) represented by the formula 5 which is soluble in an inert hydrocarbon solvent and a titanium compound (C-5) represented by the formula 6 to be supported by a carrier (C-3) thus prepared:

(C-1):(M²)_{γ}(Mg)_{δ}(R⁸)_{c}(R⁹)_{f}(OR¹)_{g} Formula 3

wherein M² represents a metal atom selected from the group consisting of groups 12, 13, and 14 of the periodic system; R⁸, R⁹, and R¹⁰ each represent a hydrocarbon group having 2 or more and 20 or less carbon atoms; and γ, δ, e, f, and g each represent a real number that satisfies the following relationships: 0≤γ, 0<δ, 0≤e, 0≤f, 0≤g, 0<e+f, 0≤g/(γ+δ)≤2, and kγ+2δ=e+f+g (wherein k represents the valence of M²)

(C-2):HₕSiClᵢR¹¹₍₄₋₍ₕ₊ᵢ₎₎ Formula 4

wherein R¹¹ represents a hydrocarbon group having 1 or more and 12 or less carbon atoms; and h and i each represent a real number that satisfies the following relationships: 0<h, 0<i, and 0<h+i≤4;

(C-4):(M¹)_{α}(Mg)_{β}(R²)ₐ(R³)_{b}Y¹_{c} Formula 5

wherein M¹ represents a metal atom selected from the group consisting of groups 12, 13, and 14 of the periodic system; R² and R³ each represent a hydrocarbon group having 2 or more and 20 or less carbon atoms; Y¹ represents any of alkoxy, siloxy, allyloxy, amino, amide, —N═C—R⁴, R⁵, —SR⁶ (wherein R⁴, R⁵, and R⁶ each represent a hydrocarbon group having 1 or more and 20 or less carbon atoms, and when c is 2, Y¹ moieties may be different from each other), and a β-keto acid residue; and α, β, a, b, and c each represent a real number that satisfies the following relationships: 0≤α, 0≤β, 0≤a, 0≤b, 0≤c, 0<a+b, 0≤c/((α+β)≤2, and nα+2β=a+b+c (wherein n represents the valence of M¹); and

(C-5):Ti(OR⁷)_{d}X¹_{(4-d)} Formula 6

wherein d represents a real number of 0 or larger and 4 or smaller; R⁷ represents a hydrocarbon group having 1 or more and 20 or less carbon atoms; and X¹ represents a halogen atom.

First, the compound (C-1) will be described. The compound (C-1) is represented in the form of an organic magnesium complex compound soluble in an inert hydrocarbon solvent, but encompasses all of dihydrocarbyl magnesium compounds and their complexes with other metal compounds. In the formula 3, the relational expression kγ+2δ=e+f+g of the symbols γ, δ, e, f, and g represents the stoichiometry of metal atom valence and substituents.

In the formula 3, specific examples of the hydrocarbon group represented by R⁸ or R⁹ include, but are not particularly limited to, alkyl groups, cycloalkyl groups, and aryl groups, for example, methyl, ethyl, propyl, butyl, pentyl, hexyl, octyl, decyl, cyclohexyl, and phenyl groups. Among them, alkyl groups are preferred for each of R⁸ and R⁹. When 7>0, a metal atom selected from the group consisting of groups 12, 13, and 14 of the periodic system can be used as the metal atom M². Examples thereof include, but are not particularly limited to, zinc, boron, and aluminum. Among them, aluminum and zinc are particularly preferred.

The ratio δ/γ of magnesium to the metal atom M² is not particularly limited and is preferably 0.1 or more and 30 or less, further preferably 0.5 or more and 10 or less. In the case of using a predetermined organic magnesium compound wherein γ=0, for example, a compound wherein R⁸ is 1-methylpropyl is soluble in an inert hydrocarbon solvent. Such a compound also brings about a preferred consequence to the present embodiment. It is recommended that R⁸ and R⁹ satisfy any one of the following three conditions (1), (2), and (3) in the formula 3 wherein γ=0.

Condition (1) at least one of R⁸ and R⁹ is a secondary or tertiary alkyl group having 4 or more and 6 or less carbon atoms, preferably, both of R⁸ and R⁹ are alkyl groups having 4 or more and 6 or less carbon atoms and at least one of the groups is a secondary or tertiary alkyl group;
Condition (2): R⁸ and R⁹ are alkyl groups differing in the number of carbon atoms, preferably, R⁸ is an alkyl group having 2 or 3 carbon atoms and R⁹ is an alkyl group having 4 or more carbon atoms; and
Condition (3): at least one of R⁸ and R⁹ is a hydrocarbon group having 6 or more carbon atoms, preferably, an alkyl group wherein the total number of carbon atoms contained in R⁸ and R⁹ is 12 or more.

Hereinafter, these groups will be shown specifically. In Condition (1), specific examples of the secondary or tertiary alkyl group having 4 or more and 6 or less carbon atoms include 1-methylpropyl, 2-methylpropyl, 1,1-dimethylethyl, 2-methylbutyl, 2-ethylpropyl, 2,2-dimethylpropyl, 2-methylpentyl, 2-ethylbutyl, 2,2-dimethylbutyl, and 2-methyl-2-ethylpropyl groups. Among them, a 1-methylpropyl group is particularly preferred.

In Condition (2), examples of the alkyl group having 2 or 3 carbon atoms include, but are not particularly limited to, ethyl, 1-methylethyl, and propyl groups. Among them, an ethyl group is particularly preferred. Specific examples of the alkyl group having 4 or more carbon atoms, but are not particularly limited to, butyl, pentyl, hexyl, heptyl, and octyl groups. Among them, butyl and hexyl groups are particularly preferred.

Alternatively, in Condition (3), specific examples of the hydrocarbon group having 6 or more carbon atoms include, but are not particularly limited to, hexyl, heptyl, octyl, nonyl, decyl, phenyl, and 2-naphthyl groups. Among these hydrocarbon groups, alkyl groups are preferred. Among the alkyl groups, hexyl and octyl groups are particularly preferred.

According to general tendencies, an alkyl group containing a larger number of carbon atoms is more soluble in an inert hydrocarbon solvent and forms a solution having a higher viscosity. A moderately long-chain alkyl group is therefore preferably used in terms of handling. The organic magnesium compound is used as an inert hydrocarbon solution. This solution can be used without any problem even if trace amounts of Lewis basic compounds such as ethers, esters, and amines are contained or remain therein.

Next, the alkoxy group (OR¹⁰) will be described. The hydrocarbon group represented by R¹⁰ is preferably an alkyl or aryl group having 1 or more and 12 or less carbon atoms, particularly preferably an alkyl or aryl group having 3 or more and 10 or less carbon atoms. Specific examples of R¹⁰ include, but are not particularly limited to, methyl, ethyl, propyl, 1-methylethyl, butyl, 1-methylpropyl, 1,1-dimethylethyl, pentyl, hexyl, 2-methylpentyl, 2-ethylbutyl, 2-ethylpentyl, 2-ethylhexyl, 2-ethyl-4-methylpentyl, 2-propylheptyl, 2-ethyl-5-methyloctyl, octyl, nonyl, decyl, phenyl, and naphthyl groups. Among them, butyl, 1-methylpropyl, 2-methylpentyl, and 2-ethylhexyl groups are particularly preferred.

In the present embodiment, the compound (C-1) can be synthesized by any method without particular limitations and is preferably synthesized by a method of reacting an organic magnesium compound selected from the group consisting of the formulas R⁸MgX^{I} and R^{B}Mg (wherein R⁸ is as defined above, and X¹ represents a halogen atom) with an organic metal compound selected from the group consisting of the formulas M²R⁹ₖ and M²R⁹₍ₖ₋₁₎H (wherein M², R⁹, and k are as defined above) at a temperature of 25° C. or higher and 150° C. or lower in an inert hydrocarbon solvent and, if necessary, subsequently with an alcohol having a hydrocarbon group represented by R⁹ (wherein R⁹ is as defined above) or an alkoxy magnesium compound and/or an alkoxy aluminum compound having a hydrocarbon group represented by R⁹ which is soluble in an inert hydrocarbon solvent.

In the approach of reacting the organic magnesium compound soluble in an inert hydrocarbon solvent with an alcohol, the order in which the compounds are added to the reaction system is not particularly limited. Any of the following methods can be used: the alcohol is added into the organic magnesium compound; the organic magnesium compound is added into the alcohol; and both of the compounds are added at the same time. In the present embodiment, the ratio between the organic magnesium compound soluble in an inert hydrocarbon solvent and the alcohol in the reaction is not particularly limited, and the molar composition ratio g/(γ+δ) of the alkoxy group to all metal atoms in the resulting alkoxy group-containing organic magnesium compound is 0≤g/(γ+δ)≤2, preferably 0≤g/(γ+S)<1.

Next, the compound (C-2) will be described. The compound (C-2) is a silicon chloride compound having at least one Si—H bond, represented by the formula 4:

(C-2):HₕSiClᵢR¹¹₍₄₋₍ₕ₊ᵢ₎₎ Formula 4

wherein R¹¹ represents s hydrocarbon group having 1 or more and 12 or less carbon atoms; and h and i each represent a real number that satisfies the following relationships: 0<h, 0<i, and 0<h+i≤4.

In the formula 4, specific examples of the hydrocarbon group represented by R¹¹ include, but are not particularly limited to, aliphatic hydrocarbon groups, alicyclic hydrocarbon groups, and aromatic hydrocarbon groups, for example, methyl, ethyl, propyl, 1-methylethyl, butyl, pentyl, hexyl, octyl, decyl, cyclohexyl, and phenyl groups. Among them, alkyl groups having 1 or more and 10 or less carbon atoms are preferred, and alkyl groups having 1 or more and 3 or less carbon atoms, such as methyl, ethyl, propyl, and 1-methylethyl group are further preferred. Each of h and i is a number larger than 0 that satisfies the relationship h+i 4. Preferably, i is 2 or larger and 3 or smaller.

Specific examples of such a compound include, but are not particularly limited to, HSiCl₃, HSiCl₂CH₃, HSiCl₂C₂H₅, HSiCl₂(C₃H₇), HSiCl₂(2-C₃H₇), HSiCl₂(C₄H₉), HSiCl₂(C₆H₅), HSiCl₂(4-Cl—C₆H₄), HSiCl₂(CH═CH₂), HSiCl₂(CH₂C₆H₅), HSiCₗ₂(1-CiOH₇), HSiCl₂(CH₂CH═CH₂), H₂SiCl(CH₃), H₂SiCl(C₂H₅), HSiCl(CH₃)₂, HSiCl(C₂H₅)₂, HSiCl(CH₃) (2-C₃H₇), HSiCl(CH₃) (C₆H₅), and HSiCl(C₆H₅)₂.

These silicon chloride compounds are used each alone or as a mixture of two or more types selected from these compounds. Among them, HSiCl₃, HSiCl₂CH₃, HSiCl(CH₃)₂, and HSiCl₂(C₃H₇) are preferred, and HSiCl₃ and HSiCl₂CH₃ are more preferred.

Next, the reaction between the compounds (C-1) and (C-2) will be described. For the reaction, the compound (C-2) is preferably used after being diluted in advance with an inert hydrocarbon solvent, a chlorinated hydrocarbon (e.g., 1,2-dichloroethane, o-dichlorobenzene, or dichloromethane), an ether vehicle (e.g., diethyl ether or tetrahydrofuran), or a mixed vehicle thereof. Among them, an inert hydrocarbon solvent is more preferred in terms of the performance of the catalyst. The ratio between (C-1) and (C-2) in the reaction is not particularly limited and is preferably 0.01 mol or higher and 100 mol or lower, further preferably 0.1 mol or higher and 10 mol or lower, of silicon atom contained in the compound (C-2) per 1 mol of magnesium atom contained in the compound (C-1).

The method for reacting the compounds (C-1) and (C-2) is not particularly limited. Any of the following methods can be used: the compounds (C-1) and (C-2) are reacted while introduced at the same time to a reactor (simultaneous addition method); a reactor is charged with the compound (C-2) in advance, and then, the compound (C-1) is introduced to the reactor; and a reactor is charged with the compound (C-1) in advance, and then, the compound (C-2) is introduced to the reactor. Among them, the method of charging a reactor with the compound (C-2) in advance and then introducing the compound (C-1) to the reactor is preferred. The carrier (C-3) obtained by the reaction is preferably separated by filtration or decantation and then thoroughly washed with an inert hydrocarbon solvent to remove unreacted materials or by-products, etc.

The temperature of the reaction between the compounds (C-1) and (C-2) is not particularly limited and is preferably 25° C. or higher and 150° C. or lower, more preferably 30° C. or higher and 120° C. or lower, further preferably 40° C. or higher and 100° C. or lower. In the simultaneous addition method in which the compounds (C-1) and (C-2) are reacted while introduced at the same time to a reactor, the reaction temperature is preferably adjusted to a predetermined temperature by preliminarily setting the temperature of the reactor to a predetermined temperature and adjusting the temperature in the reactor to a predetermined temperature while performing the simultaneous addition. In the method of charging a reactor with the compound (C-2) in advance and then introducing the compound (C-1) to the reactor, the reaction temperature is preferably adjusted to a predetermined temperature by adjusting the temperature of the reactor charged with the silicon chloride compound to a predetermined temperature and adjusting the temperature in the reactor to a predetermined temperature while introducing the organic magnesium compound to the reactor. In the method of charging a reactor with the compound (C-1) in advance and then introducing the compound (C-2) to the reactor, the reaction temperature is preferably adjusted to a predetermined temperature by adjusting the temperature of the reactor charged with the compound (C-1) to a predetermined temperature and adjusting the temperature in the reactor to a predetermined temperature while introducing the compound (C-2) to the reactor.

Next, the organic magnesium compound (C-4) will be described. The compound (C-4) is preferably represented by the formula 5(C-4):

(C-4):(M¹)α(Mg)_{β}(R²)a(R³)_{b}Y¹_{c} Formula 5

wherein M¹ represents a metal atom selected from the group consisting of groups 12, 13, and 14 of the periodic system; R² and R³ each represent a hydrocarbon group having 2 or more and 20 or less carbon atoms; Y¹ represents any of alkoxy, siloxy, allyloxy, amino, amide, —N═C—R⁴, R⁵, —SR⁶ (wherein R⁴, R⁵, and R⁶ each represent a hydrocarbon group having 1 or more and 20 or less carbon atoms, and when c is 2, Y¹ moieties may be different from each other), and a β-keto acid residue; and α, β, a, b, and c each represent a real number that satisfies the following relationships: 0≤a, 0<β, 0≤a, 0 b, 0<a+b, 0≤c/((α+β)≤2, and nα+2β=a+b+c (wherein n represents the valence of M¹).

The amount of the compound (C-4) used is preferably 0.1 or more and 10 or less, more preferably 0.5 or more and 5 or less, in terms of the molar ratio of magnesium atom contained in the compound (C-4) to titanium atom contained in the compound (C-5).

The temperature of the reaction between the compounds (C-4) and (C-5) is not particularly limited and is preferably −80° C. or higher and 150° C. or lower, more preferably within the range of −40° C. or higher and 100° C. or lower.

The concentration of the compound (C-4) in use is not particularly limited and is preferably 0.1 mol/L or higher and 2 mol/L or lower, more preferably 0.5 mol/L or higher and 1.5 mol/L or lower, on the basis of titanium atom contained in the compound (C-4). An inert hydrocarbon solvent is preferably used for diluting the compound (C-4).

The order in which the compounds (C-4) and (C-5) are added to the carrier (C-3) is not particularly limited. Any of the following methods can be used: the compound (C-5) is added subsequently to the compound (C-4); the compound (C-4) is added subsequently to the compound (C-5); and the compounds (C-4) and (C-5) are added at the same time. Among them, the method of adding the compounds (C-4) and (C-5) at the same time is preferred. The reaction between the compounds (C-4) and (C-5) is carried out in an inert hydrocarbon solvent, preferably in an aliphatic hydrocarbon solvent such as hexane or heptane. The catalyst thus obtained is used as a slurry solution with an inert hydrocarbon solvent.

Next, the compound (C-5) will be described. In the present embodiment, the compound (C-5) is a titanium compound represented by the formula 6:

(C-5): Ti(OR⁷)_{d}X¹_{(4-d)} Formula 6

wherein d represents a real number of 0 or larger and 4 or smaller; R⁷ represents a hydrocarbon group having 1 or more and 20 or less carbon atoms; and X¹ represents a halogen atom.

In the formula 6, specific examples of the hydrocarbon group represented by R⁷ include, but are not particularly limited to: aliphatic hydrocarbon groups such as methyl, ethyl, propyl, butyl, pentyl, hexyl, 2-ethylhexyl, heptyl, octyl, decyl, and allyl groups; alicyclic hydrocarbon groups such as cyclohexyl, 2-methylcyclohexyl, and cyclopentyl groups; and aromatic hydrocarbon groups such as phenyl and naphthyl groups. Among them, aliphatic hydrocarbon groups are preferred. Specific examples of the halogen represented by X¹ include, but are not particularly limited to, chlorine, bromine, and iodine. Among them, chlorine is preferred. One compound selected from these compounds may be used alone as the compound (C-5), or two or more compounds selected from these compounds may be used as a mixture.

The amount of the compound (C-5) used is not particularly limited and is preferably 0.01 or more and 20 or less, particularly preferably 0.05 or more and 10 or less, in terms of the molar ratio to magnesium atom contained in the carrier (C-3).

The reaction temperature for the compound (C-5) is not particularly limited and is preferably −80° C. or higher and 150° C. or lower, further preferably within the range of −40° C. or higher and 100° C. or lower.

In the present embodiment, the method for allowing the compound (C-5) to be supported by the carrier (C-3) is not particularly limited and may involve reacting an excess of the compound (C-5) with the carrier (C-3) and/or using a third component to efficiently support the compound (C-5). A method of achieving this supporting through the reaction between the compound (C-5) and the organic magnesium compound (C-4) is preferred.

Next, the organic metal compound component [B] for use in the present embodiment will be described. The solid catalytic component for use in the present embodiment can serve as a highly active catalyst for polymerization by combination with the organic metal compound component [B]. The organic metal compound component [B] is also called a “promoter.” The organic metal compound component [B] is preferably a compound containing a metal selected from the group consisting of groups 1, 2, 12, and 13 of the periodic system, particularly preferably an organic aluminum compound and/or an organic magnesium compound.

Compounds represented by the formula 7 are preferably used each alone or as a mixture as the organic aluminum compound:

AlR¹²ⱼZ¹₍₃₋ⱼ₎ Formula 7

wherein R¹² represents a hydrocarbon group having 1 or more and 20 or less carbon atoms; Z¹ represents a group selected from the group consisting of hydrogen, halogen, alkoxy, allyloxy, and siloxy groups; and j represents any number of 2 or larger and 3 or smaller.

In the formula 7, specific examples of the hydrocarbon group having 1 or more and 20 or less carbon atoms, represented by R¹² include, but are not particularly limited to, aliphatic hydrocarbons, aromatic hydrocarbons, and alicyclic hydrocarbons, for example, trialkyl aluminum compounds such as trimethyl aluminum, triethyl aluminum, tripropyl aluminum, tributyl aluminum, tri(2-methylpropyl)aluminum (or triisobutyl aluminum), tripentyl aluminum, tri(3-methylbutyl)aluminum, trihexyl aluminum, trioctyl aluminum, and tridecyl aluminum; aluminum halide compounds such as diethyl aluminum chloride, ethyl aluminum dichloride, bis(2-methylpropyl)aluminum chloride, ethyl aluminum sesquichloride, and diethyl aluminum bromide; alkoxy aluminum compounds such as diethyl aluminum ethoxide and bis(2-methylpropyl)aluminum butoxide; siloxy aluminum compounds such as dimethylhydrosiloxy aluminum dimethyl, ethylmethylhydrosiloxy aluminum diethyl, and ethyldimethylsiloxy aluminum diethyl; and mixtures thereof. Among them, trialkyl aluminum compounds are particularly preferred.

The organic magnesium compound is preferably an organic magnesium compound represented by the formula 3 which is soluble in an inert hydrocarbon solvent:

(M²)_{γ}(Mg)_{δ}(R¹)ₑ(R¹)_{f}(OR¹⁰)_{g} Formula 3

wherein M² represents a metal atom selected from the group consisting of groups 12, 13, and 14 of the periodic system; R⁸, R⁹, and R¹⁰ each represent a hydrocarbon group having 2 or more and 20 or less carbon atoms; and γ, δ, e, f, and g each represent a real number that satisfies the following relationships: 0 γ, 0<6, 0≤e, 0 f, 0≤g, 0<e+f, 0≤g/(γ+δ)≤2, and kγ+2δ=e+f+g (wherein k represents the valence of M²).

This organic magnesium compound is represented in the form of an organic magnesium complex compound soluble in an inert hydrocarbon solvent, but encompasses all of dialkyl magnesium compounds and their complexes with other metal compounds. Although γ, δ, e, f, g, M², R⁸, R⁹, and OR¹⁰ are as already defined, this organic magnesium compound is preferably a compound wherein the ratio δ/γ is in the range of 0.5 or more and 10 or less, more preferably a compound wherein M² is aluminum, because a compound having higher solubility in an inert hydrocarbon solvent is more preferred.

The ratio between the solid catalytic component and the organic metal compound component [B] to be combined is not particularly limited and is preferably 1 mmol or higher and 3,000 mmol or lower of the organic metal compound component [B] per g of the solid catalytic component.

### <Metallocene Catalyst>

A general transition metal compound is used in cases using the metallocene catalyst. Examples of the method for producing the metallocene catalyst include, but are not particularly limited to, a production method described in Japanese Patent No. 4868853. Such a metallocene catalyst is constituted by: two catalytic components of (a) a transition metal compound having a cyclic η-binding anionic ligand and (b) an activating agent capable of forming a complex that exerts catalytic activity through reaction with the transition metal compound.

The transition metal compound having a cyclic r-binding anionic ligand used in the present embodiment can be represented by, for example, the following formula 8:

L¹ⱼWₖM³X²ₚX³_{q} Formula 8

In the formula 8, each L¹ independently represents a cyclic η-binding anionic ligand selected from the group consisting of a cyclopentadienyl group, an indenyl group, a tetrahydroindenyl group, a fluorenyl group, a tetrahydrofluorenyl group, and an octahydrofluorenyl group, and this ligand optionally has 1 to 8 substituents, wherein the substituents each independently represent a substituent having up to 20 non-hydrogen atoms, selected from the group consisting of hydrocarbon groups having 1 to 20 carbon atoms, halogen atoms, halogen-substituted hydrocarbon groups having 1 to 12 carbon atoms, aminohydrocarbyl groups having 1 to 12 carbon atoms, hydrocarbyloxy groups having 1 to 12 carbon atoms, dihydrocarbylamino groups having 1 to 12 carbon atoms, hydrocarbylphosphino groups having 1 to 12 carbon atoms, a silyl group, an aminosilyl group, hydrocarbyloxysilyl groups having 1 to 12 carbon atoms, and halosilyl groups.

In the formula 8, M³ represents a transition metal selected from transition metal groups belonging to group 4 of the periodic system, wherein the formal oxidation number is +2, +3, or +4, and this transition metal is bonded to at least one ligand L¹ via η⁵ bond.

In the formula 8, W represents a divalent substituent having up to 50 non-hydrogen atoms, and this divalent substituent monovalently binds to each of L¹ and M³ and thereby forms a metallacycle in collaboration with L¹ and M³. Each X² independently represents an anionic σ-binding type ligand having up to 60 non-hydrogen atoms, selected from the group consisting of a monovalent anionic σ-binding type ligand, a divalent anionic σ-binding type ligand divalently binding to M³, and a divalent anionic σ-binding type ligand monovalently binding to each of L¹ and M³.

In the formula 8, each X² independently represents a neutral Lewis base-coordinating compound having up to 40 non-hydrogen atoms, and X³ represents a neutral Lewis base-coordinating compound.

j is 1 or 2 provided that when j is 2, two ligands L¹ are optionally bonded to each other via a divalent group having up to 20 non-hydrogen atoms, wherein the divalent group is a group selected from the group consisting of hydrocarbadiyl groups having 1 to 20 carbon atoms, halohydrocarbadiyl groups having 1 to 12 carbon atoms, hydrocarbyleneoxy groups having 1 to 12 carbon atoms, hydrocarbyleneamino groups having 1 to 12 carbon atoms, a silanediyl group, halosilanediyl groups, and a silyleneamino group.

k is 0 or 1. p is 0, 1, or 2 provided that: when X² is a monovalent anionic σ-binding type ligand or a divalent anionic σ-binding type ligand binding to L¹ and M³, p is an integer smaller by at least 1 than the formal oxidation number of M³; and when X² is a divalent anionic σ-binding type ligand binding only to M³, p is an integer smaller by at least (j+1) than the formal oxidation number of M³. q is 0, 1, or 2.

Examples of the ligand X² in the compound of the formula 8 include halides, hydrocarbon groups having 1 to 60 carbon atoms, hydrocarbyloxy groups having 1 to 60 carbon atoms, hydrocarbylamide groups having 1 to 60 carbon atoms, hydrocarbyl phosphide groups having 1 to 60 carbon atoms, hydrocarbyl sulfide groups having 1 to 60 carbon atoms, a silyl group, and combinations thereof.

Examples of the neutral Lewis base-coordinating compound X³ in the compound of the formula 8 include phosphines, ethers, amines, olefins having 2 to 40 carbon atoms, dienes having 1 to 40 carbon atoms, and divalent groups induced from these compounds.

In the present embodiment, the transition metal compound having a cyclic η-binding anionic ligand is preferably a transition metal compound represented by the formula 8 wherein j=1. Preferred examples of the compound represented by the formula 8 wherein j=1 include compounds represented by the following formula 9:

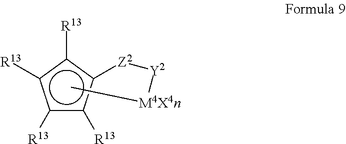

In the formula 9, M⁴ represents a transition metal selected from the group consisting of titanium, zirconium, nickel, and hafnium, wherein the formal oxidation number of the transition metal is +2, +3, or +4. Each R¹³ independently represents a hydrogen atom or a substituent having up to 20 non-hydrogen atoms, selected from the group consisting of hydrocarbon groups having 1 to 8 carbon atoms, a silyl group, a germyl group, a cyano group, halogen atoms, and combinations thereof provided that when the substituent R¹³ is a hydrocarbon group having 1 to 8 carbon atoms, a silyl group, or a germyl group, two adjacent substituents R¹³ are optionally bonded to each other to form a divalent group, which can form a ring in collaboration with the bond between two carbon atoms of the cyclopentadienyl ring bonded to these two adjacent substituents R¹³, respectively.

In the formula 9, each X⁴ independently represents a substituent having up to 20 non-hydrogen atoms, selected from the group consisting of halides, hydrocarbon groups having 1 to 20 carbon atoms, hydrocarbyloxy groups having 1 to 18 carbon atoms, hydrocarbylamino groups having 1 to 18 carbon atoms, a silyl group, hydrocarbylamide groups having 1 to 18 carbon atoms, hydrocarbyl phosphide groups having 1 to 18 carbon atoms, hydrocarbyl sulfide groups having 1 to 18 carbon atoms, and combinations thereof provided that two substituents X⁴ can optionally form in collaboration a neutral conjugate diene having 4 to 30 carbon atoms or a divalent group.

In the formula 9, Y² represents —O—, —S—, —NR*—, or —PR*— wherein R* represents a hydrogen atom, a hydrocarbon group having 1 to 12 carbon atoms, a hydrocarbyloxy group having 1 to 8 carbon atoms, a silyl group, an alkyl halide group having 1 to 8 carbon atoms, an aryl halide group having 6 to 20 carbon atoms, or a combination thereof.

In the formula 9, Z² represents SiR*₂, CR*₂, SiR*₂SiR*₂, CR*₂CR*₂, CR*=CR*, CR*₂SiR*₂, or GeR*₂ wherein R* is as defined above. n is 1, 2, or 3.

Examples of the transition metal compound having a cyclic η-binding anionic ligand used in the present embodiment include compounds as shown below. Specific examples of the zirconium compounds include, but are not particularly limited to, bis(methylcyclopentadienyl)zirconium dimethyl, bis(n-butylcyclopentadienyl)zirconium dimethyl, bis(indenyl)zirconium dimethyl, bis(1,3-dimethylcyclopentadienyl)zirconium dimethyl, (pentamethylcyclopentadienyl) (cyclopentadienyl)zirconium dimethyl, bis(cyclopentadienyl)zirconium dimethyl, bis(pentamethylcyclopentadienyl)zirconium dimethyl, bis(fluorenyl)zirconium dimethyl, ethylenebis(indenyl)zirconium dimethyl, ethylenebis(4,5,6,7-tetrahydro-1-indenyl)zirconium dimethyl, ethylenebis(4-methyl-1-indenyl)zirconium dimethyl, ethylenebis(5-methyl-1-indenyl)zirconium dimethyl, ethylenebis(6-methyl-1-indenyl)zirconium dimethyl, ethylenebis(7-methyl-1-indenyl)zirconium dimethyl, ethylenebis(5-methoxy-1-indenyl)zirconium dimethyl, ethylenebis(2,3-dimethyl-1-indenyl)zirconium dimethyl, ethylenebis(4,7-dimethyl-1-indenyl)zirconium dimethyl, ethylenebis-(4,7-dimethoxy-1-indenyl)zirconium dimethyl, methylenebis(cyclopentadienyl)zirconium dimethyl, isopropylidene(cyclopentadienyl)zirconium dimethyl, isopropylidene (cyclopentadienyl-fluorenyl)zirconium dimethyl, silylenebis(cyclopentadienyl)zirconium dimethyl, and dimethylsilylene(cyclopentadienyl)zirconium dimethyl.

Specific examples of the titanium compounds include, but are not particularly limited to, [(N-t-butylamido) (tetramethyl-η⁵-cyclopentadienyl)-1,2-ethanediyl]titanium dimethyl, [(N-t-butylamido) (tetramethyl-η⁵-cyclopentadienyl)dimethylsilane]titanium dimethyl, [(N-methylamido) (tetramethyl-η⁵-cyclopentadienyl)dimethylsilane]titanium dimethyl, [(N-phenylamido) (tetramethyl-η⁵-cyclopentadienyl)dimethylsilane]titanium dimethyl, [(N-benzylamido) (tetramethyl-η⁵-cyclopentadienyl)dimethylsilane]titanium dimethyl, [(N-t-butylamido) (η⁵-cyclopentadienyl)-1,2-ethanediyl] titanium dimethyl, [(N-t-butylamido)(115-cyclopentadienyl)dimethylsilane]titanium dimethyl, [(N-methylamido) (η⁵-cyclopentadienyl)-1,2-ethanediyl] titanium dimethyl, [(N-methylamido) (η⁵-cyclopentadienyl)dimethylsilane]titanium dimethyl, [(N-t-butylamido) (η⁵-indenyl)dimethylsilane]titanium dimethyl, and [(N-benzylamido) (η⁵-indenyl)dimethylsilane]titanium dimethyl.

Specific examples of the nickel compounds include, but are not particularly limited to, dibromobistriphenylphosphine nickel, dichlorobistriphenylphosphine nickel, dibromodiacetonitrile nickel, dibromodibenzonitrile nickel, dibromo(1,2-bisdiphenylphosphinoethane)nickel, dibromo(1,3-bisdiphenylphosphinopropane)nickel, dibromo(1,1′-diphenylbisphosphinoferrocene)nickel, dimethylbisdiphenylphosphine nickel, dimethyl(1,2-bisdiphenylphosphinoethane)nickel, methyl(1,2-bisdiphenylphosphinoethane)nickel tetrafluoroborate, (2-diphenylphosphino-1-phenylethyleneoxy)phenylpyridine nickel, dichlorobistriphenylphosphine palladium, dichlorodibenzonitrile palladium, dichlorodiacetonitrile palladium, dichloro(1,2-bisdiphenylphosphinoethane)palladium, bistriphenylphosphine palladium bistetrafluoroborate, and bis(2,2′-bipyridine)methyl iron tetrafluoroborate etherate.

Specific examples of the hafnium compounds include, but are not particularly limited to, [(N-t-butylamido) (tetramethyl-η5-cyclopentadienyl)-1,2-ethanediyl]hafnium dimethyl, [(N-t-butylamido) (tetramethyl-η5-cyclopentadienyl)dimethylsilane]hafnium dimethyl, [(N-methylamido) (tetramethyl-η5-cyclopentadienyl)dimethylsilane]hafnium dimethyl, [(N-phenylamido) (tetramethyl-η5-cyclopentadienyl)dimethylsilane]hafnium dimethyl, [(N-benzylamido) (tetramethyl-η5-cyclopentadienyl)dimethylsilane]hafnium dimethyl, [(N-t-butylamido) (15-cyclopentadienyl)-1,2-ethanediyl]hafnium dimethyl, [(N-t-butylamido)(115-cyclopentadienyl)dimethylsilane]hafnium dimethyl, [(N-methylamido) (15-cyclopentadienyl)-1,2-ethanediyl]hafnium dimethyl, [(N-methylamido) (15-cyclopentadienyl)dimethylsilane]hafnium dimethyl, [(N-t-butylamido) (15-indenyl)dimethylsilane]hafnium dimethyl, and [(N-benzylamido) (115-indenyl)dimethylsilane] hafnium dimethyl.

Specific examples of the transition metal compound having a cyclic η-binding anionic ligand used in the present embodiment further include compounds named by the replacement of the moiety “dimethyl” (which appears at the end of the name of each compound, i.e., immediately after the moiety “zirconium” or “titanium”, and corresponds to the moiety of X⁴ in the formula 9) in the name of each zirconium compound or titanium compound listed above with, for example, any of “dichloro”, “dibromo”, “diiodo”, “diethyl”, “dibutyl”, “diphenyl”, “dibenzyl”, “2-(N,N-dimethylamino)benzyl”, “2-butene-1,4-diyl”, “s-trans-η4-1,4-diphenyl-1,3-butadiene”, “s-trans-η⁴-3-methyl-1,3-pentadiene”, “s-trans-η⁴-1,4-dibenzyl-1,3-butadiene”, “s-trans-η⁴-2,4-hexadiene”, “s-trans-η⁴-1,3-pentadiene”, “s-trans-η⁴-1,4-ditolyl-1,3-butadiene”, “s-trans-η⁴-1,4-bis(trimethylsilyl)-1,3-butadiene”, “s-cis-η⁴-1,4-diphenyl-1,3-butadiene”, “s-cis-η⁴-3-methyl-1,3-pentadiene”, “s-cis-η⁴-1,4-dibenzyl-1,3-butadiene”, “s-cis-η⁴-2,4-hexadiene”, “s-cis-η⁴-1,3-pentadiene”, “s-cis-η⁴-1,4-ditolyl-1,3-butadiene”, and “s-cis-η⁴-1,4-bis(trimethylsilyl)-1,3-butadiene”.

The transition metal compound having a cyclic η-binding anionic ligand used in the present embodiment can be synthesized by a method generally known in the art. In the present embodiment, these transition metal compounds may be used singly or in combination.

Next, the activating agent b) capable of forming a complex that exerts catalytic activity through reaction with the transition metal compound (hereinafter, also simply referred to as an “activating agent”) used in the present embodiment will be described.

Examples of the activating agent for use in the present embodiment include compounds represented by the following formula 10:

[L²−H]^{d+}[M⁵ₘQₚ]^{d-} Formula 10

wherein [L²−H]^{d+} represents a proton-donating Bronsted acid wherein L² represents a neutral Lewis base, and d represents an integer of 1 to 7; and [M⁵ₘQₚ]^{d-} represents a compatible non-coordinating anion wherein M⁵ represents a metal belonging to any of groups 5 to 15 of the periodic system, or a metalloid, each Q is independently selected from the group consisting of hydrides, halides, dihydrocarbylamide groups having 2 to 20 carbon atoms, hydrocarbyloxy groups having 1 to 30 carbon atoms, hydrocarbon groups having 1 to 30 carbon atoms, and substituted hydrocarbon groups having 1 to 40 carbon atoms wherein the number of the halide represented by Q is 1 or less, m represents an integer of 1 to 7, p represents an integer of 2 to 14, and d is as defined above provided that p−m=d.

Specific examples of the non-coordinating anion include, but are not particularly limited to, tetrakisphenyl borate, tri(p-tolyl) (phenyl) borate, tris(pentafluorophenyl) (phenyl) borate, tris(2,4-dimethylphenyl) (phenyl) borate, tris(3,5-dimethylphenyl) (phenyl) borate, tris(3,5-di-trifluoromethylphenyl) (phenyl) borate, tris(pentafluorophenyl) (cyclohexyl) borate, tris(pentafluorophenyl)(naphthyl) borate, tetrakis(pentafluorophenyl) borate, triphenyl(hydroxyphenyl) borate, diphenyl-di(hydroxyphenyl) borate, triphenyl(2,4-dihydroxyphenyl) borate, tri(p-tolyl) (hydroxyphenyl) borate, tris(pentafluorophenyl) (hydroxyphenyl) borate, tris(2,4-dimethylphenyl) (hydroxyphenyl) borate, tris(3,5-dimethylphenyl) (hydroxyphenyl) borate, tris(3,5-di-trifluoromethylphenyl) (hydroxyphenyl) borate, tris(pentafluorophenyl) (2-hydroxyethyl) borate, tris(pentafluorophenyl) (4-hydroxybutyl) borate, tris(pentafluorophenyl) (4-hydroxy-cyclohexyl) borate, tris(pentafluorophenyl) (4-(4′-hydroxyphenyl)phenyl) borate, and tris(pentafluorophenyl) (6-hydroxy-2-naphthyl) borate.

Other preferred examples of the non-coordinating anion include borates derived from the borates listed above by the replacement of the hydroxy group with a NHR group wherein R is preferably a methyl group, an ethyl group, or a tert-butyl group.

Specific examples of the proton-donating Bronsted acid include, but are not particularly limited to: trialkyl group-substituted ammonium cations such as triethylammonium, tripropylammonium, tri(n-butyl)ammonium, trimethylammonium, tributylammonium, and tri(n-octyl)ammonium; N,N-dialkylanilinium cations such as N,N-dimethylanilinium, N,N-diethylanilinium, N,N-2,4,6-pentamethylanilinium, and N,N-dimethylbenzylanilinium; dialkylammonium cations such as di-(i-propyl)ammonium and dicyclohexylammonium; triarylphosphonium cations such as triphenylphosphonium, tri(methylphenyl)phosphonium, and tri(dimethylphenyl)phosphonium; and dimethylsulfonium, diethylsulfonium, and diphenylsulfonium.

In the present embodiment, an organic metal oxy compound having unit represented by the following formula 11 may be used as the activating agent:

M⁶R¹⁴ₙ₋₂ Formula 11

wherein M⁶ represents a metal belonging to any of groups 13 to 15 of the periodic system, or a metalloid, each R¹⁴ independently represents a hydrocarbon group having 1 to 12 carbon atoms or a substituted hydrocarbon group, n represents the valence of the metal M⁶, and m represents an integer of 2 or larger.

As a preferred example, the activating agent for use in the present embodiment is, for example, an organic aluminum oxy compound comprising a unit represented by the following formula 12:

AlR¹⁵—O Formula 12

wherein R¹⁵ represents an alkyl group having 1 to 8 carbon atoms, and m represents an integer of 2 to 60.

As a more preferred example, the activating agent for use in the present embodiment is, for example, a methylalumoxane comprising a unit represented by the following formula 13:

Al(CH₃—O Formula 13

wherein m represents an integer of 2 to 60.

In the present embodiment, these activating agent components may be used singly or in combination.

In the present embodiment, such a catalytic component may be used as a supported catalyst in which the component is supported by a solid component. Such a solid component is not particularly limited and is specifically, for example, at least one inorganic solid material selected from: porous polymer materials such as polyethylene, polypropylene, and styrene-divinylbenzene copolymers; inorganic solid materials having an element belonging to any of groups 2, 3, 4, 13, and 14 of the periodic system, such as silica, alumina, magnesia, magnesium chloride, zirconia, titania, boron oxide, calcium oxide, zinc oxide, barium oxide, vanadium pentaoxide, chromium oxide, and thorium oxide, and mixtures thereof; and complex oxides thereof.

Specific examples of the complex oxides of silica include, but are not particularly limited to, complex oxides of silica and an element of group 2 or 13 of the periodic system, such as silica-magnesia and silica-alumina. In the present embodiment, in addition to the two catalytic components mentioned above, an organic aluminum compound can be used, if necessary, as a catalytic component. The organic aluminum compound that can be used in the present embodiment is, for example, a compound represented by the following formula 14:

AlR¹⁶ₙX⁵₃₋ₙ Formula 14

wherein R¹⁶ represents an alkyl group having 1 to 12 carbon atoms or an aryl group having 6 to 20 carbon atoms, X⁵ represents halogen, hydrogen, or an alkoxyl group, wherein the alkyl group is linear, branched, or cyclic, and n represents an integer of 1 to 3.

In this context, the organic aluminum compound may be a mixture of compounds represented by the formula 14. In the organic aluminum compound that can be used in the present embodiment, examples of R¹⁶ in the formula include a methyl group, an ethyl group, a butyl group, an isobutyl group, a hexyl group, an octyl group, a decyl group, a phenyl group, and a tolyl group. Examples of X⁵ in the formula include a methoxy group, an ethoxy group, a butoxy group, and chloro.

Specific examples of the organic aluminum compound that can be used in the present embodiment include, but are not particularly limited to, trimethyl aluminum, triethyl aluminum, tributyl aluminum, triisobutyl aluminum, trihexyl aluminum, trioctyl aluminum, and tridecyl aluminum. Alternative examples of the organic aluminum compound that can be used in the present embodiment include reaction products of these organic aluminums and alcohols such as methyl alcohol, ethyl alcohol, butyl alcohol, pentyl alcohol, hexyl alcohol, octyl alcohol, and decyl alcohol, for example, dimethyl methoxy aluminum, dimethyl ethoxy aluminum, and dibutyl butoxy aluminum.

### (Polymerization Conditions)

In the method for producing the ultrahigh-molecular-weight polyethylene powder of the present embodiment, the polymerization temperature is usually 30° C. or higher and 100° C. or lower. The polymerization temperature equal to or higher than 30° C. tends to realize efficient industrial production. On the other hand, the polymerization temperature equal to or lower than 100° C. tends to realize continuous stable operation. The intrinsic viscosity IV of the ultrahigh-molecular-weight polyethylene powder tends to be lower as the polymerization temperature is higher, and tends to be higher as the polymerization temperature is lower.

In the method for producing the ultrahigh-molecular-weight polyethylene powder of the present embodiment, the polymerization pressure is usually atmospheric pressure or higher and 2 MPa or lower. The polymerization pressure is preferably 0.1 MPa or higher, more preferably 0.12 MPa or higher and preferably 1.5 MPa or lower, more preferably 1.0 MPa or lower. The polymerization pressure equal to or higher than atmospheric pressure tends to realize efficient industrial production. The polymerization pressure equal to or lower than 2 MPa tends to be able to suppress partial heat generation ascribable to rapid polymerization reaction during the introduction of a catalyst, and realize stable production of the polyethylene.

The polymerization reaction can be carried out by any of batch, semicontinuous, and continuous methods. A batch method is preferred from the viewpoint of controlling the proportion of the void in the ultrahigh-molecular-weight polyethylene powder of the present embodiment to the range mentioned above. On the other hand, a continuous method is preferred from the viewpoint of rendering the inside of the polymerization system more uniform. A partial high-temperature state ascribable to rapid ethylene reaction can be suppressed by continuously supplying ethylene gas, a solvent, a catalyst, etc., into the polymerization system while continuously discharging them together with produced polyethylene. Thus, the polymerization system is further stabilized. Ethylene reaction in a homogeneous state in the system prevents the formation of branches and/or double bonds or the like in polymer chains and is less likely to cause reduction in molecular weight and/or cross-linking of the polyethylene. The resulting ultrahigh-molecular-weight polyethylene powder decreases unmelted matter remaining when melted or dissolved, is prevented from being colored, and is less likely to present problems such as reduced mechanical properties.

Alternatively, the polymerization may be carried out at two or more stages differing in reaction conditions. The intrinsic viscosity of the resulting polyethylene can also be adjusted by the presence of hydrogen in the polymerization system or by the change of the polymerization temperature, as described in, for example, the specification of West German Patent Application Publication No. 3127133. The addition of hydrogen as a chain transfer agent into the polymerization system can control the intrinsic viscosity within a proper range.

The addition of the chain transfer agent tends to decrease the intrinsic viscosity IV of the ultrahigh-molecular-weight polyethylene to be produced even at the same polymerization temperature. In the case of adding hydrogen into the polymerization system, the mole fraction of the hydrogen is preferably 0 mol % or more and 30 mol % or less, more preferably 0 mol % or more and 25 mol % or less, further preferably 0 mol % or more and 20 mol % or less. In the present embodiment, in addition to each component as mentioned above, other components known in the art to be useful in production of the polyethylene can be included.

Besides, as described above, in the ultrahigh-molecular-weight polyethylene powder of the present embodiment, it is significant to disentangle molecular chains slowly little by little by impregnating the powder with liquid paraffin, and allowing it to stand still at a temperature at which the powder is not melted but molecular chains can move (50° C. or more and 100° C. or less) under vacuum (300 Pa or more and 400 Pa or less) for 1 hour or more and 6 hours or less to cause the liquid paraffin to sufficiently enter pores of the powder. Next, the resultant is dipped in hexane for 5 hours or more and 24 hours or less to extract the liquid paraffin from the powder, and the resultant powder is dried at 25° C. or more and 50° C. or less for 24 hours, and thus, a powder having a short dissolution time (of 5 seconds or more and 80 seconds or less) can be obtained (control method 1).

Alternatively, when main polymerization is performed with a polymer obtained through polymerization by using, as a preliminary polymerization catalyst, 55 to 70% by mass of liquid paraffin added to a polymerization solvent in preliminary polymerization, and the liquid paraffin is removed from the powder after completing the polymerization, a powder having a short dissolution time (of 5 seconds or more and 80 seconds or less) can be obtained (production method 2).

Further alternatively, when polymerization is performed under a high pressure condition (0.5 MPa or more and 1.0 MPa or less) using a preliminary polymerization catalyst (at a low temperature (5° C. or more and 20° C. or less), for a short period of time (0.5 hours or more and 2 hours or less) with ethylene charged (5 NL or more and 20 NL or less)), the polymerization can be performed in a highly active state of initial polymerization activity. Therefore, a large amount of polymerization heat energy is generated in the polymerization step, and an interconnected pore is formed to extend from a powder central part to the surface while the heat energy is escaped from the powder central part to the outside. Further more, when the amount of the heat energy is adjusted, the interconnected pore diameter can be controlled (control method 3).

In the polymerization of the ultrahigh-molecular-weight polyethylene powder of the present embodiment, an antistatic agent such as Stadis or STATSAFE manufactured by Innospec (agent: Maruwa Bussan K. K.) can be used for suppressing static electric adhesion of the polymer to a polymerization reactor. The antistatic agent such as Stadis or STATSAFE can be added with a pump or the like to the polymerization reactor in the form of a diluent in an inert hydrocarbon medium. At this point, the amount to be added is preferably 1 ppm or more and 500 ppm or less, and more preferably 10 ppm or more and 100 ppm or less with respect to a production amount of an ethylene polymer per unit time in a method in which it is precedently added to a solid catalyst, added to the polymerization reactor or the like.

### [Additive]

The ultrahigh-molecular-weight polyethylene powder of the present embodiment can be supplemented, if necessary, with an additive such as a slip agent, a neutralizer, an antioxidant, a light stabilizer, an antistatic agent, or a pigment.

Examples of the slip agent or the neutralizer include, but are not particularly limited to, aliphatic hydrocarbons, higher fatty acids, higher fatty acid metal salts, fatty acid esters of alcohols, waxes, higher fatty acid amides, silicone oil, and rosin. Specific examples thereof include, but are not particularly limited to, calcium stearate. The content of the slip agent or the neutralizer is not particularly limited and is preferably 5000 ppm or lower, more preferably 4000 ppm or lower, further preferably 3000 ppm or lower.

The antioxidant is not particularly limited and is preferably, for example, a phenol compound or a phenol-phosphorus compound, specifically include: phenol antioxidants such as 2,6-di-t-butyl-4-methylphenol(dibutylhydroxytoluene), n-octadecyl-3-(4-hydroxy-3,5-di-t-butylphenyl)propionate, and tetrakis(methylene(3,5-di-t-butyl-4-hydroxyhydrocinnamate))methane; phenol-phosphorus antioxidants such as 6-[3-(3-t-butyl-4-hydroxy-5-methylphenyl)propoxy]-2,4,8,10-tetra-t-butyldibenzo[d,f] [1,3,2]dioxaphosphepin; and phosphorus antioxidants such as tetrakis(2,4-di-t-butylphenyl)-4,4′-biphenylene-di-phosphonite, tris(2,4-di-t-butylphenyl)phosphite, and cyclic neopentane tetraylbis(2,4-t-butylphenyl phosphite).

In the ultrahigh-molecular-weight polyethylene powder according to the present embodiment, the amount of the antioxidant is preferably 5 parts by mass or lower, more preferably 4 parts by mass or lower, further preferably 3 parts by mass or lower, particularly preferably 2 parts by mass or lower, per 100 parts by mass in total of the ultrahigh-molecular-weight polyethylene powder and the liquid paraffin. The ultrahigh-molecular-weight polyethylene powder containing 5 parts by mass or lower of the antioxidant is less susceptible to embrittlement and/or discoloration, reduction in mechanical properties, etc., because of the suppressed degradation thereof, resulting in better long-term stability.

Examples of the light stabilizer include, but are not particularly limited to: benzotriazole light stabilizers such as 2-(5-methyl-2-hydroxyphenyl)benzotriazole and 2-(3-t-butyl-5-methyl-2-hydroxyphenyl)-5-chlorobenzotriazole; and hindered amine light stabilizers such as bis(2,2,6,6-tetramethyl-4-piperidine)sebacate and poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]. The content of the light stabilizer is not particularly limited and is 5000 ppm or lower, preferably 3000 ppm or lower, more preferably 2000 ppm or lower.

Examples of the antistatic agent include, but are not particularly limited to, aluminosilicate, kaolin, clay, natural silica, synthetic silica, silicates, talc, diatomaceous earth, and glycerin fatty acid ester.

As a solvent separation method employed in the polymerization step of the polyethylene powder of the present embodiment, any one of a decantation method, a centrifugation method, a filtration method, and the like may be employed, and the filtration method is preferred because of easiness of separation between the ethylene polymer and the solvent.

A method for inactivating the catalyst used in the polymerization step of the ethylene polymer to be contained in the polyethylene powder of the present embodiment is not especially limited, and inactivation of the catalyst is performed preferably after separating the ethylene polymer and the solvent.

When an agent for inactivating the catalyst is introduced after separating the polyethylene powder and the solvent, a low-molecular-weight component, a catalyst component and the like contained in the solvent can be suppressed from precipitating in the ethylene polymer.

The agent for inactivating the catalyst is not especially limited, and examples include oxygen, water, alcohols, glycols, phenols, carbon monoxide, carbon dioxide, ethers, carbonyl compounds, and alkynes.

In the method for producing the polyethylene powder of the present embodiment, a drying step is preferably performed after separating the ethylene polymer from the solvent. In the drying step, a rotary kiln dryer, a paddle dryer, a fluidized bed dryer or the like is preferably used. A drying temperature is preferably 30° C. or more and 150° C. or less.

Besides, it is effective to introduce an inert gas of nitrogen or the like into the drier for accelerating the drying. At this point, it is more effective to employ a method in which steam or the like is used together with the agent for inactivating the catalyst.

After drying the ethylene polymer to be contained in the polyethylene powder of the present embodiment, the resultant powder may be sifted for removing a coarse powder.

The polyethylene powder of the present embodiment may be a mixture of a plurality of polyethylene powders including the ethylene polymer obtained by the above-described production method.

### [Molded Article]

The ultrahigh-molecular-weight polyethylene powder of the present embodiment can be processed by various methods. The molded article of the present embodiment is obtained by molding the ultrahigh-molecular-weight polyethylene powder mentioned above. The molded article of the present embodiment can be employed in various uses. Specific examples of the molded article of the present embodiment include, but are not limited to, separators for secondary batteries (e.g., microporous membranes) and fibers (e.g., high-strength fibers). Among others, the molded article is suitable as a microporous membrane for a lithium ion secondary battery separator or a high-strength fiber.

A conventional method known in the art may be used as a method for producing the molded article of the present embodiment. Examples of such a method include, but are not particularly limited to, compression molding (press molding), extrusion molding, and drawing molding. The method for producing a separator for secondary battery or fiber as the molded article is as follows.

Examples of the method for producing the separator for secondary battery (e.g., microporous membrane) include, but are not particularly limited to, a processing method based on a wet process using a solvent, which involves extrusion in an extruder equipped with a T die, drawing, extraction, and drying. Specific examples thereof include, but are not particularly limited to, a production method under the following general swelling conditions and a production method under low-temperature swelling conditions.

### (Swelling Conditions)

The ultrahigh-molecular-weight polyethylene powder, liquid paraffin, and optionally an additive such as an antioxidant are blended and stirred at a temperature lower by 35° C. than the melting point (Tₙ₂) of the ultrahigh-molecular-weight polyethylene powder to prepare a liquid in a slurry form.

The obtained liquid in a slurry form is charged into a kneader, kneaded at a given temperature, then thermally pressed, and subsequently pressed by cooling to form a gel sheet. The thickness of the gel sheet is adjusted using a metal frame.

This sheet in a gel form is drawn using a simultaneous biaxial drawing machine. Then, the drawn film is cut out and fixed to a metal frame. Then, the resultant is dipped in hexane for the extraction and removal of liquid paraffin, and then dried. The film can be further heat-set to obtain a microporous membrane for a secondary battery separator.

Examples of the method for producing the fiber (e.g., high-strength fiber) include, but are not particularly limited to, a method of kneading and spinning liquid paraffin and the ultrahigh-molecular-weight polyethylene powder mentioned above, followed by heating and drawing. Specific examples thereof include, but are not particularly limited to, a production method under the following general swelling conditions and a production method under low-temperature swelling conditions.

### (Swelling Conditions)

The ultrahigh-molecular-weight polyethylene powder, liquid paraffin, and optionally an additive such as an antioxidant are blended and stirred at a temperature lower by 35° C. than the melting point (Tₘ₂) of the ultrahigh-molecular-weight polyethylene powder to prepare a liquid in a slurry form.

Next, the liquid in a slurry form is charged into a kneader, and kneading operation is performed at a given temperature.

Then, spinning is performed through a spinneret attached to Capillograph 1D.

In this respect, a discharged thread containing liquid paraffin is wound at a location distant from the spinneret.

Subsequently, in order to remove liquid paraffin from the wound thread, the thread is dipped in hexane for extraction operation and then dried.

The obtained thread can be primarily drawn in a thermostat bath and subsequently secondarily drawn in a thermostat bath immediately before being broken to obtain a high-strength fiber (drawn thread).

### [High-Strength Fiber]

A specific example of a method for producing a high-strength fiber includes a production method including a slurry preparing step, a gelling step, an arbitrary kneading step, an arbitrary extrusion preparation step, an extruding step, an arbitrary rapidly cooling step, an extracting step, and a fiber drawing step.

### (Slurry Preparing Step)

The slurry preparing step is a step of mixing the ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry.

The stirring temperature is preferably 25° C. or more and 120° C. or less, more preferably 50° C. or more and 115° C. or less, further preferably 80° C. or more and 110° C. or less, and particularly preferably 90° C. or more and 105° C. or less.

When the stirring temperature is 25° C. or more, the liquid paraffin can be efficiently impregnated into pores of the ultrahigh-molecular-weight polyethylene powder.

When the stirring temperature is 120° C. or less, the surface of the ultrahigh-molecular-weight polyethylene powder is suppressed from melting for preventing fusion among particles of the powder, and thus, a homogenous gel having disentangled molecular chains can be obtained.

### (Gelling Step)

The gelling step is a step of mixing the slurry and second liquid paraffin at 150° C. or more and 300° C. or less to obtain a gel for a fiber at 140° C. or more and 200° C. or less.

When the temperature of the gel for a fiber is 140° C. or more, a homogeneous gel having disentangled molecular chains can be obtained in a short period of time. When the temperature is 200° C. or less, great reduction of the molecular weight due to thermal decomposition can be suppressed.

The temperature of the second liquid paraffin is preferably 150° C. or more and 250° C. or less, more preferably 150° C. or more and 200° C. or less, and further preferably 150° C. or more and 180° C. or less.

The temperature of the gel for a fiber is preferably 140° C. or more and 190° C. or less, more preferably 140° C. or more and 180° C. or less, and further preferably 140° C. or more and 170° C. or less.

A polyethylene concentration in the gel for a fiber is preferably 3% by mass or more and 20% by mass or less, more preferably 3% by mass or more and 15% by mass or less, further preferably 3% by mass or more and 10% by mass or less, and particularly preferably 3% by mass or more and 8% by mass or less.

When the polyethylene concentration in the gel for a fiber is 3% by mass or more, a fiber having less unevenness of thread diameter can be stably spun. When the polyethylene concentration is 20% by mass or less, a fiber in which molecular chains are disentangled can be obtained.

### (Kneading Step)

The kneading step is a step of kneading the gel for a fiber.

A kneading temperature is preferably 140° C. or more and 200° C. or less, more preferably 140° C. or more and 180° C. or less, further preferably 140° C. or more and 170° C. or less, and particularly preferably 150° C. or more and 160° C. or less.

When the kneading temperature is 140° C. or more, a homogenous gel having disentangled molecular chains can be obtained. When the kneading temperature is 200° C. or less, great reduction of the molecular weight due to thermal decomposition can be suppressed.

A kneading time is preferably 5 minutes or more and 180 minutes or less, more preferably 10 minutes or more and 150 minutes or less, further preferably 15 minutes or more and 90 minutes or less, and particularly preferably 30 minutes or more and 60 minutes or less.

When the kneading time is 5 minutes or more, a homogenous gel having disentangled molecular chains can be obtained. When the kneading time is 180 minutes or less, great reduction of the molecular weight due to thermal decomposition can be suppressed.

A rotational speed in the kneading is preferably 3 rpm or more and 50 rpm or less, more preferably 3 rpm or more and 30 rpm or less, further preferably 3 rpm or more and 20 rpm or less, and particularly preferably 3 rpm or more and 10 rpm or less.

When the rotational speed in the kneading is 3 rpm or more, a homogenous gel having disentangled molecular chains can be obtained. When the rotational speed is 50 rpm or less, great reduction of the molecular weight due to thermal decomposition can be suppressed.

### (Extrusion Preparation Step)

The extrusion preparation step is a step of making preparation before extruding the gel for a fiber.

Specific examples of the extrusion preparation include temperature adjustment, and deaeration of the gel for a fiber.

A temperature in the extrusion preparation step is preferably 140° C. or more and 200° C. or less, more preferably 140° C. or more and 190° C. or less, further preferably 140° C. or more and 180° C. or less, and particularly preferably 150° C. or more and 180° C. or less.

When the temperature in the extrusion preparation step is 140° C. or more, the liquid paraffin is prevented from flowing out of the gel for a fiber to suppress variation of the gel concentration, and thus, a fiber can be stably obtained. When the temperature is 200° C. or less, great reduction of the molecular weight due to thermal decomposition can be suppressed.

A time of the extrusion preparation step (e.g., a time of deaeration) is preferably 5 minutes or more and 90 minutes or less, more preferably 5 minutes or more and 60 minutes or less, further preferably 15 minutes or more and 60 minutes or less, and particularly preferably 30 minutes or more and 60 minutes or less.

When the time of the extrusion preparation step is 5 minutes or more, the gel for a fiber can be sufficiently deaerated, and a fiber can be stably obtained. When the time is 90 minutes or less, great reduction of the molecular weight due to thermal decomposition can be suppressed.

### (Extruding Step)

The extruding step is a step of extruding the gel for a fiber to obtain a fiber.

An extrusion rate is preferably 5 mm/min or more and 20 mm/min or less, more preferably 5 mm/min or more and 15 mm/min or less, further preferably 7.5 mm/min or more and 12 mm/min or less, and particularly preferably 7.5 mm/min or more and 10 mm/min or less.

When the extrusion rate is 5 mm/min or more, the fiber can be collected without applying tension thereto, and the fiber can be drawn by many times in the fiber drawing step, and thus, a highly oriented (high-strength) fiber can be obtained. When the rate is 20 mm/min or less, the discharge amount can be stabilized, and thus, a fiber having less unevenness of thread diameter can be stably obtained.

A winding rate is preferably 200 mm/min or more and 1600 mm/min or less, more preferably 200 mm/min or more and 1400 mm/min or less, further preferably 250 mm/min or more and 1000 mm/min or less, and particularly preferably 500 mm/min or more and 800 mm/min or less.

When the winding rate is 200 mm/min or more, the fiber can be collected without applying tension thereto, and the fiber can be drawn by many times in the fiber drawing step, and thus, a highly oriented (high-strength) fiber can be obtained. When the winding rate is 1600 mm/min or less, the discharge amount can be stabilized, and thus, a fiber having less unevenness of thread diameter can be stably obtained.

The discharge amount is preferably 0.2 g/min or more and 1.5 g/min or less, more preferably 0.2 g/min or more and 1.2 g/min or less, further preferably 0.2 g/min or more and 1.0 g/min or less, and particularly preferably 0.3 g/min or more and 0.8 g/min or less.

When the discharge amount is 0.2 g/min or more, the fiber can be collected without applying tension thereto, and the fiber can be drawn by many times in the fiber drawing step, and thus, a highly oriented (high-strength) fiber can be obtained. When the discharge amount is 1.5 g/min or less, melt fracture is suppressed, and thus, a fiber having less unevenness of thread diameter can be stably obtained.

A spinning diameter is preferably 0.8 mm or more and 1.5 mm or less, more preferably 0.8 mm or more and 1.2 mm or less, further preferably 0.8 mm or more and 1.0 mm or less, and particularly preferably 0.9 mm or more and 1.0 mm or less.

When the spinning diameter is 0.8 mm or more, the diameter of the fiber after extraction of the liquid paraffin can be adjusted to a thickness at some level, and the fiber can be drawn by many times in the fiber drawing step, and thus, a highly oriented (high-strength) fiber can be obtained. When the diameter is 1.5 mm or less, a time for extracting the liquid paraffin from the fiber can be shortened, and hence the extraction operation can be efficiently completed.

### (Rapidly Cooling Step)

The rapidly cooling step is a step of rapidly cooling the fiber. The rapid cooling method is not especially limited, and an example includes a method in which the fiber is allowed to pass through a water bath.

A time from the extruding step to the rapidly cooling step (e.g., a time until an extruded fiber enters a water bath) is preferably 0 second or more and 10 seconds or less, more preferably 0 second or more and 5 seconds or less, and further preferably 0 second or more and 2 seconds or less.

When the time from the extruding step to the rapidly cooling step is 10 seconds or less, a fiber in a molten state can be rapidly solidified to minimize unevenness of the fiber diameter.

When the fiber is allowed to pass through a water bath in the rapidly cooling step, a distance from a spinning nozzle to the water surface of the water bath is preferably 0 cm or more and 10 cm or less, more preferably 1 cm or more and 8 cm or less, further preferably 1 cm or more and 5 cm or less, and particularly preferably 1 cm or more and 3 cm or less.

When the distance from the spinning nozzle to the water surface of the water bath is 10 cm or less, the fiber in a molten state can be rapidly solidified to minimize unevenness of the fiber diameter.

A temperature in the rapidly cooling step is preferably 5° C. or more and 30° C. or less, more preferably 5° C. or more and 25° C. or less, further preferably 5° C. or more and 20° C. or less, and particularly preferably 5° C. or more and 15° C. or less.

When the temperature in the rapidly cooling step is 5° C. or more, cost for cooling can be suppressed for efficient production. When the temperature is 30° C. or less, the fiber in a molten state can be rapidly solidified to minimize unevenness of the fiber diameter.

### (Extracting Step)

The extracting step is a step of extracting the first liquid paraffin and the second liquid paraffin from the fiber to obtain a fiber for drawing.

For extracting the liquid paraffin, an extraction solvent is preferably used. The extraction solvent is not especially limited, and examples include hexane and dichloromethane.

An extraction method is not especially limited, and an example includes a method in which the fiber is dipped in the extraction solvent.

An extraction time is preferably 3 hours or more and 24 hours or less, more preferably 3 hours or more and 20 hours or less, further preferably 5 hours or more and 20 hours or less, and particularly preferably 10 hours or more and 20 hours or less.

When the extraction time is 3 hours or more, the liquid paraffin can be extracted to an extent that the resultant does not have a problem as the fiber for drawing. When the amount of the liquid paraffin remaining in the fiber for drawing is large, mobility of the molecular chains is so high when heat is applied in the fiber drawing step that the resultant is easily highly oriented, but this state is difficult to retain (the state easily returns to a state prior to being highly oriented). Therefore, it is difficult to obtain a high-strength fiber. When the time is 24 hours or less, the fiber for drawing can be efficiently obtained without deteriorating the productivity.

### (Fiber Drawing Step)

The fiber drawing step is a step of thermally drawing the fiber for drawing.

The drawing is preferably multistage drawing, and more preferably two-stage drawing. The two-stage drawing preferably includes a primary drawing step, and a secondary drawing step.

((Primary Drawing Step)) A feeding rate is preferably 50 mm/min or more and 200 mm/min or less, more preferably 50 mm/min or more and 150 mm/min or less, further preferably 50 mm/min or more and 120 mm/min or less, and particularly preferably 50 mm/min or more and 100 mm/min or less.

A winding rate is preferably 1000 mm/min or more and 4000 mm/min or less, more preferably 1000 mm/min or more and 3500 mm/min or less, further preferably 1500 mm/min or more and 3500 mm/min or less, and particularly preferably 2000 mm/min or more and 3000 mm/min or less.

A draw ratio is controlled by adjusting the feeding rate and the winding rate, and is set also in consideration of productivity.

A drawing temperature is preferably 110° C. or more and 155° C. or less, more preferably 110° C. or more and 150° C. or less, further preferably 115° C. or more and 145° C. or less, and particularly preferably 120° C. or more and 140° C. or less.

When the drawing temperature is 110° C. or more, the drawing can be performed in the state in which the mobility of the molecular chains is high, and hence high orientation can be attained. When the temperature is 155° C. or less, the fiber for drawing can be drawn without being melted.

### ((Secondary Drawing Step))

A feeding rate is preferably 50 mm/min or more and 200 mm/min or less, more preferably 50 mm/min or more and 150 mm/min or less, further preferably 50 mm/min or more and 120 mm/min or less, and particularly preferably 50 mm/min or more and 100 mm/min or less.

A winding rate is preferably 100 mm/min or more and 500 mm/min or less, more preferably 100 mm/min or more and 450 mm/min or less, further preferably 150 mm/min or more and 400 mm/min or less, and particularly preferably 200 mm/min or more and 300 mm/min or less.

A draw ratio is controlled by adjusting the feeding rate and the winding rate, and is set also in consideration of productivity.

A drawing temperature is preferably 130° C. or more and 155° C. or less, more preferably 130° C. or more and 150° C. or less, further preferably 135° C. or more and 150° C. or less, and particularly preferably 140° C. or more and 150° C. or less.

When the drawing temperature is 130° C. or more, the drawing can be performed in the state in which the mobility of the molecular chains is high, and hence high orientation can be attained. When the temperature is 155° C. or less, a primarily drawn fiber can be drawn without being melted.

### [Microporous Membrane]

A specific example of a method for producing a microporous membrane includes a production method including a slurry preparing step, a gelling step, an arbitrary kneading step, a pressing step, a membrane drawing step, and an extracting step.

### (Slurry Preparing Step)

The slurry preparing step is a step of mixing the ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry.

The stirring temperature is preferably 25° C. or more and 120° C. or less, more preferably 50° C. or more and 115° C. or less, further preferably 80° C. or more and 110° C. or less, and particularly preferably 90° C. or more and 105° C. or less.

When the stirring temperature is 25° C. or more, the liquid paraffin can be efficiently impregnated into pores of the ultrahigh-molecular-weight polyethylene powder. When the stirring temperature is 120° C. or less, the surface of the ultrahigh-molecular-weight polyethylene powder is suppressed from melting for preventing fusion among particles of the powder, and thus, a homogenous gel having disentangled molecular chains can be obtained.

### (Gelling Step)

The gelling step is a step of mixing the slurry and second liquid paraffin at 150° C. or more and 300° C. or less to obtain a gel for pressing at 140° C. or more and 200° C. or less.

When the temperature of the gel for pressing is 140° C. or more, a homogeneous gel having disentangled molecular chains can be obtained in a short period of time. When the temperature is 200° C. or less, great reduction of the molecular weight due to thermal decomposition can be suppressed.

The temperature of the second liquid paraffin is preferably 160° C. or more and 210° C. or less, more preferably 170° C. or more and 200° C. or less, and further preferably 180° C. or more and 200° C. or less.

A polyethylene concentration in the gel for pressing is preferably 20% by mass or more and 55% by mass or less, more preferably 20% by mass or more and 50% by mass or less, further preferably 20% by mass or more and 40% by mass or less, and particularly preferably 20% by mass or more and 30% by mass or less.

When the polyethylene concentration in the gel for pressing is 20% by mass or more, a press sheet having little unevenness of thickness can be stably produced.

When the polyethylene concentration is 55% by mass or less, a press sheet in which molecular chains are disentangled can be obtained.

### (Kneading Step)

The kneading step is a step of kneading the gel for pressing.

A kneading temperature is preferably 140° C. or more and 250° C. or less, more preferably 150° C. or more and 240° C. or less, further preferably 160° C. or more and 230° C. or less, and particularly preferably 180° C. or more and 220° C. or less.

When the kneading temperature is 140° C. or more, a homogenous gel having disentangled molecular chains can be obtained. When the kneading temperature is 250° C. or less, great reduction of the molecular weight due to thermal decomposition can be suppressed.

A kneading time is preferably 5 minutes or more and 60 minutes or less, more preferably 5 minutes or more and 40 minutes or less, further preferably 5 minutes or more and 30 minutes or less, and particularly preferably 5 minutes or more and 20 minutes or less.

When the kneading time is 5 minutes or more, a homogenous gel having disentangled molecular chains can be obtained. When the kneading time is 60 minutes or less, great reduction of the molecular weight due to thermal decomposition can be suppressed.

A rotational speed in the kneading is preferably 30 rpm or more and 100 rpm or less, more preferably 30 rpm or more and 80 rpm or less, further preferably 30 rpm or more and 70 rpm or less, and particularly preferably 30 rpm or more and 60 rpm or less.

When the rotational speed in the kneading is 30 rpm or more, a homogenous gel having disentangled molecular chains can be obtained. When the rotational speed is 100 rpm or less, great reduction of the molecular weight due to thermal decomposition can be suppressed.

### (Pressing Step)

The pressing step is a step of thermally pressing the gel for pressing to obtain a gel sheet.

In the pressing step, a metal frame having a thickness of 1.0 mm is used for obtaining a thickness of the gel sheet of 1.0 mm.

In the pressing step, the pressing is preferably performed with the temperature and the pressure adjusted in multiple stages (preferably three stages). For example, it is preferable that heating is conducted in a first stage under conditions of a temperature of 180° C. or more and 220° C. or less, a pressure of 1 MPa, and a time of 3 minutes, that heating is conducted in a second stage under conditions of a temperature of 180° C. or more and 220° C. or less, a pressure of 10 MPa, and a time of 2 minutes, and that cooling is conducted in a third stage under conditions of a temperature of 20° C. or more and 35° C. or less, a pressure of 10 MPa, and a time of 5 minutes.

### (Membrane Drawing Step)

The membrane drawing step is a step of drawing the gel sheet to obtain a drawn membrane.

The drawing is preferably simultaneous biaxial drawing.

A drawing temperature is preferably 110° C. or more and 130° C. or less.

When the drawing temperature is 110° C. or more, the drawing can be performed in the state in which the mobility of the molecular chains is high, and hence high orientation can be attained. When the temperature is 130° C. or less, the gel sheet can be drawn without being melted.

A drawing ratio in the longitudinal direction is preferably 5 times or more and 20 times or less, more preferably 7 times or more and 18 times or less, and further preferably 10 times or more and 16 times or less.

A drawing ratio in the lateral direction is preferably 5 times or more and 20 times or less, more preferably 7 times or more and 18 times or less, and further preferably 10 times or more and 16 times or less.

The drawing ratio is set in consideration of the strength of the membrane, and productivity.

### (Extracting Step)

The extracting step is a step of extracting the first liquid paraffin and the second liquid paraffin from the drawn membrane.

For extracting the liquid paraffin, an extraction solvent is preferably used. The extraction solvent is not especially limited, and examples include hexane and dichloromethane.

An extraction method is not especially limited, and an example includes a method in which the drawn membrane is dipped in the extraction solvent.

An extraction time is preferably 3 hours or more and 24 hours or less, more preferably 3 hours or more and 20 hours or less, further preferably 5 hours or more and 20 hours or less, and particularly preferably 10 hours or more and 20 hours or less.

### EXAMPLES

Hereinafter, the present invention will be described more specifically with reference to Examples and Comparative Examples. However, the present invention is not intended to be limited by Examples below by any means.

Herein, ethylene and hexane used in Examples and Comparative Examples were dehydrated using MS-3A (manufactured by UNION SHOWA K.K.). The hexane was used after being further deoxidated by deaeration under reduced pressure using a vacuum pump.

Liquid paraffin used in Examples and Comparative Examples was liquid paraffin manufactured by MORESCO Corp. (product name: Smoil P-350P). Representative properties thereof were as follows: density at 15° C.: 0.866 g/cm³, pour point: −10° C., kinematic viscosity at 40° C.: 68.00 mm²/s(cSt), kinematic viscosity at 100° C.: 9.188 mm²/s(cSt), ring analysis Cn: 30%, Cp: 70%, average molecular weight: 489 g/mol.

### [Methods and Conditions for Measuring]

The physical properties of ultrahigh-molecular-weight polyethylene powders of Examples and Comparative Examples were measured by the following methods.

### (Measurement 1) Intrinsic Viscosity IV

The intrinsic viscosity IV of each ultrahigh-molecular-weight polyethylene powder obtained in Examples and Comparative Examples was measured as follows in accordance with IS01628-3 (2010).

The polyethylene powder was weighed in the range of 4.0 to 4.5 mg and dissolved by stirring at 150° C. for 90 minutes in a dissolution tube, the air inside which was evacuated with a vacuum pump and purged with nitrogen, using 20 mL of decahydronaphthalene (supplemented with 1 g/L 2,6-di-t-butyl-4-methylphenol; hereinafter, referred to as decalin) deaerated with a vacuum pump and purged with nitrogen as a solvent to obtain a solution. The viscosity tube used was a Cannon-Fenske viscometer (manufactured by Sibata Scientific Technology Ltd.: product No. −100). This operation was performed continuously 5 times, and an average of three values excluding the maximum and minimum values was calculated to calculate final intrinsic viscosity.

### (Measurement 2) Dissolution Time

The dissolution time of an ultrahigh-molecular-weight polyethylene powder obtained in each of Examples and Comparative Examples was calculated by successively performing the following procedures 1 and 2:

### [Procedure 1: Calculation of D50]

A particle size of a target ultrahigh-molecular-weight polyethylene powder was measured with a laser particle size distribution meter (SALD-2100, manufactured by Shimadzu Corporation) using methanol as a dispersion medium, and based on the measurement, a cumulative particle size distribution from the small particle size side was created, and a particle size corresponding to 50% cumulative particle size was determined as D50. This operation was performed continuously 5 times, and an average of three values excluding the maximum and minimum values was calculated to calculate final D₅₀.

### [Procedure 2: Calculation of Dissolution Time]

The dissolution time of a powder having the particle size D50 was obtained. First, under observation, with an optical microscope, of an ultrahigh-molecular-weight polyethylene powder having a long diameter and a short diameter within the range of D50±10%, one particle was freely collected. Here, the short diameter of the particle was determined, in a plane figure of the particle observed with an optical microscope, as a shortest distance between parallel lines, and the long diameter of the particle was determined as a longest distance between parallel lines crossing, at right angle, the parallel lines of the short diameter. The thus collected one particle of the ultrahigh-molecular-weight polyethylene powder (hereinafter, also referred to as the “measurement particle”) was set on a microscope glass, 0.05 mL of liquid paraffin was dropped onto the measurement particle with a 1 mL syringe, and then a cover glass was placed thereon to sandwich the measurement particle. Thereafter, the microscope glass was set on a heat stage, and the temperature was increased from room temperature to 150° C. under temperature increase conditions described below. The appearance of the measurement particle during the temperature increase was captured with an optical microscope equipped with a camera every 5 seconds. Based on the thus obtained observation images, an equivalent circle diameter of the measurement particle was calculated, and a time from a state in which the equivalent circle diameter was the largest until elimination of the powder was determined as the dissolution time. This operation was continuously performed 10 times, and an average of eight values excluding the maximum and minimum values was calculated to calculate a final dissolution time.

### (Temperature Increase Conditions)

temperature increase rate from room temperature to 35° C.: 5° C./min
temperature increase rate from 35° C. to 80° C.: 8° C./min
temperature increase rate from 80° C. to 150° C.: 5° C./min

### (Measurement 3) Proportion of Interconnected Pores in Powder Having Particle Size D50

The proportion of interconnected pores in the ultrahigh-molecular-weight polyethylene powder obtained in each of Examples and Comparative Examples was calculated through the following procedure 3:

### [Procedure 3: Proportion of Interconnected Pores]

Five particles of an ultrahigh-molecular-weight polyethylene powder having a long diameter and a short diameter falling in the range of D50±10% (wherein the short diameter of the particle was determined, in a plane figure of the particle observed with an optical microscope, as a shortest distance between parallel lines, and the long diameter of the particle was determined as a longest distance between parallel lines crossing, at right angle, the parallel lines of the short diameter) were collected, a double-sided tape was attached to a sampling stage, and the 5 particles were placed thereon.

The powders were irradiated with X-rays with nano3DX (manufactured by Rigaku Corporation) to obtain three-dimensional image data, and the data was subjected to image processing with image analysis software to calculate a proportion of interconnected pores. X-ray conditions and imaging conditions were as follows:

### [X-Ray Conditions]

X-ray target: Cu
X-ray tube voltage/tube current: 40 kV/30 mA
[Imaging conditions]
180-degree rotation
Number of images: 1000
Exposure time: 10 sec/image
Spatial resolution: 0.54 m/pix

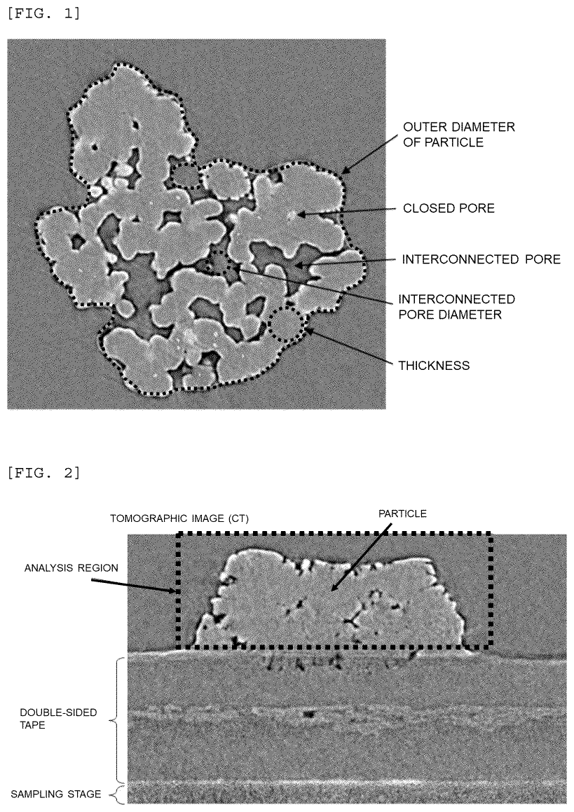

Thereafter, the thus obtained image was subjected to image analysis with analysis software. The obtained image, and a tomographic image thereof are illustrated in FIGS. 1 and 2.

### [Analysis Range]

In a direction vertical to the horizontal surface of the sampling stage, an area where the powder was not in contact with a sticky portion of the double-sided tape was determined as an analysis range.

### [Procedures for Detecting Resin Region]

### Noise Removal 1

1. An X-ray CT image was subjected to Median3D of ImageJ.

Parameters were set as follows: x=2, γ=2, and Z=2.

2. The result obtained in 1. was subjected to Morphological Filters (3D) of MorphoLibJ.

Parameters were set as follows: operation=Closing, element=Ball, x-radius=2, y-radius=2, and z-radius=2.

3. The result obtained in 2. was subjected to Gaussian Blur3D of ImageJ.

Parameters were set as follows: x=2, y=2, and Z=2.

### Binarization

4. In the result obtained in 3., voxels having a brightness value beyond a threshold value were determined as white, and voxels having a brightness value lower than the threshold value were determined as black. The threshold value was estimated by using implementation of the moment method of ImageJ.

### Noise Removal 2

5. In the result obtained in 4., white voxels were segmented into masses of continuous voxels, and a mass consisting of less than 1000 voxels was changed to black. For the segmentation processing, 3D Simple Segmentation of 3D Suite ImageJ was used.

The black and white voxel data obtained through the processing of 5. was determined as P. A white region in the data P was determined as a resin region (A).

### [Procedures for Detecting Closed Pore Region]

6. The data P was subjected to 3D Fill Holes of 3D Suite ImageJ.

7. Voxels in the result of 6. disposed in the same position as white voxels in the data P were changed to black.

The black and white voxel data obtained through the processing of 7. was determined as Q. A white region in the data Q was determined as a closed pore region (B).

### [Procedures for Detecting Particle Outline]

8. 3D DistanceMap of 3D Suite ImageJ was used to obtain a distance between each voxel and the closest white voxel in the data P.

Parameters were set as follows: map=EDT, mask=None, threshold=1, inverse.

9. Voxels having a value of 20 or less as a result of the processing of 8. were newly determined as white, and the other voxels were determined as black voxels.

10. 2D Fill Holes of ImageJ was applied to a lowermost tomographic image in the analysis range.

11. 3D Fill Holes of 3D Suite ImageJ was applied to the entire data.

12. 3D DistanceMap of 3D Suite ImageJ was used to obtain a distance of each voxel in the result of 11. to the closest black voxel. Parameters were set as follows: map=EDT, mask=None, threshold=1, invers.

13. Voxels having a value of 20 or less as a result of 12. were newly determined as black, and the other voxels were determined as white voxels.

The black and white voxel data obtained as a result of 13. was determined as R. A white region in the data R was determined as a particle outline (C).

[Procedures for Detecting Interconnected Pore Region]

14. Voxels in the data R disposed in the same position as white voxels in the data Q were changed to black.

15. Voxels in the result of 14. disposed in the same position as white voxels in the data P were changed to black.

Black and white voxel data in the result of 15. was determined as S. A white region in the data S was determined as an interconnected pore region (D).

[interconnected pore region (D)]=[particle outline (C)]−[closed pore region (B)]−[resin region (A)]

### [Proportion of Interconnected Pores]

proportion of interconnected pores=total number of white voxels in S/total number of white voxels in R

This series of operations were conducted on 5 particles, and an average of the resultant values was determined as a final proportion of interconnected pores.

(Measurement 4) Surface Thickness of Powder having Particle Size D50

The surface thickness of the ultrahigh-molecular-weight polyethylene powder obtained in each of Examples and Comparative Examples was calculated through the following procedure 4:

### [Procedure 4: Surface Thickness of Powder]

16. BoneJ was used to calculate Thickness of the data P.

17. A median of Thicknesses of voxels having Thickness larger than 0 was determined as the thickness.

This series of operations were conducted on 5 particles, and an average of the resultant values was determined as a final surface thickness of the powder.

(Measurement 5) Interconnected Pore Diameter of Powder having Particle Size D50

The interconnected pore diameter of the ultrahigh-molecular-weight polyethylene powder obtained in each of Examples and Comparative Examples was calculated through the following procedure 5:

### [Procedure 5: Interconnected Pore Diameter]

18. BoneJ was used to calculate Thickness of the data S.

19. A median of Thicknesses of voxels having Thickness larger than 0 was determined as the interconnected pore diameter.

This series of operations were conducted on 5 particles, and an average of the resultant values was determined as a final interconnected pore diameter.

### (Measurement 6) Ti and Al Contents in Ultrahigh-Molecular-Weight Polyethylene Powder

Each ultrahigh-molecular-weight polyethylene powder obtained in Examples and Comparative Examples was pressure-decomposed using a microwave decomposition apparatus (model ETHOS TC, manufactured by Milestone General K.K.). The element concentrations of the metal titanium (Ti) and aluminum (Al) contained in the ultrahigh-molecular-weight polyethylene powder were measured by the internal standard method using ICP-MS (inductively coupled plasma-mass spectrometer, model X Series X7, manufactured by Thermo Fisher Scientific K.K.).

### (Measurement 7) Average Particle Size (D50) of Ultrahigh-Molecular-Weight Polyethylene Powder

A particle size of the ultrahigh-molecular-weight polyethylene powder obtained in each of Examples and Comparative Examples was measured with a laser particle size distribution meter (SALD-2100, manufactured by Shimadzu Corporation). The measurement was performed with methanol used as a dispersion medium, and based on the measurement, a cumulative particle size distribution from the small particle size side was created, and a particle size corresponding to 50% cumulative particle size was determined as D50. This operation was performed continuously 5 times, and an average of three values excluding the maximum and minimum values was calculated to calculate final D50.

### (Molded Article Production Process 1-1) Method for Producing Separator for Secondary Battery (Microporous Membrane) Using High Polymer Concentration

A separator for secondary battery was produced as follows using each ultrahigh-molecular-weight polyethylene powder obtained in Examples and Comparative Examples.

45 parts by mass of the ultrahigh-molecular-weight polyethylene powder, 55 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were added per 100 parts by mass in total of the ultrahigh-molecular-weight polyethylene powder and the liquid paraffin, and stirred at a temperature lower by 35° C. than the melting point (Tₘ₂) of the ultrahigh-molecular-weight polyethylene powder for 30 minutes to prepare a liquid in a slurry form.

The obtained liquid in a slurry form was charged into Labo Plastomill (unit model: 4C150-01) manufactured by Toyo Seiki Seisaku-sho, Ltd., kneaded at a screw rotational speed of 50 rpm at a constant temperature of 200° C. for 10 minutes, then thermally pressed under conditions of 180° C./1 MPa/3 minutes, further thermally pressed under conditions of 180° C./10 MPa/2 minutes, and then pressed by cooling under conditions of 25° C./10 MPa/5 minutes to form a gel sheet. The thickness of the gel sheet was adjusted to 1.0 mm using a metal frame having a thickness of 1.0 mm.

This sheet in a gel form was drawn at 115° C. at a ratio of 7×7 using a simultaneous biaxial drawing machine. Then, this drawn film was cut into 30 cm square and fixed to a metal frame having an inside dimension of 25 cm. Then, the resultant was dipped in hexane for the extraction and removal of liquid paraffin, and then dried for 24 hours or longer. The film was further heat-set at 134° C. for 1 minute to obtain a secondary battery separator.

(Molded article production process 1-2) Method for producing separator for secondary battery (microporous membrane) using high polymer concentration

A separator for secondary battery was produced as follows using each ultrahigh-molecular-weight polyethylene powder obtained in Examples and Comparative Examples.

Assuming that the total amount of the ultrahigh-molecular-weight polyethylene powder and liquid paraffin was 100 parts by mass, 55 parts by mass of the ultrahigh-molecular-weight polyethylene powder, 45 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were blended, and the resultant mixture was stirred for 60 minutes at a temperature lower by 35° C. than the melting point (Tₘ₂) of the ultrahigh-molecular-weight polyethylene powder to prepare a liquid in a slurry form.

Next, the liquid in a slurry form was added to liquid paraffin (liquid paraffin (product name: Smoil P-350P) manufactured by MORESCO Corp.) at 180° C., and the resultant was stirred for 2 minutes to prepare a gel having a polymer concentration of 45 parts by mass.

The thus obtained liquid in a slurry form was charged into Labo Plastomill (unit model: 4C150-01) manufactured by Toyo Seiki Seisaku-sho, Ltd., kneaded at a screw rotational speed of 50 rpm at a constant temperature of 200° C. for 10 minutes, then thermally pressed under conditions of 180° C./1 MPa/3 minutes, further thermally pressed under conditions of 180° C./10 MPa/2 minutes, and then pressed by cooling under conditions of 25° C./10 MPa/5 minutes to form a gel sheet. The thickness of the gel sheet was adjusted to 1.0 mm using a metal frame having a thickness of 1.0 mm.

The resultant gel sheet was drawn at 115° C. at a ratio of 7×7 or more and 20×20 or less using a simultaneous biaxial drawing machine. Then, the thus drawn film was cut into a 30 cm square and fixed to a metal frame having an inside dimension of a 25 cm square.

Then, the resultant was dipped in hexane for the extraction and removal of the liquid paraffin, and then dried for 24 hours or more. The resultant was further heat-set at 134° C. for 1 minute to obtain a separator for a secondary battery.

### (Molded Article Production Process 2-1) Method for Producing Separator for Secondary Battery Using General Polymer Concentration

A separator for secondary battery was obtained in the same manner as in the above (Molded article production process 1-1) except that 25 parts by mass of the ultrahigh-molecular-weight polyethylene powder, 75 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were added per 100 parts by mass in total of the ultrahigh-molecular-weight polyethylene powder and the liquid paraffin.

### (Molded Article Production Process 2-2) Method for Producing Separator for Secondary Battery Using General Polymer Concentration

A separator for a secondary battery was obtained in the same manner as described above in (Molded article production process 1-2) except for the following: Assuming that the total amount of the ultrahigh-molecular-weight polyethylene powder and liquid paraffin is 100 parts by mass, 35 parts by mass of the ultrahigh-molecular-weight polyethylene powder, 65 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were blended, and next, the resultant liquid in a slurry form was added to liquid paraffin (liquid paraffin (product name: Smoil P-350P) manufactured by MORESCO Corp.) at 180° C., and the resultant was stirred for 2 minutes to prepare a gel having a polymer concentration of 25 parts by mass.

### (Evaluation Method 1) Number of Defects in Separator for Secondary Battery

A separator for a secondary battery was produced by a method described above in (Molded article production process 1-1), (Molded article production process 1-2), (Molded article production process 2-1), or (Molded article production process 2-2), and the number of defects of 50 μm or more present in an area of 1 m² of the microporous membrane (corresponding to 16 microporous membranes of a 25 cm square) was counted visually, or with a magnifying glass if necessary. The term “defect” used herein refers to a portion having deeper color (poor dispersion) than a normal portion in observing the microporous membrane with transmitted light, and fiber and a colored foreign matter were not counted as a defect. Based on the thus obtained number of defects, the number of defects, that is, one of the indexes for the quality of the microporous membrane, was evaluated according to the criteria given below. The evaluation results are shown in Table 1.

### (Evaluation Criteria)

⊚ (very good): less than 15 defects/m²
O (good): 15 defects/m² or more and less than 45 defects/m²
Δ (fair): 45 defects/m² or more and less than 90 defects/m²
X (poor) 90 defects/m² or more

### (Evaluation Method 2) Thickness Variation of Separator for Secondary Battery

A microporous membrane serving as a separator for a secondary battery was produced by the method described above in (Molded article production process 1-1), (Molded article production process 1-2), (Molded article production process 2-1), or (Molded article production process 2-2), and the thickness of the obtained microporous membrane was measured using a film thickness gauge based on JIS K 7130. For measurement locations, one microporous membrane of 25 cm square was cut into 25 microporous membranes of 5 cm square. Their respective central parts were measured, and an average film thickness was calculated. Thickness variations (hereinafter, also referred to as an uneven film thickness), one of the indexes for the quality of the microporous membrane, was evaluated according to the criteria given below on the basis of the average film thickness. The evaluation results are shown in Table 1.

### (Evaluation Criteria)

⊚(very good): variations of less than ±1.5 m from the average film thickness.
O (good): variations of ±1.5 μm or more and less than 2.0 m from the average film thickness.
Δ (fair): variations of ±2.0 μm or more and less than 4.0 m from the average film thickness.
X (poor): variations of ±4.0 μm or more from the average film thickness.

### (Evaluation Method 3) Basis Weight-Based Puncture Strength (Gf/(g/m²)) of Separator for Secondary Battery

Each microporous membrane serving as a separator for a secondary battery described above in (Molded article production process 1-1), (Molded article production process 1-2), (Molded article production process 2-1), or (Molded article production process 2-2) was fixed to a sample holder having an opening of 10 mm in diameter using Handy Compression Tester “KES-G5” manufactured by Kato Tech Co., Ltd. Next, a central part of the fixed microporous membrane was subjected to a puncture test under conditions involving a radius of curvature of 0.5 mm at the tip of a needle and a puncture rate of 10 mm/min to obtain a puncture strength (gf) as a maximum puncture load. The obtained puncture strength (gf) was divided by a basis weight to calculate basis weight-based puncture strength (gf/(g/m²)). This operation was carried out 8 times using eight microporous membranes, and an average value from the eight measurements was regarded as basis weight-based puncture strength (gf/(g/m²)) and evaluated according to the evaluation criteria given below. The evaluation results are shown in Table 1.

### (Evaluation Criteria)

★ (excellent): the basis weight-based puncture strength was 95 gf/(g/m²) or more
⊚ (very good): the basis weight-based puncture strength was 80 gf/(g/m²) or more and less than 95 gf/(g/m²)
O (good): the basis weight-based puncture strength was 70 gf/(g/m²) or more and less than 80 gf/(g/m²).
Δ (fair): the basis weight-based puncture strength was 60 gf/(g/m²) or more and less than 70 gf/(g/m²).
X (poor): the basis weight-based puncture strength was less than 60 gf/(g/m²).

### (Evaluation Method 4) Thermal Shrinkage Rate of Separator for Secondary Battery

In producing a microporous membrane to be used as a separator for a secondary battery as described above in (Molded article production process 1-1), (Molded article production process 1-2), (Molded article production process 2-1), or (Molded article production process 2-2), the production was performed under four heat setting conditions of 130° C./min, 132°/min, 134° C./min, and 136° C./min, and the porosity of the thus obtained heat set membranes was calculated. For obtaining the porosity, a sample of a 10 cm×10 cm square was cut out of each microporous membrane, the volume (cm³) and the mass (g) of the sample were obtained, and the porosity was calculated based on these values and the density (g/cm³) of the polyethylene in accordance with the following expression:

$$porosity ( \% ) = ( volume - mass / density ) / volume \times 100$$

Besides, each of the heat set membranes was sandwiched with sheets of paper, the resultant bundle of paper was put in an envelope, and the resultant envelope was heated at 120° C. for 1 hour. Thereafter, the resultant was cooled at room temperature for 15 minutes. The length of each side of the membrane was measured with a metal measure to obtain an average, and a shrinkage rate from the original length (10 cm) was calculated to calculate a thermal shrinkage rate. At this point, a graph of the relationship between the porosity and the thermal shrinkage rate was created, a thermal shrinkage rate at a porosity of 50% was roughly estimated based on the graph, and the membrane physical property was evaluated based on the thus obtained thermal shrinkage rate according to the criteria given below. The evaluation results are shown in Table 1.

### (Evaluation Criteria)

★ (excellent): less than 10%
⊚ (very good): 10% or more and less than 20%
O (good): 20% or more and less than 25%
Δ (fair): 25% or more and less than 30%
X (poor): 30% or more

### (Molded Article Production Process 3-1) Method for

Producing High-Strength Fiber in General Kneading Time A high-strength fiber was produced as follows using each ultrahigh-molecular-weight polyethylene powder. 15 parts by mass of the ultrahigh-molecular-weight polyethylene powder, 85 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were added per 100 parts by mass in total of the ultrahigh-molecular-weight polyethylene powder and the liquid paraffin, and stirred at a temperature lower by 35° C. than the melting point (Tₘ₂) of the ultrahigh-molecular-weight polyethylene powder for 60 minutes to prepare a liquid in a slurry form.

Next, the liquid in a slurry form was added to liquid paraffin (liquid paraffin (product name: Smoil P-350P) manufactured by MORESCO Corp.) at 160° C., and the resultant was stirred for 2 minutes to prepare a gel having a polymer concentration of 5 parts by mass. The thus obtained gel was charged into Labo Plastomill (unit model: 4C150-01) manufactured by Toyo Seiki Seisaku-sho, Ltd., and kneaded at a screw rotational speed of 10 rpm at a constant temperature of 150° C. for 180 minutes to prepare a kneaded gel.

Subsequently, spinning operation was conducted using Capillograph 1D (unit model: PMD-C) manufactured by Toyo Seiki Seisaku-sho, Ltd. The orifice used had an pore diameter of 1.0 mm, a length of 66 mm, and an inflow angle of 90°, and after charging the kneaded gel into a furnace set to 180° C., deaeration operation was conducted for 60 minutes. Thereafter, the extrusion rate was set to 7.5 mm/min for obtaining a discharge amount of 0.35 g/min, and the resultant fiber was collected, after passing through a water bath disposed directly below the orifice tip, at a winding rate of 2.8 m/min. The distance between the orifice tip to the water surface of the water bath was 8 cm, and the temperature of the water bath was set to 20° C.

Thereafter, in order to remove the liquid paraffin from the wound fiber, extraction operation was performed by dipping the fiber in hexane, and the resultant was dried for 24 hours.

The thus obtained fiber was primarily drawn at a rate of 20 mm/min in a thermostat bath set to 120° C., and subsequently secondarily drawn at a rate of 10 mm/min in a thermostat bath set to 140° C. up to immediately before being broken to obtain a high-strength fiber (drawn thread). The temperature in the thermostat bath was a value obtained by actually measuring the temperature of the center part of the thermostat bath with a thermometer.

### (Molded Article Production Process 3-2) Method for Producing High-Strength Fiber in General Kneading Time

A high-strength fiber was produced using an ultrahigh-molecular-weight polyethylene powder as follows: Assuming that the total amount of the ultrahigh-molecular-weight polyethylene powder and liquid paraffin was 100 parts by mass, 15 parts by mass of the ultrahigh-molecular-weight polyethylene powder, 85 parts by mass of liquid paraffin (liquid paraffin (product name: Smoil P-350P) manufactured by MORESCO Corp.), and 1 part by mass of an antioxidant (tetrakis[methylene(3,5-di-t-butyl-4-hydroxy-hydrocinnamate)]methane (product name: ANOX20) manufactured by Great Lakes Chemical Japan) were blended, and the resultant mixture was stirred for 60 minutes at a temperature lower by 35° C. than the melting point (Tₘ₂) of the ultrahigh-molecular-weight polyethylene powder to prepare a liquid in a slurry form.

Next, the liquid in a slurry form was added to liquid paraffin (liquid paraffin (product name: Smoil P-350P) manufactured by MORESCO Corp.) at 180° C., and the resultant was stirred for 2 minutes to prepare a gel having a polymer concentration of 5 parts by mass. The thus obtained gel was charged into Labo Plastomill (unit model: 4C150-01) manufactured by Toyo Seiki Seisaku-sho, Ltd., and kneaded at a screw rotational speed of 10 rpm at a constant temperature of 150° C. for 180 minutes to prepare a kneaded gel.

Subsequently, spinning operation was conducted using Capillograph 1D (unit model: PMD-C) manufactured by Toyo Seiki Seisaku-sho, Ltd. The orifice used had an pore diameter of 1.0 mm, a length of 66 mm, and an inflow angle of 90°, and after charging the kneaded gel into a furnace set to 180° C., deaeration operation was conducted for 60 minutes. Thereafter, the extrusion rate was set to 10 mm/min for obtaining a discharge amount of 0.45 g/min, and the resultant fiber was collected, after passing through a water bath disposed directly below the orifice tip, at a winding rate of 0.8 m/min. The distance between the orifice tip to the water surface of the water bath was 8 cm, and the temperature of the water bath was set to 20° C.

Thereafter, in order to remove the liquid paraffin from the wound fiber, extraction operation was performed by dipping the fiber in hexane, and the resultant was dried for 24 hours.

The thus obtained fiber was primarily drawn at a feeding rate of 100 mm/min and a winding rate of 3000 mm/min in a thermostat bath set to 120° C., and subsequently secondarily drawn at a feeding rate of 100 mm/min and at a rate up to immediately before being broken in a thermostat bath set to 140° C. to obtain a high-strength fiber (drawn thread). The drawing step was performed using a heating stretching machine (unit model: IMC-3F08) manufactured by Imoto Machinery Co., Ltd. The temperature in the thermostat bath was a value obtained by actually measuring the temperature of the center part of the thermostat bath with a thermometer.

### (Molded Article Production Process 4-1) Method for Producing High-Strength Fiber Using Short Kneading Time

A high-strength fiber was obtained in the same manner as described above in (Molded article production process 3-1) except that the kneading time with Labo Plastomill (unit model: 4C150-01) manufactured by Toyo Seiki Seisaku-sho, Ltd. was changed to 60 minutes.

### (Molded Article Production Process 4-2) Method for Producing High-Strength Fiber Using Short Kneading Time

A high-strength fiber was obtained in the same manner as described above in (Molded article production process 3-2) except that the kneading time with Labo Plastomill (unit model: 4C150-01) manufactured by Toyo Seiki Seisaku-sho, Ltd. was changed to 0 minutes (namely, the kneading with Labo Plastomill was not performed).

### (Evaluation Method 5) Number of Fiber Balls of High-Strength Fiber

It was confirmed how many fiber balls were generated in a length of 10 m of a high-strength fiber (drawn thread) spun by the method described above in (Molded article production process 3-1), (Molded article production process 3-2), (Molded article production process 4-1), or (Molded article production process 4-2), and the number of fiber balls was calculated. The term “fiber ball” used herein refers to a portion of the fiber locally having larger thickness (poor dispersion) than a normal portion. The quality of the high-strength fiber was evaluated based on the calculated number of fiber balls as follows. The evaluation results are shown in Table 1.

### (Evaluation Criteria)

⊚ (very good): less than 3 fiber balls per meter
O (good): 3 or more and less than 6 fiber balls per meter
Δ (fair): 6 or more and less than 10 fiber balls per meter
X (poor): 10 or more fiber balls per meter

### (Evaluation Method 6) Uneven Thread Diameter of High-Strength Fiber

A thread diameter was measured at 0.5-m intervals under an optical microscope as to 10 m of each high-strength fiber (drawn thread) obtained by spinning by the methods described above in (Molded article production process 3-1), (Molded article production process 3-2), (Molded article production process 4-1), or (Molded article production process 4-2) and an average thread diameter was calculated. An uneven thread diameter, one of the indexes for the quality of the high-strength fiber, was evaluated according to the evaluation criteria given below on the basis of the average thread diameter. The evaluation results are shown in Table 1.

### (Evaluation Criteria)

⊚ (very good): variations of less than ±3 m from the average thread diameter.
O (good): variations of ±3 μm or more and less than m from the average thread diameter.
Δ (fair): variations of ±5 μm or more and less than m from the average thread diameter.
X (poor): variations of ±10 μm or more from the average film thickness

### (Evaluation Method 7) Tensile Breaking Strength of High-Strength Fiber

A high-strength fiber (drawn thread), having a length of 10 m, spun by the method described above in (Molded article production process 3-1), (Molded article production process 3-2), (Molded article production process 4-1), or (Molded article production process 4-2) was cut at an interval of 1 m, and each of the thus obtained 10 pieces of fiber was pulled at room temperature until it was broken to calculate average breaking strength. At this point, the breaking strength was calculated by dividing a value of the maximum load applied to the fiber by the fineness. Here, the fineness refers to the weight (g) per 1×10⁴ m of the fiber, and was obtained based on the weight of the high-strength fiber having a length of 10 m. As the unit of the fineness, dtex was used. In the measurement of the weight, a scale capable of weighing up to 0.1 mg was used. The evaluation results are shown in Table 1. The tensile breaking strength of the high-strength fiber was evaluated according to the following criteria:

### (Evaluation Criteria)

★ (excellent): the breaking strength of 43 cN/dtex or more
⊚ (very good): the breaking strength of 30 cN/dtex or more and less than 43 cN/dtex
O (good): the breaking strength of 25 cN/dtex or more and less than 30 cN/dtex
Δ (fair): the breaking strength of 20 cN/dtex or more and less than 25 cN/dtex
X (poor): the breaking strength of less than 20 cN/dtex

### (Evaluation Method 8) High-Speed Windability Evaluation of High-Strength Fiber

Each gel kneaded by the methods described above in (Molded article production process 3-1), (Molded article production process 3-2), (Molded article production process 4-1), or (Molded article production process 4-2) was subjected to spinning operation using Capillograph 1D (unit model: PMD-C) manufactured by Toyo Seiki Seisaku-sho, Ltd. The orifice used had a pore diameter of 0.5 mm, a length of 5 mm, and an inflow angle of 90°. The spinning conditions involved a temperature of 200° C., an extrusion rate fixed to 20 mm/min, and a winding rate gradually elevated from 3 m/min at an increase rate of 19.7 m/min². In this respect, a rate at which the thread was broken was measured as a high-speed winding rate, and evaluated according to the evaluation criteria given below on the basis of an average value from five measurements. The evaluation results are shown in Table 1.

### (Evaluation Criteria)

★ (excellent): the high-speed winding rate was 900 m/min or more.
⊚ (very good): the high-speed winding rate was 700 m/min or more and less than 900 m/min.
O (good): the high-speed winding rate was 400 m/min or more and less than 700 m/min.
Δ (fair): the high-speed winding rate was 200 m/min or more and less than 400 m/min
X (poor): the high-speed winding rate was less than 200 m/min

### (Measurement 8) Melting Point (Tₘ₂) of Ultrahigh-Molecular-Weight Polyethylene Powder

The melting point (Tₘ₂) of each ultrahigh-molecular-weight polyethylene powder obtained in Examples and Comparative Examples was measured as follows using DSC8000 manufactured by Perkin Elmer, Inc. as a differential scanning calorimeter (DSC).

8.3 to 8.5 mg of the ultrahigh-molecular-weight polyethylene powder was weighed and placed in an aluminum sample pan. An aluminum cover was attached to this pan, which was then loaded in the differential scanning calorimeter. While the apparatus was purged with nitrogen at a flow rate of 20 mL/min, measurement was carried out under the conditions given below. A pure substance of indium was used in temperature correction.
1) Retaining the powder at 50° C. for 1 minute, followed by heating to 180° C. at a heating rate of 10° C./min.
2) Retaining the powder at 180° C. for 5 minutes, followed by cooling to 50° C. at a cooling rate of 10° C./min.
3) Retaining the powder at 50° C. for 5 minutes, followed by heating to 180° C. at a heating rate of 10° C./min.

The temperature of a peak top in a melting curve obtained in the process of heating in the step 3) was regarded as a melting peak temperature (Tₘ₂).

### [Method for Synthesizing Catalyst]

### Catalyst Production Example 1

### Preparation of Supported Metallocene Catalytic Component [A]

### (1) Synthesis of Raw Material [a-1]

Spherical silica having an average particle size of 8 μm, a surface area of 400 m²/g, and an intra-particle pore volume of 0.8 ml/g was fired at 500° C. for 5 hours in the nitrogen atmosphere for dehydration. The number of silanol groups was 1.4 mmol/g.

In a 1.8 L autoclave, 40 g of this dehydrated silica was dispersed in 800 mL of hexane in the nitrogen atmosphere to obtain slurry.

While the temperature of the obtained slurry was kept at 20° C. with stirring, 100 mL of a hexane solution of triethyl aluminum (concentration: 1 mol/L) was added dropwise thereto over 1 hour. Then, the mixture was stirred at the same temperature as above for 2 hours.

Then, the obtained reaction mixture was decantated to remove unreacted triethyl aluminum in the supernatant.

In this way, 800 mL of hexane slurry of silica component

[A-1] Treated with Triethyl Aluminum was Obtained.
(2) Preparation of Raw Material [a-2]

[(N-t-Butylamido) (tetramethyl-η⁵-cyclopentadienyl)dimethylsilane]titanium-1,3-pentadiene (hereinafter, referred to as a “titanium complex”) was dissolved at 200 mmol in 1250 mL of Isopar E [trade name of hydrocarbon mixture manufactured by Exxon Chemical Co., Inc. (US)]. To this solution, 25 mL of a hexane solution containing 1 mol/L commercially available butyl ethyl magnesium was added. The titanium complex concentration was adjusted to 0.1 mol/L by the addition of hexane to obtain titanium complex [a-2].

(3) Preparation of Raw Material [a-3]

Bis(hydrogenated tallow alkyl)methylammonium-tris(pentafluorophenyl) (4-hydroxyphenyl) borate (hereinafter, referred to as a “borate”) (5.7 g) was added to 50 mL of toluene and dissolved therein to obtain a 100 mmol/L toluene solution of the borate. To this toluene solution of the borate, 5 mL of a hexane solution containing 1 mol/L ethoxydiethyl aluminum was added at room temperature. The borate concentration in the solution was adjusted to 70 mmol/L by the addition of hexane. Then, the mixture was stirred at room temperature for 1 hour to obtain reaction mixture [a-3] containing the borate.

### (4) Synthesis of Supported Metallocene Catalyst [A]

While 800 mL of the slurry of the silica component [a-1] obtained in the section (1) was stirred at 20° C., 48 mL of the titanium complex [a-2] obtained in the section (2) and 69 mL of the reaction mixture [a-3] containing the borate obtained in the section (3) were added thereto at the same time over 1 hour. The mixture was further stirred at the same temperature as above for 1 hour such that the titanium complex was reacted with the borate. Catalytic activity can be controlled by adjusting the amounts of the titanium complex [a-2] and the reaction mixture [a-3] containing the borate here. Specifically, the catalytic activity tends to be increased by increasing their amounts. After the completion of the reaction, the supernatant was removed, and unreacted catalytic raw materials were removed with hexane to obtain supported metallocene catalyst [A] containing a catalytic active species formed on the silica (hereinafter, also referred to as solid catalytic component [A] or solid catalyst A).

### (5) Synthesis of Raw Material(a-4)

An 8 L stainless autoclave thoroughly purged with nitrogen was charged with 2,000 mL of a hexane solution containing 1 mol/L 6 [Mg(C₄H₉)₂]·Al(C₂H₅)₃ (corresponding to 2000 mmol in total of magnesium and aluminum), and pressure-fed with 240 mL of a hexane solution containing 8.33 mol/L methyl hydrogen polysiloxane (manufactured by Shin-Etsu Chemical Co., Ltd.) with stirring at 80° C., and the stirring was further continued at 80° C. over 2 hours.

After the completion of the reaction, the reaction solution was cooled to ordinary temperature and used as raw material (a-4). The raw material (a-4) had a concentration of 0.786 mol/L in total of magnesium and aluminum.

### Catalyst Production Example 2

### Preparation of Solid Catalytic Component [B]

### (1) Synthesis of Raw Material(b-1)

An 8 L stainless steel autoclave thoroughly purged with nitrogen was charged with 2,000 mL of 6 [Mg(C₄H₉)₂]·Al(C₂H₅)₃, the resultant was diluted with hexane, and then a hexane solution containing 800 mmol of n-butanol was added thereto dropwise over 3 hours with stirring at 50° C. After the completion of the dropwise addition, the line was washed with 300 mL of hexane. The reaction was further continued with stirring at 50° C. over 2 hours. After the completion of the reaction, the reaction solution was cooled to ordinary temperature and used as a raw material [b-1].

### (2) Synthesis of Raw Material[b-2]

In a 8 L stainless autoclave thoroughly purged with nitrogen, with stirring 2,000 mL of a hexane solution containing 1 mol/L 6 [Mg(C₄H₉)₂]·Al(C₂H₅)₃ (corresponding to 2000 mmol in total of magnesium and aluminum) at 80° C., 240 mL of a hexane solution containing 8.33 mol/L methyl hydrogen polysiloxane (manufactured by Shin-Etsu Chemical Co., Ltd.) was pressure-fed, and the stirring was further continued at 80° C. over 2 hours. After the completion of the reaction, the reaction solution was cooled to ordinary temperature and used as raw material [b-2]. The raw material [b-2] had a concentration of 0.786 mol/L in total of magnesium and aluminum.

### (3) Synthesis of Carrier [B-1]

An 8 L stainless steel autoclave thoroughly purged with nitrogen was charged with 1,000 mL of a hexane solution containing 1 mmol/L trichlorosilane, and a hexane solution containing the organic magnesium compound corresponding to 943 mmol of magnesium as the raw material [b-1] was added thereto at 65° C. dropwise over 3 hours, and the reaction was further continued with stirring at 65° C. for 1 hour. After the completion of the reaction, the supernatant was removed, and the resulting solid was washed with 1,800 mL of hexane four times to obtain a carrier [B-1]. As a result of analyzing this carrier, the amount of magnesium contained per g of the solid was 7.5 mmol.

### (4) Preparation of Solid Catalytic Component [B]

To 1,970 mL of the hexane slurry containing 110 g of the carrier [B-1], 103 mL of a hexane solution containing 1 mol/L titanium tetrachloride and 131 mL of the raw material [b-2] were added at the same time over 3 hours with stirring at 10° C. After the addition, the reaction was continued at 10° C. for 1 hour. After the completion of the reaction, the supernatant was removed, and unreacted raw material components were removed by washing with hexane four times to prepare solid catalytic component [B].

### Catalyst Production Example 3

### Preparation of Solid Catalytic Component [C]

### (1) Synthesis of Raw Material(c-1)

An 8 L stainless autoclave thoroughly purged with nitrogen was charged with 2,000 mL of a hexane solution containing 1 mol/L 6 [Mg(C₄H₉)₂]·Al(C₂H₅)₃ (corresponding to 2,000 mmol in total of magnesium and aluminum), and pressure-fed with 240 mL of a hexane solution containing 8.33 mol/L methyl hydrogen polysiloxane (manufactured by Shin-Etsu Chemical Co., Ltd.) with stirring at 80° C., and the reaction was further continued with stirring at 80° C. over 2 hours. After the completion of the reaction, the reaction solution was cooled to ordinary temperature and used as raw material (c-1). The raw material (c-1) had a concentration of 0.786 mol/L in total of magnesium and aluminum.

### (2) Preparation of Solid Catalytic Component [C]

To an 8 L stainless autoclave purged with nitrogen, 1,600 mL of hexane was added. To the autoclave, 800 mL of a hexane solution containing 1 mol/L titanium tetrachloride and 800 mL of the raw material (c-1) were added at the same time over 5 hours with stirring at 10° C. The reaction was continued at 10° C. for 1 hour.

After the completion of the reaction, the supernatant was removed, and unreacted raw material components were removed by washing with hexane four times to prepare solid catalytic component [C] (hereinafter, also referred to as solid catalyst C). The catalytic activity of this catalyst can be adjusted by a polymerization pressure in polymerization.

### [Promoter]

The promoters used were the following promoters 1 to 3.
Promoter 1: a mixture of commercially available triisobutyl aluminum and diisobutyl aluminum hydride (9:1 (mass ratio in order) mixture)
Promoter 2: 6 [Mg(C₄H₉)₂]·Al(C₂H₅)₃
Promoter 3: The raw material (a-4), the raw material (b-2) or the raw material(c-1) synthesized above

### Example 1

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.045 MPa, and ethylene was further introduced into the polymerization reactor such that its internal pressure was 0.1 MPa. Then, 5.0 mg of the solid catalytic component [C] was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless steel beaker with an aperture of 68 mm, and was dried at 70° C. for 2 hours with stirring at a stirring speed of 50 rpm to obtain an ultrahigh-molecular-weight polyethylene powder. Next, the ultrahigh-molecular-weight polyethylene powder was dipped for 3 hours in liquid paraffin adjusted to 50° C. under vacuum, and then dipped in hexane for 10 hours to extract the liquid paraffin, and the resultant was dried at 25° C. for 24 hours. The catalytic activity of the ultrahigh-molecular-weight polyethylene powder (amount of polyethylene obtained per unit catalyst weight) was 18,000 (g-PE/g-catalyst). Scales and an extremely coarse powder were removed using a sieve having an aperture size of 425 am, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes to be used as a separator for a secondary battery were produced by the methods described above in (Molded article production process 1-1), (Molded article production process 1-2), (Molded article production process 2-1), and (Molded article production process 2-2) using the obtained ultrahigh-molecular-weight polyethylene powder, and evaluated by the evaluation methods 1 to 4 described above. The obtained evaluation results of the microporous membranes are shown in Table 1.

### Example 2

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 1 was dispersed in 100 mL of dehydrated normal hexane and introduced into the polymerization reactor, and the temperature of the polymerization reactor was adjusted to 20° C. Stirring was started at a rotational speed of 1,000 rpm. Then, ethylene was adjusted to 15 NL in a flowmeter, and 750.0 mg of the solid catalytic component [C] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 2) was extracted and collected into a nitrogen glove.

Subsequently, main polymerization was carried out using the collected preliminary polymerization catalyst 2.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.045 MPa. Further, ethylene was introduced into the polymerization reactor such that its internal pressure was 0.8 MPa. Then, 40.0 mg of the preliminary polymerization catalyst 2 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 3 hours in liquid paraffin adjusted to 50° C. under vacuum, and then dipped in hexane for 10 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 24,000 (g-PE/g-catalyst). Scales and an extremely coarse powder were removed using a sieve having an aperture size of 425 μm, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes to be used as a separator for a secondary battery were produced by the methods described above in (Molded article production process 1-1), (Molded article production process 1-2), (Molded article production process 2-1), and (Molded article production process 2-2) using the obtained ultrahigh-molecular-weight polyethylene powder, and evaluated by the evaluation methods 1 to 4 described above. The obtained evaluation results of the microporous membranes are shown in Table 1.

### Example 3

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 1 was dispersed in 100 mL of dehydrated normal hexane and introduced into the polymerization reactor, and the temperature of the polymerization reactor was adjusted to 20° C. Stirring was started at a rotational speed of 1,000 rpm. Then, ethylene was adjusted to 15 NL in a flowmeter, and 750.0 mg of the solid catalytic component [C] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 3) was extracted and collected into a nitrogen glove.

Subsequently, main polymerization was carried out using the collected preliminary polymerization catalyst 3.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.016 MPa. Further, ethylene was introduced into the polymerization reactor such that its internal pressure was 0.8 MPa. Then, 40.0 mg of the preliminary polymerization catalyst 3 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 3 hours in liquid paraffin adjusted to 50° C. under vacuum, and then dipped in hexane for 10 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 26,500 (g-PE/g-catalyst). Scales and an extremely coarse powder were removed using a sieve having an aperture size of 425 μm, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes for secondary battery separators were produced by the methods described above in (Molded article production process 1-1), (Molded article production process 1-2), (Molded article production process 2-1), and (Molded article production process 2-2) using the obtained ultrahigh-molecular-weight polyethylene powder, and evaluated by the evaluation methods 1 to 4. The obtained results of evaluating the microporous membranes are shown in Table 1.

### Example 4

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 1 was dispersed in 100 mL of dehydrated normal hexane and introduced into the polymerization reactor, and the temperature of the polymerization reactor was adjusted to 15° C. Stirring was started at a rotational speed of 1,000 rpm. Then, ethylene was adjusted to 15 NL in a flowmeter, and 750.0 mg of the solid catalytic component [C] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 4) was extracted and collected into a nitrogen glove.

Subsequently, main polymerization was carried out using the collected preliminary polymerization catalyst 4.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.0036 MPa. Further, ethylene was introduced into the polymerization reactor such that its internal pressure was 0.8 MPa. Then, 40.0 mg of the preliminary polymerization catalyst 4 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless steel beaker with an aperture of 68 mm, and was dried at 70° C. for 2 hours with stirring at a stirring speed of 50 rpm to obtain an ultrahigh-molecular-weight polyethylene powder. Next, the ultrahigh-molecular-weight polyethylene powder was dipped for 4 hours in liquid paraffin adjusted to 60° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 26,000 (g-PE/g-catalyst). Scales and an extremely coarse powder were removed using a sieve having an aperture size of 425 m, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes to be used as a separator for a secondary battery were produced by the methods described above in (Molded article production process 1-1), (Molded article production process 1-2), (Molded article production process 2-1), and (Molded article production process 2-2) using the obtained ultrahigh-molecular-weight polyethylene powder, and evaluated by the evaluation methods 1 to 4 described above. The obtained evaluation results of the microporous membranes are shown in Table 1.

### Example 5

The air inside a vessel-type 1.5 L polymerization reactor equipped with a stirrer was evacuated, and 500 mL of a mixed solvent obtained precedently by well mixing 45% by mass of dehydrated normal hexane and 55% by mass of liquid paraffin was then introduced into the polymerization reactor. Subsequently, 5.0 mL of the promoter 1 was dispersed in 100 mL of dehydrated normal hexane and introduced into the polymerization reactor, and the temperature of the polymerization reactor was adjusted to 15° C., followed by starting stirring at a rotational speed of 1,000 rpm. Thereafter, ethylene was adjusted to 15 NL in a flowmeter, and 750.0 mg of the solid catalytic component [C] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as the preliminary polymerization catalyst 5) was extracted and collected into a nitrogen glove.

Subsequently, main polymerization was carried out using the collected preliminary polymerization catalyst 5.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.0036 MPa, and ethylene was further introduced into the polymerization reactor such that its internal pressure was 0.8 MPa. Then, 40.0 mg of the preliminary polymerization catalyst 5 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless steel beaker with an aperture of 68 mm, and was dried at 70° C. for 2 hours with stirring at a stirring speed of 50 rpm to obtain an ultrahigh-molecular-weight polyethylene powder.

The catalytic activity of the ultrahigh-molecular-weight polyethylene powder (amount of polyethylene obtained per unit catalyst weight) was 24,200 (g-PE/g-catalyst). Scales and an extremely coarse powder were removed using a sieve having an aperture size of 425 μm, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes to be used as a separator for a secondary battery were produced by the methods described above in (Molded article production process 1-1), (Molded article production process 1-2), (Molded article production process 2-1), and (Molded article production process 2-2) using the obtained ultrahigh-molecular-weight polyethylene powder, and evaluated by the evaluation methods 1 to 4 described above. The obtained evaluation results of the microporous membranes are shown in Table 1.

### Example 6

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 2 was dispersed in 100 mL of dehydrated normal hexane and introduced into the polymerization reactor, and the temperature of the polymerization reactor was adjusted to 10° C., followed by starting stirring at a rotational speed of 1,000 rpm. Thereafter, ethylene was adjusted to 10 NL in a flowmeter, and 750.0 mg of the solid catalytic component [B] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as the preliminary polymerization catalyst 6) was extracted and collected into a nitrogen glove.

Subsequently, main polymerization was carried out using the collected preliminary polymerization catalyst 6.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 2 was dispersed in 100 mL of dehydrated normal hexane and introduced into the polymerization reactor, and the temperature of the polymerization reactor was adjusted to 78° C. Stirring was started at a rotational speed of 1,000 rpm. Subsequently, hydrogen for adjusting intrinsic viscosity IV (molecular weight) was introduced into the polymerization reactor such that its internal pressure was 0.00035 MPa, and ethylene was further introduced into the polymerization reactor such that its internal pressure was 0.8 MPa. Then, 40.0 mg of the preliminary polymerization catalyst 6 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless steel beaker with an aperture of 68 mm, and was dried at 70° C. for 2 hours with stirring at a stirring speed of 50 rpm to obtain an ultrahigh-molecular-weight polyethylene powder. Next, the ultrahigh-molecular-weight polyethylene powder was dipped for 4 hours in liquid paraffin adjusted to 60° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 21,350 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1), (Molded article production process 3-2), (Molded article production process 4-1), and (Molded article production process 4-2) using the obtained ultrahigh-molecular-weight polyethylene powder, and evaluated by the evaluation methods 5 to 8 described above. The obtained evaluation results of the high-strength fibers are shown in Table 1.

### Example 7

The air inside a vessel-type 1.5 L polymerization reactor equipped with a stirrer was evacuated, and 500 mL of a mixed solvent obtained precedently by well mixing 35% by mass of dehydrated normal hexane and 65% by mass of liquid paraffin was then introduced into the polymerization reactor. Subsequently, 5.0 mL of the promoter 2 was dispersed in 100 mL of dehydrated normal hexane and introduced into the polymerization reactor, and the temperature of the polymerization reactor was adjusted to 10° C., followed by starting stirring at a rotational speed of 1,000 rpm. Thereafter, ethylene was adjusted to 10 NL in a flowmeter, and 750.0 mg of the solid catalytic component [B] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as the preliminary polymerization catalyst 7) was extracted and collected into a nitrogen glove.

Subsequently, main polymerization was carried out using the collected preliminary polymerization catalyst 7.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 2 was dispersed in 100 mL of dehydrated normal hexane and introduced into the polymerization reactor, and the temperature of the polymerization reactor was adjusted to 78° C. Stirring was started at a rotational speed of 1,000 rpm. Subsequently, hydrogen for adjusting intrinsic viscosity IV (molecular weight) was introduced into the polymerization reactor such that its internal pressure was 0.00035 MPa. Further, ethylene was introduced into the polymerization reactor such that its internal pressure was 0.7 MPa. Then, 40.0 mg of the preliminary polymerization catalyst 7 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. The catalytic activity of the ultrahigh-molecular-weight polyethylene powder (amount of polyethylene obtained per unit catalyst weight) was 21,000 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1), (Molded article production process 3-2), (Molded article production process 4-1), and (Molded article production process 4-2) using the obtained ultrahigh-molecular-weight polyethylene powder, and evaluated by the evaluation methods 5 to 8 described above. The obtained evaluation results of the high-strength fibers are shown in Table 1.

### Example 8

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 2 was dispersed in 100 mL of dehydrated normal hexane and introduced into the polymerization reactor, and the temperature of the polymerization reactor was adjusted to 10° C. Stirring was started at a rotational speed of 1,000 rpm. Then, ethylene was adjusted to 10 NL in a flowmeter, and 750.0 mg of the solid catalytic component [B] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 8) was extracted and collected into a nitrogen glove.

Subsequently, main polymerization was carried out using the collected preliminary polymerization catalyst 8.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 2 was dispersed in 100 mL of dehydrated normal hexane and introduced into the polymerization reactor, and the temperature of the polymerization reactor was adjusted to 58° C. Stirring was started at a rotational speed of 1,000 rpm. Subsequently, ethylene gas was introduced into the polymerization reactor such that its internal pressure was 0.7 MPa. Then, 40.0 mg of the preliminary polymerization catalyst 8 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 4 hours in liquid paraffin adjusted to 70° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 19,000 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1), (Molded article production process 3-2), (Molded article production process 4-1), and (Molded article production process 4-2) using the obtained ultrahigh-molecular-weight polyethylene powder, and evaluated by the evaluation methods 5 to 8. The obtained results of evaluating the high-strength fibers are shown in Table 1.

### Example 9

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 3 was dispersed in 100 mL of dehydrated normal hexane and introduced into the polymerization reactor, and the temperature of the polymerization reactor was adjusted to 8° C. Stirring was started at a rotational speed of 1,000 rpm. Then, ethylene was adjusted to 5 NL in a flowmeter, and 750.0 mg of the solid catalytic component [A] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 9) was extracted and collected into a nitrogen glove.

Subsequently, main polymerization was carried out using the collected preliminary polymerization catalyst 9.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 3 was dispersed in 100 mL of dehydrated normal hexane and introduced into the polymerization reactor, and the temperature of the polymerization reactor was adjusted to 70° C. Stirring was started at a rotational speed of 1,000 rpm. Subsequently, ethylene gas was introduced into the polymerization reactor such that its internal pressure was 0.8 MPa. Then, 40.0 mg of the preliminary polymerization catalyst 9 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 6 hours in liquid paraffin adjusted to 80° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 28,000 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1), (Molded article production process 3-2), (Molded article production process 4-1), and (Molded article production process 4-2) using the obtained ultrahigh-molecular-weight polyethylene powder, and evaluated by the evaluation methods 5 to 8. The obtained results of evaluating the high-strength fibers are shown in Table 1.

### Example 10

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 3 was dispersed in 100 mL of dehydrated normal hexane and introduced into the polymerization reactor, and the temperature of the polymerization reactor was adjusted to 5° C. Stirring was started at a rotational speed of 1,000 rpm. Then, ethylene was adjusted to 5 NL in a flowmeter, and 750.0 mg of the solid catalytic component [A] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as preliminary polymerization catalyst 10) was extracted and collected into a nitrogen glove.

Subsequently, main polymerization was carried out using the collected preliminary polymerization catalyst 10.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 3 was dispersed in 100 mL of dehydrated normal hexane and introduced into the polymerization reactor, and the temperature of the polymerization reactor was adjusted to 60° C. Stirring was started at a rotational speed of 1,000 rpm. Subsequently, ethylene gas was introduced into the polymerization reactor such that its internal pressure was 0.8 MPa. Then, 40.0 mg of the preliminary polymerization catalyst 10 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 6 hours in liquid paraffin adjusted to 90° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 26,000 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1), (Molded article production process 3-2), (Molded article production process 4-1), and (Molded article production process 4-2) using the obtained ultrahigh-molecular-weight polyethylene powder, and evaluated by the evaluation methods 5 to 8. The obtained results of evaluating the high-strength fibers are shown in Table 1.

### Comparative Example 1

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 1 was dispersed in 100 mL of dehydrated normal hexane and introduced into the polymerization reactor, and the temperature of the polymerization reactor was adjusted to 20° C., followed by starting stirring at a rotational speed of 1,000 rpm. Thereafter, ethylene was adjusted to 15 NL in a flowmeter, and 750.0 mg of the solid catalytic component [C] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as the preliminary polymerization catalyst H-1) was extracted and collected into a nitrogen glove.

Subsequently, main polymerization was carried out using the collected preliminary polymerization catalyst H-1.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.05 MPa, and ethylene was further introduced into the polymerization reactor such that its internal pressure was 0.8 MPa. Then, 40.0 mg of the preliminary polymerization catalyst H-1 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder form. The obtained solid component was placed in a stainless steel beaker with an aperture of 68 mm and dried at 70° C. for 2 hours with stirring at a stirring speed of 50 rpm to obtain an ultrahigh-molecular-weight polyethylene powder. Next, the ultrahigh-molecular-weight polyethylene powder was dipped for 3 hours in liquid paraffin adjusted to 50° C. under vacuum, and then dipped in hexane for 10 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 24,500 (g-PE/g-catalyst). Scales and an extremely coarse powder were removed using a sieve having an aperture size of 425 μm, 600 ppm of calcium stearate was added thereto, and then, the physical property evaluation of the ultrahigh-molecular-weight polyethylene powder was carried out. The evaluation results of the ultrahigh-molecular-weight polyethylene powder are shown in Table 1.

Microporous membranes to be used as a separator for a secondary battery were produced by the methods described above in (Molded article production process 1-1) and (Molded article production process 2-1) using the obtained ultrahigh-molecular-weight polyethylene powder, and evaluated by the evaluation methods 1 to 4 described above. The obtained evaluation results of the microporous membranes are shown in Table 1.

### Comparative Example 2

The air inside a vessel-type 1.5 L polymerization reactor equipped with a stirrer was evacuated, and 500 mL of dehydrated normal hexane was then introduced into the polymerization reactor. Subsequently, 5.0 mL of the promoter 3 was dispersed in 100 mL of dehydrated normal hexane and introduced into the polymerization reactor, and the temperature of the polymerization reactor was adjusted to 5° C., followed by starting stirring at a rotational speed of 1,000 rpm. Thereafter, ethylene was adjusted to 5 NL in a flowmeter, and 750.0 mg of the solid catalytic component [A] was dispersed in 200 mL of dehydrated normal hexane and introduced into the polymerization reactor, followed by batch preliminary polymerization reaction for 1.0 hour. After the completion of the reaction, the obtained preliminary polymerization catalyst (hereinafter, also referred to as the preliminary polymerization catalyst H-2) was extracted and collected into a nitrogen glove.

Subsequently, main polymerization was carried out using the collected preliminary polymerization catalyst H-2.

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 3 was dispersed in 100 mL of dehydrated normal hexane and introduced into the polymerization reactor, and the temperature of the polymerization reactor was adjusted to 58° C. Stirring was started at a rotational speed of 1,000 rpm. Subsequently, ethylene gas was introduced into the polymerization reactor such that its internal pressure was 0.8 MPa. Then, 40.0 mg of the preliminary polymerization catalyst H-2 was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state.

The obtained solid component was placed in a stainless steel beaker with an aperture of 68 mm, and was dried at 70° C. for 2 hours with stirring at a stirring speed of 50 rpm to obtain an ultrahigh-molecular-weight polyethylene powder. Next, the ultrahigh-molecular-weight polyethylene powder was dipped for 6 hours in liquid paraffin adjusted to 90° C. under vacuum, and then dipped in hexane for 15 hours to extract the liquid paraffin, and the resultant was dried at 25° C. for 24 hours.

The catalytic activity of the ultrahigh-molecular-weight polyethylene powder (amount of polyethylene obtained per unit catalyst weight) was 22,500 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1. High-strength fibers were produced by the methods described above in (Molded article production process 3-1) and (Molded article production process 4-1) using the obtained ultrahigh-molecular-weight polyethylene powder, and evaluated by the evaluation methods 5 to 8 described above. The obtained evaluation results of the microporous membranes are shown in Table 1.

### Comparative Example 3

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 1 was dispersed in 100 mL of dehydrated normal hexane and introduced into the polymerization reactor, and the temperature of the polymerization reactor was adjusted to 80° C. Stirring was started at a rotational speed of 1,000 rpm. Subsequently, hydrogen for adjusting intrinsic viscosity IV (molecular weight) was introduced into the polymerization reactor such that its internal pressure was 0.016 MPa, and ethylene was further introduced into the polymerization reactor such that its internal pressure was 0.8 MPa. Then, 5.0 mg of the solid catalytic component [C] was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. The catalytic activity of the ultrahigh-molecular-weight polyethylene powder (amount of polyethylene obtained per unit catalyst weight) was 27,000 (g-PE/g-catalyst). Scales and an extremely coarse powder were removed using a sieve having an aperture size of 425 am, 600 ppm of calcium stearate was added thereto, and then, the physical property evaluation of the ultrahigh-molecular-weight polyethylene powder was carried out. The results of evaluating the ultrahigh-molecular-weight polyethylene powder are shown in Table 1.

Microporous membranes to be used as a separator for a secondary battery were produced by the methods described above in (Molded article production process 1-1) and (Molded article production process 2-1) using the obtained ultrahigh-molecular-weight polyethylene powder, and evaluated by the evaluation methods 1 to 4 described above. The obtained evaluation results of the microporous membranes are shown in Table 1.

### Comparative Example 4

The air inside a vessel-type 1.5 L polymerization reactor equipped with a stirrer was evacuated, and 500 mL of dehydrated normal hexane was then introduced into the polymerization reactor. Subsequently, 0.6 mL of the promoter 2 was dispersed in 100 mL of dehydrated normal hexane and introduced into the polymerization reactor, and the temperature of the polymerization reactor was adjusted to 78° C., followed by starting stirring at a rotational speed of 1,000 rpm. Then, hydrogen for adjusting intrinsic viscosity IV (molecular weight) was introduced into the polymerization reactor such that its internal pressure was 0.00035 MPa, and ethylene was further introduced into the polymerization reactor such that its internal pressure was 0.7 MPa. Then, 5.0 mg of the solid catalytic component [B] was dispersed in 200 mL of dehydrated normal hexane and introduced into the polymerization reactor, followed by batch polymerization reaction for 1.0 hour. During the polymerization reaction, the internal pressure of the polymerization reactor was appropriately maintained by additionally introducing ethylene into the polymerization reactor. Then, the polymerization reactor was opened, and the contents were filtered under reduced pressure to separate and recover a solid component in a powder state. The obtained solid component was placed in a stainless beaker with an aperture of 68 mm and dried at 70° C. for 2 hours with stirring at a stirring speed of 50 rpm to obtain an ultrahigh-molecular-weight polyethylene powder. The catalytic activity of the ultrahigh-molecular-weight polyethylene powder (amount of polyethylene obtained per unit catalyst weight) was 23,500 (g-PE/g-catalyst). Scales and an extremely coarse powder were removed using a sieve having an aperture size of 425 m. The physical property evaluation of the ultrahigh-molecular-weight polyethylene powder was carried out. The results of evaluating the ultrahigh-molecular-weight polyethylene powder are shown in Table 1.

High-strength fibers were produced by the methods described above in (Molded article production process 3-1) and (Molded article production process 4-1) using the obtained ultrahigh-molecular-weight polyethylene powder, and evaluated by the evaluation methods 5 to 8. The obtained results of evaluating the high-strength fibers are shown in Table 1.

TABLE 1-1

| | | | | Example 1 | | Example 2 | | Example 3 | | Example 4 | | Example 5 | | Example 6 |
|---|---|---|---|---|---|---|---|---|---|---|---|---|---|---|
| | | | | Batch | | Batch | | Batch | | Batch | | Batch | | Batch |
| | | | Unit | method | | method | | method | | method | | method | | method |
| Preliminary | | Preliminary | ° C. | — | | 20 | | 20 | | 15 | | 15 | | 10 |
| polymerization | | polymerization | | | | | | | | | | | | |
| | | temperature | | | | | | | | | | | | |
| | | Amount of charged | NL | — | | 15 | | 15 | | 15 | | 15 | | 10 |
| | | ethylene | | | | | | | | | | | | |
| | | Preliminary | h | — | | 1 | | 1 | | 1 | | 1 | | 1 |
| | | polymerization time | | | | | | | | | | | | |
| | | Type of | — | — | | Solid catalyst | | Solid catalyst | | Solid catalyst | | Solid catalyst | | Solid catalyst |
| | | catalyst | | | | component C | | component C | | component C | | component C | | component B |
| | | Type of promoter | — | — | | Promoter 1 | | Promoter 1 | | Promoter 1 | | Promoter 1 | | Promoter 2 |
| Polymerization | | Polymerization | ° C. | 80 | | 80 | | 80 | | 80 | | 80 | | 78 |
| conditions | | temperature | | | | | | | | | | | | |
| | | Polymerization | MPa | 0.1 | | 0.8 | | 0.8 | | 0.8 | | 0.8 | | 0.8 |
| | | pressure | | | | | | | | | | | | |
| | | Hydrogen pressure | MPa | 0.045 | | 0.045 | | 0.016 | | 0.0036 | | 0.0036 | | 0.00035 |
| | | CM (Gas phase | mol % | 0 | | 0 | | 0 | | 0 | | 0 | | 0 |
| | | concentration) | | | | | | | | | | | | |
| | | Type of | — | Solid catalyst | | Preliminary | | Preliminary | | Preliminary | | Preliminary | | Preliminary |
| | | catalyst | | component C | | polymerization | | polymerization | | polymerization | | polymerization | | polymerization |
| | | | | | | catalyst 2 | | catalyst 3 | | catalyst 4 | | catalyst 5 | | catalyst 6 |
| | | Type of promoter | — | Promoter 1 | | Promoter 1 | | Promoter 1 | | Promoter 1 | | Promoter 1 | | Promoter 2 |
| | | Polymerization | h | 1.0 | | 1.0 | | 1.0 | | 1.0 | | 1.0 | | 1.0 |
| | | residence time | | | | | | | | | | | | |
| | | Amount of catalyst | mg | 5.0 | | 40.0 | | 40.0 | | 40.0 | | 40.0 | | 40.0 |
| Drying | | Drying temperature | ° C. | 70 | | 70 | | 70 | | 70 | | 70 | | 70 |
| conditions | | Drying time | h | 2.0 | | 2.0 | | 2.0 | | 2.0 | | 2.0 | | 2.0 |
| Polymerization | | Catalyst activity | g-PE/g-s | 18000 | | 24000 | | 26500 | | 26000 | | 24200 | | 21350 |
| results | | Molecular weight | g/mol | 60,000 | | 60,000 | | 250,000 | | 1,300,000 | | 1,300,000 | | 2,650,000 |
| | | Melting point (Tm 2) | ° C. | 137 | | 137 | | 137 | | 137 | | 137 | | 137 |
| Additive | | CaSt | ppm | 600 | | 600 | | 600 | | 600 | | 600 | | 0 |
| Effects | LiB | (1) Polymer | number/m² | ⊚ | 10 | ⊚ | 5 | ⊚ | 5 | ⊚ | 6 | ⊚ | 6 | |
| | region | concentration: | | | | | | | | | | | | |
| | Molded | normal | | | | | | | | | | | | |
| | article | (number of defects) | | | | | | | | | | | | |
| | producing | Polymer | | ◯ | 17 | ⊚ | 7 | ⊚ | 7 | ⊚ | 8 | ⊚ | 8 | |
| | method: | concentration: high | | | | | | | | | | | | |
| | 1-1, 2-1 | (number of defects) | | | | | | | | | | | | |
| | | (2) Polymer | μm | ⊚ | 1.4 | ⊚ | 1 | ⊚ | 1 | ⊚ | 1 | ⊚ | 1 | |
| | | concentration: | | | | | | | | | | | | |
| | | normal | | | | | | | | | | | | |
| | | (thickness | | | | | | | | | | | | |
| | | unevenness) | | | | | | | | | | | | |
| | | Polymer | | ◯ | 1.8 | ⊚ | 1 | ⊚ | 1 | ⊚ | 1.2 | ⊚ | 1.2 | |
| | | concentration: high | | | | | | | | | | | | |
| | | (thickness | | | | | | | | | | | | |
| | | unevenness) | | | | | | | | | | | | |
| | | (3) Polymer | gf/ | Δ | 68 | ◯ | 75 | ◯ | 79 | ⊚ | 90 | ⋆ | 96 | |
| | | concentration: | (g/m²) | | | | | | | | | | | |
| | | normal | | | | | | | | | | | | |
| | | (puncture strength) | | | | | | | | | | | | |
| | | Polymer | | Δ | 60 | Δ | 69 | ◯ | 75 | ⊚ | 87 | ⊚ | 92 | |
| | | concentration: high | | | | | | | | | | | | |
| | | (puncture strength) | | | | | | | | | | | | |
| | | (4) Polymer | % | ⊚ | 15 | ⊚ | 10 | ⊚ | 11 | ⊚ | 14 | ⊚ | 11 | |
| | | concentration: | | | | | | | | | | | | |
| | | normal | | | | | | | | | | | | |
| | | Polymer | | ◯ | 20 | ⊚ | 12 | ⊚ | 13 | ⊚ | 17 | ⊚ | 13 | |
| | | concentration: high | | | | | | | | | | | | |
| | | @ porosity of 50% | | | | | | | | | | | | |
| | | (heat shrinkage rate) | | | | | | | | | | | | |
| | | @ porosity of 50% | | | | | | | | | | | | |
| | | (heat shrinkage rate) | | | | | | | | | | | | |
| | Fiber | (5) Labo Plastomill | number/m | | | | | | | | | | | ⊚ |
| | region | kneading time: | | | | | | | | | | | | |
| | Molded | normal | | | | | | | | | | | | |
| | article | (amount of fiber ball) | | | | | | | | | | | | |
| | producing | Labo Plastomill | | | | | | | | | | | | ⊚ |
| | method: | kneading time: short | | | | | | | | | | | | |
| | 3-1, 4-1 | (amount of fiber ball) | | | | | | | | | | | | |
| | | (6) Labo Plastomill | μm | | | | | | | | | | | ⊚ |
| | | kneading time: | | | | | | | | | | | | |
| | | normal | | | | | | | | | | | | |
| | | (unevenness of fiber | | | | | | | | | | | | |
| | | diameter) | | | | | | | | | | | | |
| | | Labo Plastomill | | | | | | | | | | | | ⊚ |
| | | kneading time: short | | | | | | | | | | | | |
| | | (unevenness of fiber | | | | | | | | | | | | |
| | | diameter) | | | | | | | | | | | | |
| | | (7) Labo Plastomill | cN/dtex | | | | | | | | | | | ◯ |
| | | kneading time: | | | | | | | | | | | | |
| | | normal | | | | | | | | | | | | |
| | | (breaking strength) | | | | | | | | | | | | |
| | | Labo Plastomill | | | | | | | | | | | | Δ |
| | | kneading time: short | | | | | | | | | | | | |
| | | (breaking strength) | | | | | | | | | | | | |
| | | (8) Labo Plastomill | m/min | | | | | | | | | | | ◯ |
| | | kneading time: | | | | | | | | | | | | |
| | | normal | | | | | | | | | | | | |
| | | (winding rate at | | | | | | | | | | | | |
| | | break) | | | | | | | | | | | | |
| | | Labo Plastomill | | | | | | | | | | | | Δ |
| | | kneading time: short | | | | | | | | | | | | |
| | | (winding rate at | | | | | | | | | | | | |
| | | break) | | | | | | | | | | | | |

| | | | | Example 6 | Example 7 | | Example 8 |
|---|---|---|---|---|---|---|---|
| | | | | Batch | Batch | | Batch |
| | | | Unit | method | method | | method |
| Preliminary | | Preliminary | ° C. | 10 | 10 | | 10 |
| polymerization | | polymerization | | | | | |
| | | temperature | | | | | |
| | | Amount of charged | NL | 10 | 10 | | 10 |
| | | ethylene | | | | | |
| | | Preliminary | h | 1 | 1 | | 1 |
| | | polymerization time | | | | | |
| | | Type of | — | Solid catalyst | Solid catalyst | | Solid catalyst |
| | | catalyst | | component B | component B | | component B |
| | | Type of promoter | — | Promoter 2 | Promoter 2 | | Promoter 2 |
| Polymerization | | Polymerization | ° C. | 78 | 78 | | 58 |
| conditions | | temperature | | | | | |
| | | Polymerization | MPa | 0.8 | 0.7 | | 0.7 |
| | | pressure | | | | | |
| | | Hydrogen pressure | MPa | 0.00035 | 0.00035 | | 0 |
| | | CM (Gas phase | mol % | 0 | 0 | | 0 |
| | | concentration) | | | | | |
| | | Type of | — | Preliminary | Preliminary | | Preliminary |
| | | catalyst | | polymerization | polymerization | | polymerization |
| | | | | catalyst 6 | catalyst 7 | | catalyst 8 |
| | | Type of promoter | — | Promoter 2 | Promoter 2 | | Promoter 2 |
| | | Polymerization | h | 1.0 | 1.0 | | 1.0 |
| | | residence time | | | | | |
| | | Amount of catalyst | mg | 40.0 | 40.0 | | 40.0 |
| Drying | | Drying temperature | ° C. | 70 | 70 | | 70 |
| conditions | | Drying time | h | 2.0 | 2.0 | | 2.0 |
| Polymerization | | Catalyst activity | g-PE/g-s | 21350 | 21000 | | 19000 |
| results | | Molecular weight | g/mol | 2,650,000 | 3,700,000 | | 7,920,000 |
| | | Melting point (Tm 2) | ° C. | 137 | 137 | | 137 |
| Additive | | CaSt | ppm | 0 | 0 | | 0 |
| Effects | LiB | (1) Polymer | number/m² | | | | |
| | region | concentration: | | | | | |
| | Molded | normal | | | | | |
| | article | (number of defects) | | | | | |
| | producing | Polymer | | | | | |
| | method: | concentration: high | | | | | |
| | 1-1, 2-1 | (number of defects) | | | | | |
| | | (2) Polymer | μm | | | | |
| | | concentration: | | | | | |
| | | normal | | | | | |
| | | (thickness | | | | | |
| | | unevenness) | | | | | |
| | | Polymer | | | | | |
| | | concentration: high | | | | | |
| | | (thickness | | | | | |
| | | unevenness) | | | | | |
| | | (3) Polymer | gf/ | | | | |
| | | concentration: | (g/m²) | | | | |
| | | normal | | | | | |
| | | (puncture strength) | | | | | |
| | | Polymer | | | | | |
| | | concentration: high | | | | | |
| | | (puncture strength) | | | | | |
| | | (4) Polymer | % | | | | |
| | | concentration: | | | | | |
| | | normal | | | | | |
| | | Polymer | | | | | |
| | | concentration: high | | | | | |
| | | @ porosity of 50% | | | | | |
| | | (heat shrinkage rate) | | | | | |
| | | @ porosity of 50% | | | | | |
| | | (heat shrinkage rate) | | | | | |
| | Fiber | (5) Labo Plastomill | number/m | 1 | ⊚ | 1 | ⊚ |
| | region | kneading time: | | | | | |
| | Molded | normal | | | | | |
| | article | (amount of fiber ball) | | | | | |
| | producing | Labo Plastomill | | 1 | ⊚ | 1 | ◯ |
| | method: | kneading time: short | | | | | |
| | 3-1, 4-1 | (amount of fiber ball) | | | | | |
| | | (6) Labo Plastomill | μm | 1 | ⊚ | 1 | ⊚ |
| | | kneading time: | | | | | |
| | | normal | | | | | |
| | | (unevenness of fiber | | | | | |
| | | diameter) | | | | | |
| | | Labo Plastomill | | 2 | ⊚ | 2 | ◯ |
| | | kneading time: short | | | | | |
| | | (unevenness of fiber | | | | | |
| | | diameter) | | | | | |
| | | (7) Labo Plastomill | cN/dtex | 26 | ⊚ | 32 | ⊚ |
| | | kneading time: | | | | | |
| | | normal | | | | | |
| | | (breaking strength) | | | | | |
| | | Labo Plastomill | | 23 | ◯ | 28 | ⊚ |
| | | kneading time: short | | | | | |
| | | (breaking strength) | | | | | |
| | | (8) Labo Plastomill | m/min | 520 | ⊚ | 820 | ⊚ |
| | | kneading time: | | | | | |
| | | normal | | | | | |
| | | (winding rate at | | | | | |
| | | break) | | | | | |
| | | Labo Plastomill | | 390 | ◯ | 580 | ◯ |
| | | kneading time: short | | | | | |
| | | (winding rate at | | | | | |
| | | break) | | | | | |

| | | | | Example 8 | Example 9 | | Example 10 | |
|---|---|---|---|---|---|---|---|---|
| | | | | Batch | Batch | | Batch | |
| | | | Unit | method | method | | method | |
| Preliminary | | Preliminary | ° C. | 10 | 8 | | 5 | |
| polymerization | | polymerization | | | | | | |
| | | temperature | | | | | | |
| | | Amount of charged | NL | 10 | 5 | | 5 | |
| | | ethylene | | | | | | |
| | | Preliminary | h | 1 | 1 | | 1 | |
| | | polymerization time | | | | | | |
| | | Type of | — | Solid catalyst | Solid catalyst | | Solid catalyst | |
| | | catalyst | | component B | component A | | component A | |
| | | Type of promoter | — | Promoter 2 | Promoter 3 | | Promoter 3 | |
| Polymerization | | Polymerization | ° C. | 58 | 70 | | 60 | |
| conditions | | temperature | | | | | | |
| | | Polymerization | MPa | 0.7 | 0.8 | | 0.8 | |
| | | pressure | | | | | | |
| | | Hydrogen pressure | MPa | 0 | 0 | | 0 | |
| | | CM (Gas phase | mol % | 0 | 0 | | 0 | |
| | | concentration) | | | | | | |
| | | Type of | — | Preliminary | Preliminary | | Preliminary | |
| | | catalyst | | polymerization | polymerization | | polymerization | |
| | | | | catalyst 8 | catalyst 9 | | catalyst 10 | |
| | | Type of promoter | — | Promoter 2 | Promoter 3 | | Promoter 3 | |
| | | Polymerization | h | 1.0 | 1.0 | | 1.0 | |
| | | residence time | | | | | | |
| | | Amount of catalyst | mg | 40.0 | 40.0 | | 40.0 | |
| Drying | | Drying temperature | ° C. | 70 | 70 | | 70 | |
| conditions | | Drying time | h | 2.0 | 2.0 | | 2.0 | |
| Polymerization | | Catalyst activity | g-PE/g-s | 19000 | 28000 | | 26000 | |
| results | | Molecular weight | g/mol | 7,920,000 | 9,640,000 | | 11,980,000 | |
| | | Melting point (Tm 2) | ° C. | 137 | 137 | | 137 | |
| Additive | | CaSt | ppm | 0 | 0 | | 0 | |
| Effects | LiB | (1) Polymer | number/m² | | | | | |
| | region | concentration: | | | | | | |
| | Molded | normal | | | | | | |
| | article | (number of defects) | | | | | | |
| | producing | Polymer | | | | | | |
| | method: | concentration: high | | | | | | |
| | 1-1, 2-1 | (number of defects) | | | | | | |
| | | (2) Polymer | μm | | | | | |
| | | concentration: | | | | | | |
| | | normal | | | | | | |
| | | (thickness | | | | | | |
| | | unevenness) | | | | | | |
| | | Polymer | | | | | | |
| | | concentration: high | | | | | | |
| | | (thickness | | | | | | |
| | | unevenness) | | | | | | |
| | | (3) Polymer | gf/ | | | | | |
| | | concentration: | (g/m²) | | | | | |
| | | normal | | | | | | |
| | | (puncture strength) | | | | | | |
| | | Polymer | | | | | | |
| | | concentration: high | | | | | | |
| | | (puncture strength) | | | | | | |
| | | (4) Polymer | % | | | | | |
| | | concentration: | | | | | | |
| | | normal | | | | | | |
| | | Polymer | | | | | | |
| | | concentration: high | | | | | | |
| | | @ porosity of 50% | | | | | | |
| | | (heat shrinkage rate) | | | | | | |
| | | @ porosity of 50% | | | | | | |
| | | (heat shrinkage rate) | | | | | | |
| | Fiber | (5) Labo Plastomill | number/m | 2 | ◯ | 4 | ◯ | 5 |
| | region | kneading time: | | | | | | |
| | Molded | normal | | | | | | |
| | article | (amount of fiber ball) | | | | | | |
| | producing | Labo Plastomill | | 4 | ◯ | 6 | Δ | 7 |
| | method: | kneading time: short | | | | | | |
| | 3-1, 4-1 | (amount of fiber ball) | | | | | | |
| | | (6) Labo Plastomill | μm | 2 | ◯ | 3 | ◯ | 4 |
| | | kneading time: | | | | | | |
| | | normal | | | | | | |
| | | (unevenness of fiber | | | | | | |
| | | diameter) | | | | | | |
| | | Labo Plastomill | | 4 | ◯ | 4 | Δ | 6 |
| | | kneading time: short | | | | | | |
| | | (unevenness of fiber | | | | | | |
| | | diameter) | | | | | | |
| | | (7) Labo Plastomill | cN/dtex | 40 | ⋆ | 45 | ⋆ | 48 |
| | | kneading time: | | | | | | |
| | | normal | | | | | | |
| | | (breaking strength) | | | | | | |
| | | Labo Plastomill | | 35 | ⊚ | 40 | ⊚ | 42 |
| | | kneading time: short | | | | | | |
| | | (breaking strength) | | | | | | |
| | | (8) Labo Plastomill | m/min | 720 | ⊚ | 780 | ⊚ | 800 |
| | | kneading time: | | | | | | |
| | | normal | | | | | | |
| | | (winding rate at | | | | | | |
| | | break) | | | | | | |
| | | Labo Plastomill | | 620 | ⊚ | 700 | ⊚ | 720 |
| | | kneading time: short | | | | | | |
| | | (winding rate at | | | | | | |
| | | break) | | | | | | |

TABLE 1-2

| | | | | Comparative Example 1 | | Comparative Example 2 | |
|---|---|---|---|---|---|---|---|
| | | | Unit | Batch method | | Batch method | |
| Preliminary polymerization | | Preliminary polymerization temperature | ° C. | 20 | | 5 | |
| | | Amount of charged ethylene | NL | 15 | | 5 | |
| | | Preliminary polymerization time | h | 1 | | 1 | |
| | | Type of catalyst | — | Solid catalyst component C | | Solid catalyst component A | |
| | | Type of promoter | — | Promoter 1 | | Promoter 3 | |
| Polymerization conditions | | Polymerization temperature | ° C. | 80 | | 58 | |
| | | Polymerization pressure | MPa | 0.8 | | 0.8 | |
| | | Hydrogen pressure | MPa | 0.05 | | 0 | |
| | | CM (Gas phase concentration) | mol % | 0 | | 0 | |
| | | Type of catalyst | — | Preliminary polymerization | | Preliminary polymerization | |
| | | | | catalyst H-1 | | catalyst H-2 | |
| | | Type of promoter | — | Promoter 1 | | Promoter 3 | |
| | | Polymerization residence time | h | 1.0 | | 1.0 | |
| | | Amount of catalyst | mg | 40.0 | | 40.0 | |
| Drying conditions | | Drying temperature | | 70 | | 70 | |
| | | Drying time | h | 2.0 | | 2.0 | |
| Polymerization results | | Catalyst activity | g-PE/g-s | 24500 | | 22500 | |
| | | Molecular weight | g/mol | 30,000 | | 12,400,000 | |
| | | Melting point (Tm 2) | ° C. | 137 | | 137 | |
| Additive | | CaSt | ppm | 600 | | 0 | |
| Effects | LiB region | (1) Polymer concentration: normal | number/ | — | membrane not | | |
| | Molded article | (number of defects) | m² | | formed | | |
| | producing method: | Polymer concentration: high | | | membrane not | | |
| | 1-1, 2-1 | (number of defects) | | | formed | | |
| | | (2) Polymer concentration: norma | μm | — | membrane not | | |
| | | (thickness unevenness) | | | formed | | |
| | | Polymer concentration: high | | — | membrane not | | |
| | | (thickness unevenness) | | | formed | | |
| | | (3) Polymer concentration: normal | gf/(g/m²) | — | membrane not | | |
| | | (puncture strength) | | | formed | | |
| | | Polymer concentration: high | | — | membrane not | | |
| | | (puncture strength) | | | formed | | |
| | | (4) Polymer concentration: normal | % | — | membrane not | | |
| | | @ porosity of 50% | | | formed | | |
| | | (heat shrinkage rate) | | | | | |
| | | Polymer concentration: high | | — | membrane not | | |
| | | @ porosity of 50% | | | formed | | |
| | | (heat shrinkage rate) | | | | | |
| | Fiber region | (5) Labo Plastomill kneading time: normal | number/ | | | — | not spun |
| | Molded article | (amount of fiber ball) | m | | | | |
| | producing method: | Labo Plastomill kneading time: short | | | | — | not spun |
| | 3-1, 4-1 | (amount of fiber ball) | | | | | |
| | | (6) Labo Plastomill kneading time: normal | μm | | | — | not spun |
| | | (unevenness of fiber diameter) | | | | | |
| | | Labo Plastomill kneading time: short | | | | — | not spun |
| | | (unevenness of fiber diameter) | | | | | |
| | | (7) Labo Plastomill kneading time: normal | cN/dtex | | | — | not spun |
| | | (breaking strength) | | | | | |
| | | Labo Plastomill kneading time: short | | | | — | not spun |
| | | (breaking strength) | | | | | |
| | | (8) Labo Plastomill kneading time: normal | m/min | | | — | not spun |
| | | (winding rate at break) | | | | | |
| | | Labo Plastomill kneading time: short | | | | — | not spun |
| | | (winding rate at break) | | | | | |

| | | | | Comparative Example 3 | | Comparative Example 4 | |
|---|---|---|---|---|---|---|---|
| | | | Unit | Batch method | | Batch method | |
| Preliminary polymerization | | Preliminary polymerization temperature | ° C. | — | | — | |
| | | Amount of charged ethylene | NL | — | | — | |
| | | Preliminary polymerization time | h | — | | — | |
| | | Type of catalyst | — | — | | — | |
| | | Type of promoter | — | — | | — | |
| Polymerization conditions | | Polymerization temperature | ° C. | 80 | | 78 | |
| | | Polymerization pressure | MPa | 0.8 | | 0.7 | |
| | | Hydrogen pressure | MPa | 0.016 | | 0.00035 | |
| | | CM (Gas phase concentration) | mol % | 0 | | 0 | |
| | | Type of catalyst | — | Solid catalyst | | Solid catalyst | |
| | | | | component C | | component B | |
| | | Type of promoter | — | Promoter 1 | | Promoter 2 | |
| | | Polymerization residence time | h | 1.0 | | 1.0 | |
| | | Amount of catalyst | mg | 5.0 | | 5.0 | |
| Drying conditions | | Drying temperature | | 70 | | 70 | |
| | | Drying time | h | 2.0 | | 2.0 | |
| Polymerization results | | Catalyst activity | g-PE/g-s | 27000 | | 23500 | |
| | | Molecular weight | g/mol | 250,000 | | 3,700,000 | |
| | | Melting point (Tm 2) | ° C. | 137 | | 137 | |
| Additive | | CaSt | ppm | 600 | | 0 | |
| Effects | LiB region | (1) Polymer concentration: normal | number/ | Δ | 55 | | |
| | Molded article | (number of defects) | m² | | | | |
| | producing method: | Polymer concentration: high | | Δ | 80 | | |
| | 1-1, 2-1 | (number of defects) | | | | | |
| | | (2) Polymer concentration: norma | μm | Δ | 4 | | |
| | | (thickness unevenness) | | | | | |
| | | Polymer concentration: high | | X | 5 | | |
| | | (thickness unevenness) | | | | | |
| | | (3) Polymer concentration: normal | gf/(g/m²) | Δ | 60 | | |
| | | (puncture strength) | | | | | |
| | | Polymer concentration: high | | X | 50 | | |
| | | (puncture strength) | | | | | |
| | | (4) Polymer concentration: normal | % | ⊚ | 12 | | |
| | | @ porosity of 50% | | | | | |
| | | (heat shrinkage rate) | | | | | |
| | | Polymer concentration: high | | ⊚ | 13 | | |
| | | @ porosity of 50% | | | | | |
| | | (heat shrinkage rate) | | | | | |
| | Fiber region | (5) Labo Plastomill kneading time: normal | number/ | | | Δ | 9 |
| | Molded article | (amount of fiber ball) | m | | | | |
| | producing method: | Labo Plastomill kneading time: short | | | | X | 14 |
| | 3-1, 4-1 | (amount of fiber ball) | | | | | |
| | | (6) Labo Plastomill kneading time: normal | μm | | | Δ | 9 |
| | | (unevenness of fiber diameter) | | | | | |
| | | Labo Plastomill kneading time: short | | | | X | 12 |
| | | (unevenness of fiber diameter) | | | | | |
| | | (7) Labo Plastomill kneading time: normal | cN/dtex | | | X | 19 |
| | | (breaking strength) | | | | | |
| | | Labo Plastomill kneading time: short | | | | X | 14 |
| | | (breaking strength) | | | | | |
| | | (8) Labo Plastomill kneading time: normal | m/min | | | X | 160 |
| | | (winding rate at break) | | | | | |
| | | Labo Plastomill kneading time: short | | | | X | 120 |
| | | (winding rate at break) | | | | | |

TABLE 1-3

| | | | | Example 1 | | Example 2 | | Example 3 | | Example 4 | | Example 5 | | Example 6 |
|---|---|---|---|---|---|---|---|---|---|---|---|---|---|---|
| | | | | Batch | | Batch | | Batch | | Batch | | Batch | | Batch |
| | | | Unit | method | | method | | method | | method | | method | | method |
| Effects | LiB region | (1) Polymer | number/ | ⊚ | 8 | ⊚ | 3 | ⊚ | 4 | ⊚ | 5 | ⊚ | 5 | |
| | Molded article | concentration: normal | m² | | | | | | | | | | | |
| | producing method: | (number of defects) | | | | | | | | | | | | |
| | 1-2, 2-2 | Polymer | | ◯ | 15 | ⊚ | 5 | ⊚ | 6 | ⊚ | 7 | ⊚ | 7 | |
| | | concentration: high | | | | | | | | | | | | |
| | | (number of defects) | | | | | | | | | | | | |
| | | (2) Polymer | μm | ⊚ | 1.3 | ⊚ | 1 | ⊚ | 1 | ⊚ | 1 | ⊚ | 1 | |
| | | concentration: normal | | | | | | | | | | | | |
| | | (thickness unevenness) | | | | | | | | | | | | |
| | | Polymer | | ◯ | 1.6 | ⊚ | 1 | ⊚ | 1 | ⊚ | 1.1 | ⊚ | 1.1 | |
| | | concentration: high | | | | | | | | | | | | |
| | | (thickness unevenness) | | | | | | | | | | | | |
| | | (3) Polymer | gf/(g/m²) | ◯ | 75 | ⊚ | 80 | ⋆ | 95 | ⋆ | 105 | ⋆ | 110 | |
| | | concentration: normal | | | | | | | | | | | | |
| | | (puncture strength) | | | | | | | | | | | | |
| | | Polymer | | ◯ | 71 | ◯ | 76 | ⊚ | 90 | ⋆ | 98 | ⋆ | 103 | |
| | | concentration: high | | | | | | | | | | | | |
| | | (puncture strength) | | | | | | | | | | | | |
| | | (4) Polymer | % | ⋆ | 9 | ⋆ | 8 | ⋆ | 7 | ⊚ | 10 | ⋆ | 9 | |
| | | concentration: normal | | | | | | | | | | | | |
| | | @ porosity of 50% | | | | | | | | | | | | |
| | | (heat shrinkage rate) | | | | | | | | | | | | |
| | | Polymer | | ⊚ | 11 | ⊚ | 10 | ⊚ | 10 | ⊚ | 12 | ⊚ | 11 | |
| | | concentration: high | | | | | | | | | | | | |
| | | @ porosity of 50% | | | | | | | | | | | | |
| | | (heat shrinkage rate) | | | | | | | | | | | | |
| | Fiber region | (5) Labo Plastomill | number/ | | | | | | | | | | | ⊚ |
| | Molded article | kneading time: normal | m | | | | | | | | | | | |
| | producing method: | (amount of fiber ball) | | | | | | | | | | | | |
| | 3-2, 4-2 | Labo Plastomill | | | | | | | | | | | | |
| | | kneading time: short | | | | | | | | | | | | |
| | | (amount of fiber ball) | | | | | | | | | | | | |
| | | (6) Labo Plastomill | μm | | | | | | | | | | | ⊚ |
| | | kneading time: normal | | | | | | | | | | | | |
| | | (unevenness of fiber | | | | | | | | | | | | |
| | | diameter) | | | | | | | | | | | | |
| | | Labo Plastomill | | | | | | | | | | | | ⊚ |
| | | kneading time: short | | | | | | | | | | | | |
| | | (unevenness of fiber | | | | | | | | | | | | |
| | | diameter) | | | | | | | | | | | | |
| | | (7) Labo Plastomill | cN/dtex | | | | | | | | | | | ⊚ |
| | | kneading time: normal | | | | | | | | | | | | |
| | | (breaking strength) | | | | | | | | | | | | |
| | | Labo Plastomil | | | | | | | | | | | | ⊚ |
| | | kneading time: short | | | | | | | | | | | | |
| | | (breaking strength) | | | | | | | | | | | | |
| | | (8) Labo Plastomill | m/min | | | | | | | | | | | ⊚ |
| | | kneading time: normal | | | | | | | | | | | | |
| | | (winding rate at break) | | | | | | | | | | | | |
| | | Labo Plastomill | | | | | | | | | | | | ⊚ |
| | | kneading time: short | | | | | | | | | | | | |
| | | (winding rate at break) | | | | | | | | | | | | |

| | | | | Example 6 | Example 7 | | Example 8 | | Example 9 | | Example 10 | |
|---|---|---|---|---|---|---|---|---|---|---|---|---|
| | | | | Batch | Batch | | Batch | | Batch | | Batch | |
| | | | Unit | method | method | | method | | method | | method | |
| Effects | LiB region | (1) Polymer | number/ | | | | | | | | | |
| | Molded article | concentration: normal | m² | | | | | | | | | |
| | producing method: | (number of defects) | | | | | | | | | | |
| | 1-2, 2-2 | Polymer | | | | | | | | | | |
| | | concentration: high | | | | | | | | | | |
| | | (number of defects) | | | | | | | | | | |
| | | (2) Polymer | μm | | | | | | | | | |
| | | concentration: normal | | | | | | | | | | |
| | | (thickness unevenness) | | | | | | | | | | |
| | | Polymer | | | | | | | | | | |
| | | concentration: high | | | | | | | | | | |
| | | (thickness unevenness) | | | | | | | | | | |
| | | (3) Polymer | gf/(g/m²) | | | | | | | | | |
| | | concentration: normal | | | | | | | | | | |
| | | (puncture strength) | | | | | | | | | | |
| | | Polymer | | | | | | | | | | |
| | | concentration: high | | | | | | | | | | |
| | | (puncture strength) | | | | | | | | | | |
| | | (4) Polymer | % | | | | | | | | | |
| | | concentration: normal | | | | | | | | | | |
| | | @ porosity of 50% | | | | | | | | | | |
| | | (heat shrinkage rate) | | | | | | | | | | |
| | | Polymer | | | | | | | | | | |
| | | concentration: high | | | | | | | | | | |
| | | @ porosity of 50% | | | | | | | | | | |
| | | (heat shrinkage rate) | | | | | | | | | | |
| | Fiber region | (5) Labo Plastomill | number/ | 1 | ⊚ | 1 | ⊚ | 2 | ◯ | 3 | ◯ | 4 |
| | Molded article | kneading time: normal | m | | | | | | | | | |
| | producing method: | (amount of fiber ball) | | | | | | | | | | |
| | 3-2, 4-2 | Labo Plastomill | | | | | | | | | | |
| | | kneading time: short | | | | | | | | | | |
| | | (amount of fiber ball) | | | | | | | | | | |
| | | (6) Labo Plastomill | μm | 1 | ⊚ | 1 | ⊚ | 2 | ◯ | 3 | ◯ | |
| | | kneading time: normal | | | | | | | | | | |
| | | (unevenness of fiber | | | | | | | | | | |
| | | diameter) | | | | | | | | | | |
| | | Labo Plastomill | | 1 | ⊚ | 1 | ⊚ | 2 | ◯ | 3 | ◯ | 4 |
| | | kneading time: short | | | | | | | | | | |
| | | (unevenness of fiber | | | | | | | | | | |
| | | diameter) | | | | | | | | | | |
| | | (7) Labo Plastomill | cN/dtex | 38 | ⊚ | 42 | ⋆ | 49 | ⋆ | 54 | ⋆ | 54 |
| | | kneading time: normal | | | | | | | | | | |
| | | (breaking strength) | | | | | | | | | | |
| | | Labo Plastomil | | 35 | ⊚ | 40 | ⋆ | 47 | ⋆ | 51 | ⋆ | 52 |
| | | kneading time: short | | | | | | | | | | |
| | | (breaking strength) | | | | | | | | | | |
| | | (8) Labo Plastomill | m/min | 720 | ⋆ | 920 | ⋆ | 1000 | ⋆ | 1100 | ⋆ | 1080 |
| | | kneading time: normal | | | | | | | | | | |
| | | (winding rate at break) | | | | | | | | | | |
| | | Labo Plastomill | | 700 | ⋆ | 900 | ⋆ | 980 | ⋆ | 1000 | ⋆ | 1020 |
| | | kneading time: short | | | | | | | | | | |
| | | (winding rate at break) | | | | | | | | | | |

The ultrahigh-molecular-weight polyethylene powder of the present invention is excellent in molding processability by shortening a dissolution time (time from the start to the end of dissolution) in liquid paraffin, and can provide a high-quality molded article, for example, a separator for a secondary battery and a fiber, and thus has industrial applicability.

1. An ultrahigh-molecular-weight polyethylene powder,
having intrinsic viscosity IV of 1.0 dL/g or more and 38.0 dL/g or less, and
having an average particle size D50 of 50 μm or more and 400 μm or less, wherein
a dissolution time of a powder having a particle size D50 is 5 seconds or more and 80 seconds or less.

2. The ultrahigh-molecular-weight polyethylene powder according to claim 1, wherein
the intrinsic viscosity IV is 13.5 dL/g or more and 38.0 dL/g or less.

3. The ultrahigh-molecular-weight polyethylene powder according to claim 1, wherein
the dissolution time is 5 seconds or more and 40 seconds or less.

4. The ultrahigh-molecular-weight polyethylene powder according to claim 1, wherein
a proportion of interconnected pores in the powder having the particle size D50 is 3% or more and 70% or less.

5. The ultrahigh-molecular-weight polyethylene powder according to claim 1, wherein
a surface thickness of the powder having the particle size D50 is 3 μm or more and 60 μm or less.

6. The ultrahigh-molecular-weight polyethylene powder according to claim 1, wherein
an interconnected pore diameter of the powder having the particle size D50 is 3 μm or more and 30 μm or less.

7. The ultrahigh-molecular-weight polyethylene powder according to claim 1, wherein
a titanium content is 5 ppm or less.

8. The ultrahigh-molecular-weight polyethylene powder according to claim 1, wherein
an aluminum content is 5 ppm or less.

9. A molded article of the ultrahigh-molecular-weight polyethylene powder according to claim 1.

10. The molded article according to claim 9, wherein
the molded article is a separator for secondary battery.

11. The molded article according to claim 9, wherein
the molded article is a fiber.

12. A method for producing a high-strength fiber, comprising:
a slurry preparing step of mixing an ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry;
a gelling step of mixing the slurry and second liquid paraffin at 150° C. or more and 300° C. or less to obtain a gel for a fiber at 140° C. or more and 200° C. or less;
an extruding step of extruding the gel for a fiber to obtain a fiber;
an extracting step of extracting the first liquid paraffin and the second liquid paraffin from the fiber to obtain a fiber for drawing; and
a fiber drawing step of thermally drawing the fiber for drawing, wherein
the ultrahigh-molecular-weight polyethylene powder has intrinsic viscosity IV of 13.5 dL/g or more and 38.0 dL/g or less,
an average particle size D50 of the ultrahigh-molecular-weight polyethylene powder is 50 μm or more and 400 μm or less, and
a dissolution time of a powder having a particle size D50 of the ultrahigh-molecular weight polyethylene powder is 5 seconds or more and 80 seconds or less.

13. The method for producing a high-strength fiber according to claim 12, comprising a kneading step of kneading the gel for a fiber before the extruding step.

14. A method for producing a microporous membrane, comprising:
a slurry preparing step of mixing an ultrahigh-molecular-weight polyethylene powder and first liquid paraffin, and stirring the resulting mixture at a temperature equal to or lower than a melting point of the ultrahigh-molecular-weight polyethylene powder to thereby obtain a slurry;
a gelling step of mixing the slurry and second liquid paraffin at 150° C. or more and 300° C. or less to obtain a gel for pressing at 140° C. or more and 200° C. or less;
a pressing step of thermally pressing the gel for pressing to obtain a gel sheet;
a membrane drawing step of drawing the gel sheet to obtain a drawn membrane; and
an extracting step of extracting the first liquid paraffin and the second liquid paraffin from the drawn membrane, wherein
the ultrahigh-molecular-weight polyethylene powder has intrinsic viscosity IV of 1.0 dL/g or more and 13.0 dL/g or less,
an average particle size D50 of the ultrahigh-molecular-weight polyethylene powder is 50 μm or more and 400 μm or less, and
a dissolution time of a powder having a particle size D50 of the ultrahigh-molecular weight polyethylene powder is 5 seconds or more and 80 seconds or less.

15. The method for producing a microporous membrane according to claim 14, comprising a kneading step of kneading the gel for pressing before the pressing step.
